(19) United States
(12) Patent Application Publication
(10) Pub. No.: US 2009/0189924 A1
(43) Pub. Date: Jul. 30, 2009

(54) DISPLAY DRIVING DEVICE, DISPLAY APPARATUS, AND METHOD OF DRIVING THEM

(75) Inventor: Jun OGURA, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/361,674

(22) Filed: Jan. 29, 2009

(30) Foreign Application Priority Data
Jan. 29, 2008 (JP) 2008-017189

(51) Int. Cl. G09G 5/10

(52) U.S. Cl. 345/690

(57) ABSTRACT

A display driving device for driving a plurality of display pixels provided with a light emitting element which performs color display, is provided with a signal converter which is supplied a display data including a plurality of color components corresponding to the plurality of display pixels and corresponds to a predetermined number of two or more display pixels having the light emitting elements of different light emission colors from each other, based on a single conversion characteristic, different gamma correction curves corresponding to the color component, which corresponds to the light emission color of each of the light emitting elements in the predetermined number of display pixels, are generated, the color component of the display data is converted with the use of each of the gamma correction curves, and a gradation signal for driving the light emitting element in each of the display pixels is generated.

### CROSS-REFERENCE TO RELATED APPLICATIONS

This application is based upon and claims the benefit of priority from prior Japanese Patent Application No. 2008-017189, filed Jan. 29, 2008, the entire contents of which are incorporated herein by reference.

### BACKGROUND OF THE INVENTION

1. Field of the Invention

The present invention relates to a display driving device, a display apparatus, and a method of driving the display driving device and the display apparatus, and particularly to a display driving device for driving a display panel in which a plurality of display pixels having a self light emitting element are arrayed, a display apparatus provided with the display driving device, and a method for driving the display driving device and the display apparatus.

2. Description of the Related Art

Recently, as a display device for an electronic apparatus such as a portable telephone or a portable music player, there has been known a display apparatus (light emitting element display apparatus) using a display panel (self light emitting display panel) with a plurality of two-dimensionally arrayed display pixels having a light emitting element, such as an organic electroluminescence element (hereinafter referred to as “organic EL element”). Compared with a widely known liquid crystal display apparatus, this display apparatus has excellent display characteristics, such as a high display response speed and low viewing angle dependency. Further, this display apparatus, unlike a liquid crystal apparatus, has such a configurational characteristic that a backlight and a light guide plate are not required.

In the above display apparatus, the light emitting element in each display pixel of the display panel is current-controlled by, for example, a voltage signal. The display panel using an active matrix driving method is provided with, in each pixel, for example, a current control thin-film transistor, in which a voltage signal corresponding to image data is applied to a gate and thus to apply the current to a light emitting element (organic EL element), and a switch thin-film transistor which performs switching for supplying the voltage signal, corresponding to the image data, to the gate of the current control thin-film transistor.

In the above display panel, when color display is performed, each of the display pixels has a light emitting element of any one of light emission colors of red (R), green (G), and blue (B). When the light emitting elements of each color differ in electro-optic characteristics (specifically, luminance characteristics), in order to display each color of R, G, and B and, in addition, in order to favorably display the white color, a gamma correction processing is required to be performed so that a luminance gradation of the light emitting elements of each color in each display pixel is subjected to gamma correction with the use of individual gamma correction curves (γ curves) so as to obtain appropriate color balance.

As a gamma correction circuit used for the gamma correction processing, a red gamma correction circuit, a green gamma correction circuit, and a blue gamma correction circuit, which correspond to the luminance characteristics of the light emitting elements of each light emission color, are provided to the light emitting elements of light emission colors of R, G, and B. The gamma correction circuit is configured so that the gamma correction processing is applied to the respective display data, which will be supplied and have the color components of R, G, and B, for each of the color components.

However, as described above, in such a configuration that the gamma correction circuits are individually provided to the light emitting elements of each light emission color, and the gamma correction processing is performed for each color component of the display data, for example in a case of the three colors of R, G, and B, three individual gamma correction circuits are required to be provided, resulting in an increase in circuit size of the display apparatus.

### BRIEF SUMMARY OF THE INVENTION

The invention has an advantage in that it provides a display driving device that can favorably display image information in color on a display panel while reducing a circuit size, a display apparatus, and a method of driving the display driving device and the display apparatus.

In order to obtain the above advantage, the present invention provides a display driving device for driving a plurality of display pixels provided with a light emitting element, which performs color display and has any one of a plurality of light emission colors, comprising: a signal converter, which is supplied a display data, which corresponds to said each display pixel and includes a plurality of color components corresponding to said plurality of light emission colors and generates a gradation signal, which corresponds to the predetermined number of two or more display pixels having the light emitting element of different light emission colors from each other and is obtained by conversion of the display data, wherein the signal converter comprises: a gamma correction curve generator which, based on a single conversion characteristic, generates gamma correction curves different from each other which correspond to the color components corresponding to the light emission color of each of the light emitting elements in the predetermined number of display pixels and set a relation between a value of the display data and a value of the gradation signal; and a gradation signal generator which converts the color component of the display data with the use of the generated gamma correction curve corresponding to said each color component and generates in a time series manner the gradation signal corresponding to the predetermined number of display pixels.

In order to obtain the above advantage, the present invention provides a display apparatus for performing color display, comprising: a display panel having a plurality of data lines and a plurality of select lines perpendicular to each other and a plurality of display pixels, which are arranged near each intersection of said plurality of data lines and said plurality of select lines and have light emitting elements performing color display and having any of a plurality of light emission colors; and a display driving device which is supplied a display data corresponding to each of light emission colors of the light emitting element in said each display pixel arrayed along the extending direction of the select line and comprising a digital signal including a plurality of color components, and generates a gradation signal based on the display data to supply the gradation signal to said plurality of display pixels through said plurality of data lines, wherein the display driving device comprises a signal converter which is provided corresponding to a predetermined number of two or more data lines corresponding to the display pixel having the light emitting element of different light emission colors from each other in said plurality of data lines and generates the gradation signal obtained by conversion of the display data, and the signal converter comprises: a gamma correction curve generator which, based on a single conversion characteristic, generates gamma correction curves different from each other which correspond to color components corresponding to a light emission color of each light emitting element in the predetermined number of display pixels corresponding to the predetermined number of data lines and set a relation between a value of the display data and a value of the gradation signal; and a gradation signal generator which converts the color component of the display data with the use of the generated gamma correction curve corresponding to said each color component and generates in a time series manner the gradation signal corresponding to the predetermined number of the display pixels.

In order to obtain the above advantage, the present invention provides a method of driving a display driving device for driving a plurality of display pixels provided with a light emitting element, which performs color display and has any one of a plurality of light emission colors, comprising: a step of converting display data, which is supplied, corresponds to said each display pixel, and includes a plurality of color components corresponding to said plurality of light emission colors, and generating a gradation signal corresponding to a predetermined number of two or more display pixels having the light emitting element of different light emission colors from each other; and a step of supplying the generated gradation signal, corresponding to said each color component, to each of the predetermined number of display pixels, wherein the step of generating the gradation signal comprises: a step of, based on a single conversion characteristics, generating gamma correction curves different from each other which correspond to each of a predetermined number of color components included in the display data and set a relation between a value of the display data and a value of the gradation signal; and a step of converting said each color component in the display data with the use of the generated gamma correction curves corresponding to each of the color components and generating in a time series manner the gradation signal corresponding to the predetermined number of display pixels.

In order to obtain the above advantage, the present invention provides a method of driving a display apparatus for performing color display, wherein the display apparatus has a display panel having a plurality of display pixels, which are arranged near each intersection of a plurality of data lines and a plurality of select lines perpendicular to each other and provided with a light emitting element performing color display and having any of a plurality of light emission colors, the method comprising: a step of converting display data, which is supplied, corresponds to each of light emission colors of the light emitting element in said each display pixel arrayed along the extending direction of the select line, and comprises a digital signal including a plurality of color components, and generating a gradation signal corresponding to the predetermined number of display pixels having the light emitting element which is connected to a predetermined number of two or more data lines and has the light emitting elements of different light emission colors from each other; and a step of supplying the generated gradation signal corresponding to said each color component to each of the predetermined number of display pixels, wherein the step of generating the gradation signal comprises: a step of, based on a single conversion characteristic, generating gamma correction curves different from each other which correspond to each of a predetermined number of color components included in the display data and set a relation between a value of the display data and a value of the gradation signal; and a step of converting said each color component in the display data with the use of the generated gamma correction curves corresponding to each of the color components and generating in a time series manner the gradation signal corresponding to the predetermined number of display pixels.

### BRIEF DESCRIPTION OF THE SEVERAL VIEWS OF THE DRAWING

FIG. 1 is a schematic block diagram showing an example of the entire configuration of a display apparatus according to the invention;

FIG. 2 is a schematic configuration diagram showing an example of a display panel and a data driver applicable to the display apparatus according to a first embodiment;

FIG. 3 is a circuit configuration diagram showing an example of a display pixel (a pixel driving circuit and a light emitting element) applicable to the display apparatus according to the first embodiment;

FIGS. 4A, 4B, and 4C are configuration diagrams of an essential part of the data driver according to the first embodiment;

FIGS. 5A and 5B are circuit configuration diagrams showing an example of a voltage generation circuit and a switching switch applicable to the data driver according to the first embodiment;

FIG. 6 is a voltage-luminance characteristic diagram showing a relation between a voltage (an organic EL voltage), applied to between an anode and a cathode of an organic EL element of each color of R, G, and B, and a light emission luminance;

FIG. 7 is a normalized voltage-luminance characteristic diagram showing a relation between a normalized voltage and the light emission luminance in voltage-luminance characteristics of the organic EL element;

FIG. 8 is a gradation-luminance characteristic diagram showing a relation between a luminance gradation value and a normalized light emission luminance in a case in which a light emission start voltage is switched and set for each color of R, G, and B in a gradation voltage generator according to the first embodiment;

FIG. 9 is a gradation-voltage characteristic diagram showing a relation between the luminance gradation value and a normalized output voltage of each color in the gradation voltage generator (γ curve generation circuit) according to the first embodiment;

FIG. 10 is a gradation-luminance characteristic diagram showing a relation between the luminance gradation value and the normalized light emission luminance in a case in which the light emission start voltage is fixed;

FIG. 11 is a timing chart showing an example of a method of driving the display apparatus according to the first embodiment;

FIG. 12 is a timing chart showing a specific example of a selection operation applied to the method of driving the display apparatus according to the first embodiment;

FIG. 13 is a conceptual diagram showing a capture operation for display data and a gradation voltage generating operation in the display apparatus according to the first embodiment;

FIG. 14 is a conceptual diagram showing a write operation in the display apparatus according to the first embodiment;

FIG. 15 is a conceptual diagram showing a holding operation in the display apparatus according to the first embodiment;

FIG. 16 is a conceptual diagram showing a light emitting operation in the display apparatus according to the first embodiment;

FIG. 17 is an operation timing diagram schematically showing a specific example of the method of driving the display apparatus having a display area, according to the first embodiment;

FIG. 18 is a configuration diagram of an essential part of a data driver in a second embodiment applied to the display apparatus according to the invention;

FIG. 19 is a schematic configuration diagram showing an example of a display panel and a data driver applicable to a display apparatus according to a third embodiment;

FIG. 20 is a configuration diagram of an essential part of the data driver according to the third embodiment;

FIG. 21 is a timing chart showing an example of a method of driving the display apparatus according to the third embodiment;

FIG. 22 is a characteristic diagram showing operation characteristics of a drive transistor in the write operation of the display pixel;

FIG. 23 is a characteristic diagram showing a relation between a driving current and a driving voltage of an organic EL element;

FIG. 24 is a characteristic diagram showing operation characteristics of a drive transistor in the light emitting operation of the display pixel;

FIG. 25 is a characteristic diagram showing load characteristics of the organic EL element;

FIG. 26 is a schematic configuration diagram showing a display panel and a data driver in a first application example in the display apparatus according to the invention;

FIG. 27 is a configuration diagram of an essential part of the data driver according to the first application example;

FIG. 28 is a timing chart showing an example of a method of driving a display apparatus according to the first application example;

FIG. 29 is a timing chart showing a specific example of each operation during a selection period in the method of driving the display apparatus according to the first application example;

FIG. 30 is a conceptual diagram showing a precharge operation in the display apparatus according to the first application example;

FIG. 31 is a conceptual diagram showing a reference voltage reading operation in the display apparatus according to the first application example;

FIG. 32 is a conceptual diagram showing a write operation in the display apparatus according to the first application example;

FIG. 33 is a conceptual diagram showing a holding operation in the display apparatus according to the first application example;

FIG. 34 is a conceptual diagram showing a light emitting operation in the display apparatus according to the first application example;

FIG. 35 is an operation timing diagram schematically showing a specific example of the method of driving the display apparatus according to the first application example;

FIG. 36 is a schematic configuration diagram showing a display panel and a data driver in a second application example of the display apparatus according to the invention;

FIG. 37 is a configuration diagram of an essential part of the data driver according to the second application example; and

FIG. 38 is a timing chart showing an example of a method of driving the display apparatus according to the second application example.

### DETAILED DESCRIPTION OF THE INVENTION

Hereinafter, a display driving device, a display apparatus, and a method of driving the display driving device and the display apparatus according to the invention will be described in detail based on the embodiments illustrated in the drawings.

### First Embodiment

### <Display Apparatus>

First, the schematic configuration of a display apparatus according to the invention will be described with reference to the drawings.

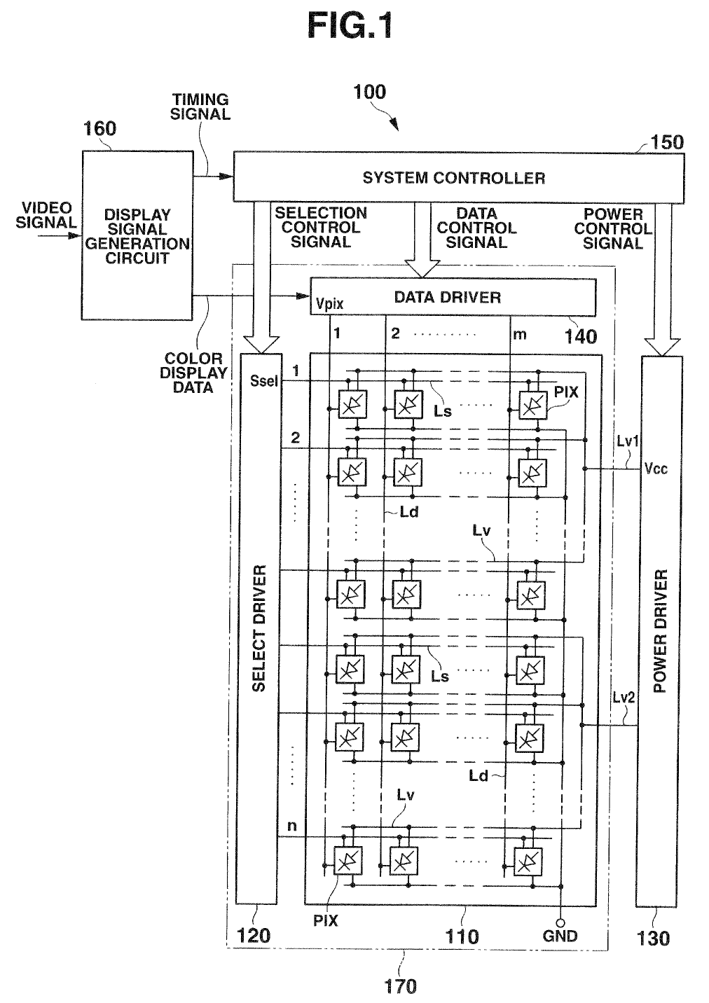

FIG. 1 is a schematic block diagram showing an example of the entire configuration of the display apparatus according to the invention.

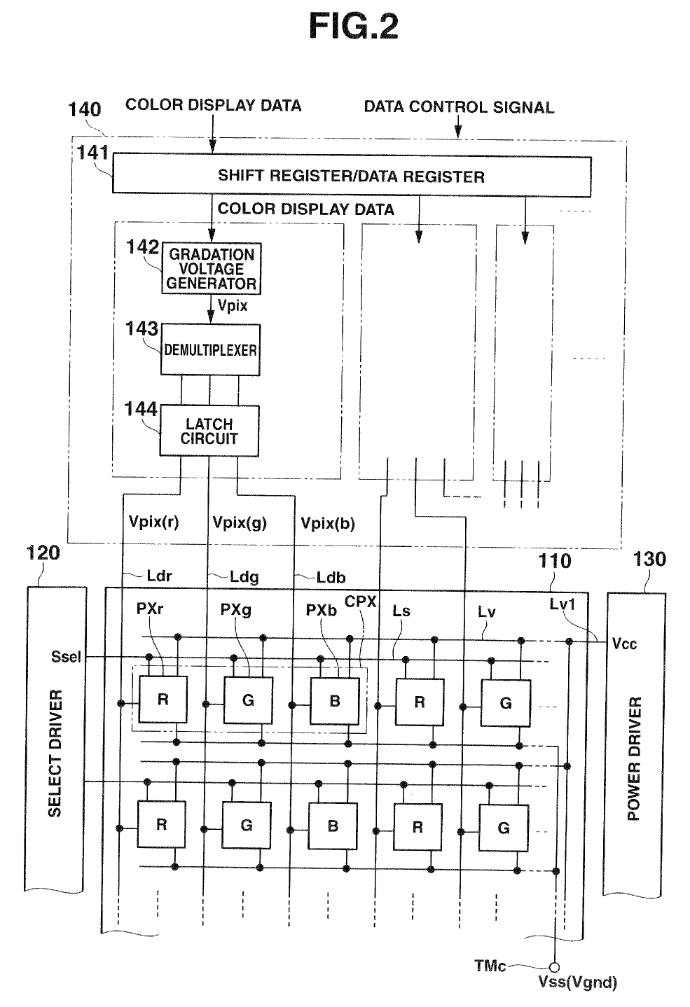

FIG. 2 is a schematic configuration diagram showing an example of a display panel and a data driver applicable to the display apparatus according to a first embodiment.

As shown in FIG. 1, a display apparatus 100 according to the present embodiment is provided with a display panel 170 constituted of a substrate having a display area 110, a select driver 120, and a data driver 140 provided thereon, a power driver 130, a system controller 150, and a display signal generation circuit 160.

The display area 110 has, for example, a plurality of select lines Ls arranged in a row direction (horizontal direction in the drawing), a plurality of data lines Ld arranged in a column direction (vertical direction in the drawing), and a plurality of display pixels PIX arrayed near each intersection of the select lines Ls and the data lines Ld. Each of the display pixels PIX is provided with a pixel driving circuit DC and a light emitting element (an organic EL element OLED), which will be described later, and the display pixels PIX are arrayed in a matrix form of a rows×m columns (n and m are arbitrary positive integers, n is an even number, and m is a multiple of 3).

The select driver 120 sequentially applies a selection signal Ssel to the select lines Ls in each row at a predetermined timing to thereby set the display image pixels PIX in each row in a selected state.

The power driver 130 applies power voltage Vcc of a predetermined voltage level to a plurality of power voltage lines Lv at a predetermined timing. The power voltage lines Lv are arranged in the row direction in parallel with the select lines Ls in each row.

The data driver (display driving device) 140 supplies a gradation signal (gradation voltage Vpix), corresponding to the display data, to the display pixels PIX through each data line Ld at a predetermined timing.

The system controller 150 controls an operation state of at least the select driver 120, the power driver 130, and the data driver 140 on the basis of a timing signal supplied from the display signal generation circuit 160, and generates and outputs a selection control signal, a power control signal, and a data control signal for displaying predetermined image information in the display area 110.

For example, on the basis of a video signal supplied from outside of the display apparatus 100, the display signal generation circuit 160 generates the display data (luminance gradation data), constituted of a digital signal, to supply the display data to the data driver 140, and, at the same time, the display signal generation circuit 160 extracts or generates a timing signal (such as system clock) for displaying the image information in the display area 110 on the basis of the display data to supply the timing signal to the system controller 150.

In FIG. 1, the power driver 130 is provided outside the display panel 170 and connected to the display panel 170 through, for example, a film substrate. However, the power driver 130 may be disposed on the display panel 170.

Part of the data driver 140 may be provided on the display panel 170, and the remaining part may be provided outside the display panel 170. In this case, the data driver 140 may be connected to the display panel 170 through a film substrate. At this time, the part of the data driver 140 in the display panel 170 may be an IC chip or may be constituted of a transistor manufactured together with each transistor of the pixel driving circuit DC, to be described later.

The select driver 120 may be an IC chip or may be constituted of a transistor manufactured together with each transistor of the pixel driving circuit DC, to be described later.

Hereinafter, the above components will be described.

### (Display Panel)

The display panel 170 has, for example, substantially at its center, the display area 110 with a plurality of the display pixels PIX arrayed in a matrix form. The display pixels PIX, as shown in FIG. 1, for example, are divided into a group in an upper area (the upper side in FIG. 1) and a group in a lower area (the lower side in FIG. 1), and the display pixels PIX included in each group are connected to the power voltage lines Lv branched in each row. The power voltage lines Lv in the upper area group are respectively connected to a first power voltage line Lv1. The power voltage lines Lv in the lower area group are respectively connected to a second power voltage line Lv2. The first and second power voltage lines Lv1 and Lv2 are connected to the power driver 130 in an electrically independent manner. Namely, the power voltage Vcc is applied from the power driver 130 to the display pixels PIX in the first row to n/2-th row (in this example, n is an even number) in the upper area of the display area 110 through the first power voltage line Lv1 connected to the power voltage line Lv in each row. Meanwhile, the power voltage Vcc is applied from the power driver 130 to the display pixels PIX in 1+n/2-th row to n-th row in the lower area of the display area 110 through the second power voltage line Lv2 connected to the power voltage line Lv in each row. The timing of the application of the power voltage Vcc from the power driver 130 to the display pixels PIX in the first line to n/2-th row in the upper area and the timing of the application of the power voltage Vcc from the power driver 130 to the display pixels PIX in 1+n/2-th row to n-th row in the lower area are set so as to be different from each other, for example.

The display pixels PIX arrayed on the display panel 170 shown in FIG. 1, as shown in FIG. 2, for example, includes sub pixels (color pixels) PXr, PXg, and PXb of each color of red (R), green (G), and blue (B) respectively connected to the individual data lines Ldr, Ldg, and Ldb arranged in the column direction (vertical direction in the drawing). These sub pixels PXr, PXg, and PXb are repeatedly arrayed in the display area 110 in the row direction (horizontal direction in the drawing) in order of, for example, R, G, B, R, G, B . . . , and, in addition, the sub pixels of the same color (PXr, PXg, and PXb) are repeatedly arrayed in the column direction. The sub pixels of three colors R, G, and B (PXr, PXg, and PXb) arrayed adjacent to one another in the row direction are combined as a set to form a color pixel CPX (namely, m is a multiple of 3), whereby the display panel 170 corresponding to color display is formed.

### (Display Pixel)

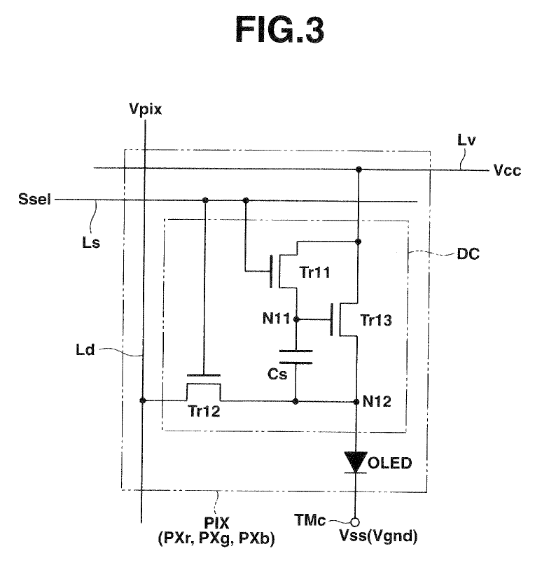

FIG. 3 is a circuit configuration diagram showing an example of a display pixel (a pixel driving circuit and a light emitting element) applicable to the display apparatus according to the present embodiment.

The display pixels PIX (sub pixels PXr, PXg, and PXb shown in FIG. 2) applied to the present embodiment, as shown in, for example, FIG. 3, are provided with a pixel driving circuit DC and a light emitting element (organic EL element OLED). The pixel driving circuit DC sets the display pixel PIX in a selected state on the basis of the selection signal Ssel applied through the select line Ls from the select driver 120, captures a gradation signal (gradation voltage Vpix), supplied from the data driver 140 through the data line Ld (the data lines Ldr, Ldg, and Ldb shown in FIG. 2), in the selected state, generates a light emission driving current corresponding to the gradation signal, and supplies the generated light emission driving current to the organic EL element OLED.

The organic EL element OLED is a current-controlled light emitting element performing a light emitting operation at a gradation level based on the light emission driving current supplied from the pixel driving circuit DC.

The pixel driving circuit DC is specifically provided with a transistor Tr11, a transistor Tr12, and a transistor Tr13, and a capacitor Cs shown in FIG. 3.

In the transistor Tr11, a gate terminal, a drain terminal, and a source terminal are respectively connected to the select line Ls, the power voltage line Lv, and a contact point N11.

In the transistor Tr12, a gate terminal, a source terminal, and a drain terminal are respectively connected to the select line Ls, the data line Ld (Ldr, Ldg, and Ldb), and a contact point N12.

In the transistor Tr13, a gate terminal, a drain terminal, and a source terminal are respectively connected to the contact point N11, the power voltage line Lv, and the contact point N12. The transistor Tr13 corresponds to the drive transistor of the invention.

The capacitor Cs is connected to between the contact point N11 and the contact point N12 (between the gate and source terminals of the transistor Tr13). The capacitor Cs may be a parasitic capacitance formed between the gate terminal and the source of the transistor Tr13, or may be a capacitor in which a capacitative element other than the transistor Tr13 is connected to between the contact point N11 and the contact point N12 in addition to the parasitic capacitance, or may be both of them.

In the organic EL element OLED, an anode terminal is connected to the contact point N12 in the pixel driving circuit DC, and a reference voltage Vss of a predetermined low electric potential (for example, a ground potential Vgnd) is applied to a cathode terminal TMc. In the drive control of the display apparatus to be described later, in a write operation period in which the gradation signal (gradation voltage Vpix) is supplied to the pixel driving circuit DC and in a holding operation period in which a voltage component corresponding to the gradation signal is held, the low potential power voltage Vcc (=Vccw) is applied to the power voltage line Lv, and the organic EL element OLED is controlled so as not to be lit.

Especially, in the display pixel PIX applied to the present embodiment, regardless of the light emission color of the organic EL element OLED connected to the pixel driving circuit DC, the pixel is designed so that the arrangement and size of the transistors Tr11 to Tr13 and the capacitor Cs are substantially the same as one another, whereby the display pixels PIX of each color of R, G, and B (sub pixels PXr, PXg, and PXb) are different from one another in the luminous efficiency and the light emission characteristics, in accordance with the electro-optic characteristics of the organic EL element OLED.

The transistors Tr11 to Tr13 are not particularly limited to the above. For example, an n-channel amorphous silicon thin-film transistor formed of n-channel field-effect transistors can be applied as the transistors Tr11 to Tr13. In this case, by using an already established technique for producing amorphous silicon, a pixel driving circuit DC constituted of an amorphous silicon thin-film transistor having stable device characteristics (such as electron mobility) can be manufactured in a relatively simple manufacturing process. In the following description, there will be described a case where n-channel thin-film transistors are applied as the transistors Tr11 to Tr13.

The circuit configuration of the display pixel PIX (pixel driving circuit DC) is not limited to the circuit configuration shown in FIG. 3. The display pixel PIX may have any circuit configuration as long as at least a current path of the drive transistor (transistor Tr13) is connected in series to a current-driven light emitting element (organic EL element OLED), and as long as the circuit configuration is a source-follower circuit configuration. Further, the light emitting element driven to emit light by the pixel driving circuit DC is not limited to the organic EL element OLED, and it may be another current-driven light emitting element, such as a light-emitting diode.

### (Select Driver)

The select driver 120 applies the selection signal Ssel of a selection level (high level in the display pixel PIX shown in FIG. 3) to each of the select lines Ls, based on the selection control signal supplied from the system controller 150, whereby the display pixels PIX in each row are set in a selected state or an unselected state by the select driver 120.

Specifically, at least during a period including the write operation period to be described later, the operation in which the selection signal Ssel of the selection level (for example, high level) is applied to the select line Ls in the relevant row is sequentially performed at a predetermined timing for each row, whereby the display pixels PIX in each row are sequentially set in the selected state by the select driver 120 (selection period).

The select driver 120 provided with a shift register and an output circuit part (output buffer) can be applied. The shift register sequentially outputs a shift signal corresponding to the select line Ls in each row, based on for example the selection control signal supplied from the system controller 150, to be described later. The output circuit part converts the shift signal into a predetermined signal level (selection level) and sequentially outputs the converted shift signal as the selection signal Ssel to the select line Ls in each row.

When a driving frequency of the select driver 120 is within a range permitting the operation of an amorphous silicon transistor, part or all of the transistors included in the select driver 120 may be manufactured as amorphous silicon transistors collectively with the transistors Tr11 to Tr13 in the pixel driving circuit DC.

### (Power Driver)

Based on the power control signal supplied from the system controller 150, the power driver 130 applies the low potential power voltage Vcc (=Vccw) to each of the power voltage lines Lv in at least the selection period including a writing period, to be described later, and applies power voltage Vcc (=Vcce) of a higher potential than the power voltage Vccw in a light emitting operation period.

In the present embodiment, as shown in FIG. 1, the display pixels PIX are divided into a group in the upper area of the display area 110 and a group in the lower area, for example, and the individual power voltage lines Lv branched in each group are arranged. In the operation period of the group in the upper area, the power driver 130 outputs the power voltage Vcc to the display pixels PIX, arrayed in the upper area, through the first power voltage line Lv1. Meanwhile, in the operation period of the group in the lower area, the power driver 130 outputs the power voltage Vcc to the display pixels PIX, arrayed in the lower area, through the second power voltage line Lv2.

The power driver 130 provided with a timing generator (such as a shift register sequentially outputting a shift signal) and an output circuit part can be applied. The timing generator generates a timing signal corresponding to the power voltage line Lv in each area (group), based on the power control signal supplied from the system controller 150. The output circuit part converts the timing signal into a predetermined voltage level (voltage values Vccw and Vcce) to output the converted timing signal as the power voltage Vcc to the power voltage line Lv (Lv1 and Lv2) in each area.

As shown in FIG. 1, if the number of the power voltage lines is small, such as the first and second power voltage lines Lv1 and Lv2, the power driver 130 is not independently disposed outside the display panel 170, and may be disposed in a part of the system controller 150.

### (Data Driver)

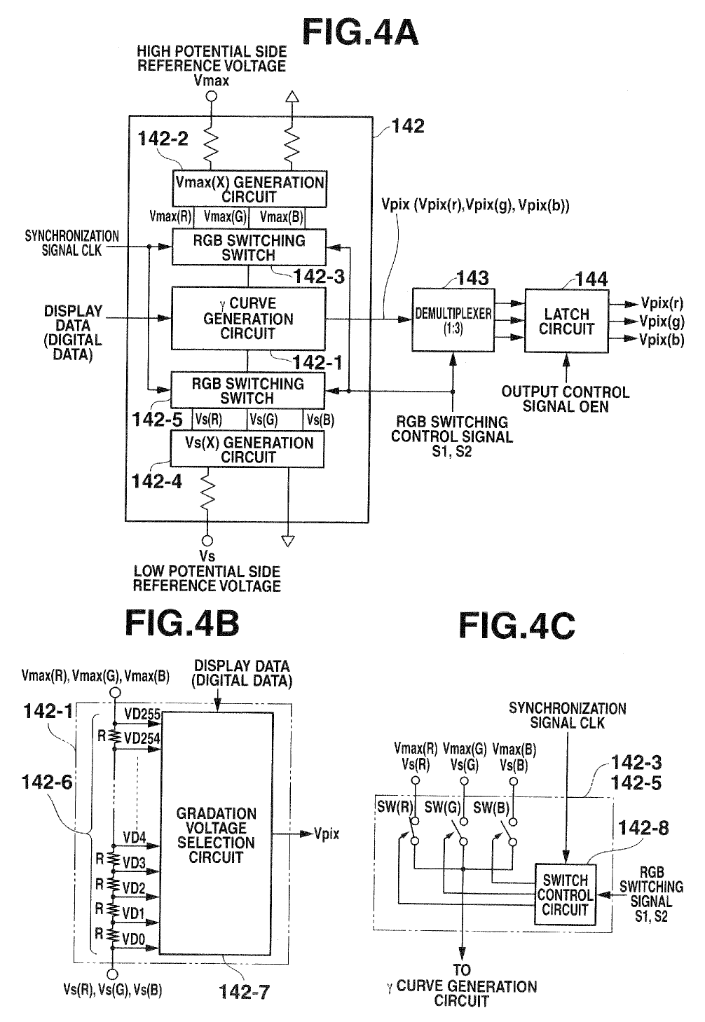

FIGS. 4A, 4B, and 4C are configuration diagrams of an essential part of the data driver according to the present embodiment.

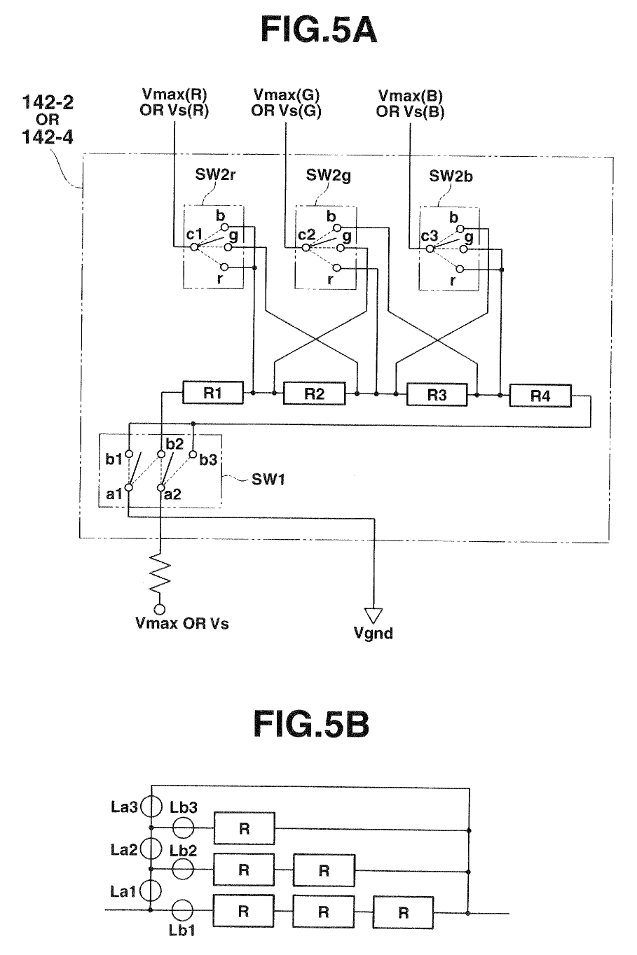

FIGS. 5A and 5B are circuit configuration diagrams showing an example of a voltage generation circuit and a switching switch applicable to the data driver according to the present embodiment.

FIG. 4 shows a specific configuration of a gradation voltage generator applicable to the data driver according to the present embodiment.

The data driver 140 applies digital-analog conversion processing to the display data (luminance gradation value), which is sequentially supplied as digital serial data from the display signal generation circuit 160, described later, and includes each of color components of, for example, red (R), green (G), and blue (B), with the use of a gamma correction curve (γ curve) having predetermined characteristics, to generate the gradation voltage Vpix (Vpix(r), Vpix(g), and Vpix(b)) gamma-corrected for each color component, and thus, to supply the generated gradation voltage Vpix to the display pixels PIX (sub pixels PXr, PXg, and PXb) of each color through the data lines Ld (Ldr, Ldg, and Ldb).

The data driver 140, as shown in, for example, FIG. 2, is provided with a shift register/data register 141, a gradation voltage generator (signal converter) 142, a demultiplexer (signal distribution circuit) 143, and a latch circuit (signal holding circuit) 144.

A set of the gradation voltage generator 142, the demultiplexer 143, and the latch circuit 144 are connected to the three adjacent data lines Ldr, Ldg, and Ldb respectively connected with a set of the display pixels PIX of three colors R, G, and B (sub pixels PXr, PXg, and PXb) forming the color pixel CPX. m/3 sets of the gradation voltage generator 142, the demultiplexer 143, and the latch circuit 144 are provided in the display apparatus 100 according to the present embodiment.

The shift register/data register 141 is provided with a shift register and a data register which sequentially output the shift signal based on the data control signal supplied from the system controller 150, for example. The data register sequentially captures the display data based on the sift signal. This display data is sequentially supplied as digital serial data from the display signal generation circuit 160 in order of R, G, B, R, G, B, . . . , and corresponds to the display pixel PIX corresponding to one line in the display area 110. The data register sequentially transfers the display data of three colors R, G, and B to the gradation voltage generator 142, which is provided in each of three columns connected with a set of the adjacent sub pixels PXr, PXg, and PXb forming the color pixel CPX.

The gradation voltage generator 142 generates and outputs the gradation signal (gradation voltage Vpix: Vpix(r), Vpix(g), and Vpix(b)) having a voltage value corresponding to the luminance value for making the organic EL element OLED emit light or emit no light (black display operation) at the luminance gradation based on the display data of the display pixels PIX of each color of R, G, and B (sub pixels PXr, PXg, and PXb) sequentially captured through the shift register/data register 141.

The gradation voltage Vpix (Vpix(r), Vpix(g), and Vpix(b)) in each color of R, G, and B generated by the gradation voltage generator 142 are different for each color in the electro-optic characteristics (luminance characteristics) of the organic EL element OLED. Therefore, in order to display each color of R, G, and B and, in addition, in order to favorably display white, the luminance gradation is required to be adjusted using different gamma correction curves, which have characteristics (correction characteristics) corresponding to the organic EL element OLED of each color, so as to obtain appropriate color balance.

In the present embodiment, on the basis of the maximum luminance reference voltages (highest gradation reference voltages) Vmax(R), Vmax(G), and Vmax(B) and the minimum luminance reference voltages (lowest gradation reference voltages) Vs(R), Vs(C), and Vs(B) which are switched and set in a time sharing manner for each color of R, G, and B, a plurality of gradation voltages, which are based on the bit number of the display data and correspond to a value that can be taken by the display data, are generated in the digital-analog conversion circuit having single gamma characteristics (γ curve). A value of each gradation voltage with respect to the value of the display data is the gamma correction curve. Setting is performed such that this gamma correction curve corresponds to the electro-optic characteristics of the organic EL element of each color of R, G, and B and has a different value for each color of R, G, and B. The display data is gamma-corrected with the use of this gamma correction curve corresponding to each color. According to this constitution, it is possible to obtain a practical effect that is equivalent to the case where the gamma correction processing is performed with the use of the individual gamma correction curves corresponding to the organic EL element OLED of each color of R, G, and B.

As shown, for example, in FIG. 4A, the gradation voltage generator 142 is specifically provided with a γ curve generation circuit (digital-analog conversion circuit) 142-1, a Vmax(X) generation circuit 142-2, an RGB switching switch 142-3, a Vs(X) generation circuit 142-4, and an RGB switching switch 142-5.

On the basis of the gradation reference voltage (the maximum luminance reference voltages Vmax(R), Vmax(G), and Vmax(B) and the minimum luminance reference voltages Vs(B), Vs(G), and Vs(B)), the γ curve generation circuit 142-1 generates the gradation voltages of the number corresponding to the number of gradations of the luminance gradation value based on the bit number of the display data (for example, when the display data has 8 bits, the number of gradations is 256). Based on the gradation voltages, the γ curve generation circuit 142-1 performs digital-analog conversion processing for converting the display data (digital data) of each color of R, G, and B, sequentially captured through the shift register/data register 141, into the Gradation signal of the analog signal voltage. At the same time, in this digital-analog conversion processing, the γ curve generation circuit 142-1 performs gamma correction processing in accordance with the electro-optic characteristics of the organic EL element OLED provided in the display pixel PIX of each color of R, G, and B.

As shown in, for example, FIG. 4B, the γ curve generation circuit 142-1 is specifically provided with a ladder resistor part 142-6 and a gradation voltage selection circuit 142-7.

The ladder resistor part 142-6 has a plurality of resistance elements R connected in series. The maximum luminance reference voltage (any of Vmax(R), Vmax(G), and Vmax(B)) and the minimum luminance reference voltage (any of Vs(R), Vs(G), and Vs(B)) are applied to the both ends of the ladder resistor part 142-6. As shown in FIG. 4B, the ladder resistor part 142-6 divides the potential difference between the maximum luminance reference voltage and the minimum luminance reference voltage by the resistance elements R and generates a plurality of gradation voltages VD0, VD1, VD2, . . . , and VD255.

The plurality of gradation voltages generated by the ladder resistor part 142-6 are applied to the gradation voltage selection circuit 142-7, and the display data of each color of R, G, and B is supplied to the gradation voltage selection circuit 142-7, whereby the gradation voltage selection circuit 142-7 selects the gradation voltage corresponding to the luminance gradation value of the display data to output the selected gradation voltage as the gradation signal.

The Vmax(X) generation circuit 142-2 generates the maximum luminance reference voltages Vmax(R), Vmax(G), and Vmax(B) based on the electro-optic characteristics of the organic EL element OLED of each color of P, G, and B to be supplied to the γ curve generation circuit 142-1.

The Vs(X) generation circuit 142-4 generates the minimum luminance reference voltages Vs(R), Vs(G), and Vs(B) based on the electro-optic characteristics of the organic EL element OLED of each color of R, G, and B to be supplied to the γ curve generation circuit 142-1.

As shown in, for example, FIG. 4C, the RGB switching switches 142-3 and 142-5 have switches SW(R), SW(G), and SW(B) and a switch control circuit 142-8.

In the RGB switching switch 142-3, the maximum luminance reference voltages Vmax(R), Vmax(G), and Vmax(B) from the Vmax(X) generation circuit 142-2 are applied to one end of the switches SW(R), SW(G), and SW(B), and the other ends of these switches are connected in common and connected to the γ curve generation circuit 142-1. The conduction of these switches is controlled by the switch control circuit 142-8. For example, when a synchronization signal CLK and RGB switching control signals S1 and S2 supplied as data control signals from the system controller 150 are applied to the switch control circuit 142-8, the switch control circuit 142-8 brings any one of the switches SW(R), SW(G), and SW(B) sequentially into a conduction state in response to the RGB switching control signals S1 and S2.

When the signal levels of the RGB switching control signals S1 and S2 are respectively high (H, H), the switch control circuit 142-8 brings the switch SW(R) into a conduction state at a rising timing of the synchronization signal CLK, and, at the same time, brings the switches SW(G) and SW(B) into a non-conduction state. When the signal levels of the RGB switching control signals S1 and S2 are respectively high (H) and low (L), the switch control circuit 142-8 brings the switch SW(G) into the conduction state at the rising timing of the synchronization signal CLK, and, at the same time, brings the switches SW(R) and SW(B) into the non-conduction state. When the signal levels of the RGB switching control signals S1 and S2 are respectively low (L, L), the switch control circuit 142-8 brings the switch SW(B) into the conduction state at the rising timing of the synchronization signal CLK, and, at the same time, brings the switches SW(R) and SW(G) into the non-conduction state.

According to the above constitution, any of the maximum luminance reference voltages Vmax(R), Vmax(G), and Vmax(B) is sequentially supplied to the γ curve generation circuit 142-1 through the RGB switching switch 142-3.

The RGB switching switch 142-5 has a configuration equivalent to the RGB switching switch 142-3. In the RGB switching switch 142-5, the minimum luminance reference voltages Vs(R), Vs(G), and Vs(B) from the Vs(X) generation circuit 142-4 are applied to one end of the switches SW(R), SW(G), and SW(B), and the other ends of these switches are connected in common and connected to the γ curve generation circuit 142-1. The conduction of these switches is controlled by the switch control circuit 142-8. According to this constitution, any of the minimum luminance reference voltages Vs(R), Vs(G), and Vs(B) is sequentially supplied to the γ curve generation circuit 142-1 through the RGB switching switch 142-5.

According to the above constitution, the gradation voltage generator 142 is controlled so that, based on the synchronization signal CLK and the RGB switching control signals S1 and S2, the combination for each color of the maximum luminance reference voltages Vmax(R), Vmax(G), and Vmax(B), generated by the Vmax(X) generation circuit 142-2 and the minimum luminance reference voltages Vs(R), Vs(G), and Vs(B), generated by the Vs(X) generation circuit 142-4, that is, Vmax(R) and Vs(R), Vmax(G) and Vs(G), and Vmax(B) and Vs(B) are selectively (in a time sharing manner) supplied to the γ curve generation circuit 142-1 through the RGB switching switches 142-3 and 142-5 in accordance with the timing of capturing the display data corresponding to the sub pixels of three colors R, G, and B (PXr, PXg, and Pxb).

In the γ curve generation circuit 142-1 in the gradation voltage generator 142, the digital-analog conversion processing is applied in a time sharing manner to the display data of each color of R, G, and B, sequentially captured through the shift register/data register 141, with the use of the different gamma correction curves which have characteristics specified by the maximum luminance reference voltages Vmax(P), Vmax(G), and Vmax(B) and the minimum luminance reference voltages Vs(R), Vs(G), and Vs(B), and the gamma-corrected analog signal voltage is generated to be sequentially output as the gradation voltage Vpix of each color (Vpix(r), Vpix(g), and Vpix(b)) to the post-stage demultiplexer 143.

As shown in, for example, FIG. 5A, a circuit configuration having a switch part SW1, ladder resistors R1 to R4, and switch parts SW2r, SW2g, and SW2b can be applied to the Vmax(X) generation circuit 142-2 or the Vs(X) generation circuit 142-4. The switch part SW1 is connected to a reference voltage such as the ground potential Vgnd and a high potential side reference voltage Vmax or a low potential side reference voltage Vs. The ground potential Vgnd and the high potential side reference voltage Vmax or the low potential side reference voltage Vs are applied to the ladder resistors R1 to P4 through the switch part SW1. The switch parts SW2r, SW2g, and SW2b take out and output the maximum luminance reference voltages Vmax(R), Vmax(G), and Vmax(B) or the minimum luminance reference voltages Vs(R), Vs(G), and Vs(B) from each of the contact points of the ladder resistors R1 to R4.

The switch part SW1 is specifically provided with two switches. In the one switch, a contact point a1 on one end side of the switch part SW1 is connected to a reference voltage such as the ground potential Vgnd, a contact point b1 on the other end side is connected to the other end side of the ladder resistors R1 to R4 (the right side of FIG. 5A), and a contact point b2 is connected to the one end side of the ladder resistors R1 to R4 (the resistance R1 side on the left side of FIG. 5A). In the other switch, a contact point a2 on the one end side is connected to the high potential side reference voltage Vmax or the low potential side reference voltage Vs through a predetermined resistor, and a contact point b3 on the other end side is connected to the other end side of the ladder resistors R1 to R4 (the resistance R4 side on the right side of FIG. 5A). These switches are interlocked with each other, whereby the contact points a1 and a2 are set in one of two states, i.e., a state where the contact points a1 and a2 are respectively connected to the contact point b1 and the contact point b2 and a state where the contact points a1 and a2 are respectively connected to the contact point b2 and the contact point b3.

Namely, when the contact points a1 and a2 are respectively connected to the contact points b1 and b2, the high potential side reference voltage Vmax or the low potential side reference voltage Vs is applied to the resistance R1 side of the ladder resistors R1 to R4, and, at the same time, the ground potential Vgnd is applied to the resistance R4 side. Meanwhile, when the contact points a1 and a2 are respectively connected to the contact points b2 and b3, the ground potential Vgnd is applied to the resistance R1 side of the ladder resistors S1 to R4, and, at the same time, the high potential side reference voltage Vmax or the low potential side reference voltage Vs is applied to the resistance R4 side. According to this constitution, the voltage applied to the both ends of the ladder resistors R1 to R4 is divided in response to each resistance value to be taken out from each contact point.

In the switch part SW2r, specifically, a contact point c1 on the one end side of the switch part SW2r is connected to an output line of red (R) color of the high potential side reference voltage Vmax(R) or the low potential side reference voltage Vs(R), contact points r and b on the other end side are connected to a connection contact point between the resistance R1 and the resistance R2, and a contact point g is connected to the connection contact point between the resistance R2 and the resistance R3.

In the switch part SW2g, specifically, a contact point c2 on the one end side of the switch part SW2g is connected to an output line of green (G) color of the high potential side reference voltage Vmax(G) or the low potential side reference voltage Vs(G), contact point r on the other end side is connected to the contact point between the resistance R2 and the resistance R3, a contact point g is connected to the connection contact point between the resistance R1 and the resistance R2, and a contact point b is connected to the connection contact point between the resistance R3 and the resistance R4.

In the switch part SW2b, specifically, a contact point c3 on the one end side of the switch part SW2b is connected to an output line of green (B) color of the high potential side reference voltage Vmax(B) or the low potential side reference voltage Vs(B), contact points r and g on the other end side are connected to the connection contact point between the resistance R3 and the resistance R4, and a contact point b is connected to the connection contact point between the resistance R2 and the resistance R3.

The switches SW2r, SW2g, and SW2b are interlocked with each other, whereby three states where the contact points c1, c2, and c3 are respectively connected to any one of the contact points r, g, and b are set.

Each resistance of the ladder resistors R1 to R4 has a configuration shown in, for example, FIG. 5B. Namely, these resistances have a circuit configuration in which a path to which three unit resistors R having the same resistance value are connected in series, a path to which the two unit resistors R having the same resistance value are connected in series, a path to which the single unit resistor R is connected, and a path to which the unit resistor R is not connected are connected in parallel. Predetermined positions La1 to La3 and Lb1 to Lb3 in the arbitrary path are cut, whereby the resistance value can be set in any of four resistance values.

According to the above constitution, as shown in, for example, Table 1, the switch parts SW2r (the contact point c1 of the switch parts SW2r), SW2g (contact point c2), and SW2b (contact point c3) are respectively connected to the contact point r in such a state that the switch part SW1 (the contact points a1 and a2 of the switch part SW1) is connected to the contact points b1 and b2, whereby the maximum luminance reference voltages Vmax(R), Vmax(G), and Vmax(B) which have a higher voltage value in order of R, G, and B (Vmax(R)≧Vmax(G)≧Vmax(B)) or the minimum luminance reference voltages Vs(R), Vs(G), and Vs(B) which have a higher voltage value in order of R, G, and B (Vs(R)≧Vs(G)≧Vs(B)) can be generated.

The switch parts SW2r (the contact point c1 of the switch parts SW2r), SW2g (contact point c2), and SW2b (contact point c3) are respectively connected to the contact point g, whereby the maximum luminance reference voltages Vmax(G), Vmax(R), and Vmax(B) which have a higher voltage value in order of G, R, and B (Vmax(G)≧Vmax(R)≧Vmax(B)) or the minimum luminance reference voltages Vs(G), Vs(R), and Vs(B) which have a higher voltage value in order of G, R, and B (Vs(G)≧Vs(R)≧Vs(B)) can be generated.

The switch parts SW2r (the contact point c1 of the switch parts SW2r), SW2g (contact point c2), and SW2b (contact point c3) are connected to the contact point b, whereby the maximum luminance reference voltages Vmax(R), Vmax(B), and Vmax(G) which have a higher voltage value in order of R, B, and G (Vmax(R)≧Vmax(B)≧Vmax(G)) or the minimum luminance reference voltages Vs(R), Vs(B), and Vs(G) which have a higher voltage value in order of R, B, and G (Vs(R)≧Vs(B)≧Vs(G)) can be generated.

The switch parts SW2r (the contact point c1 of the switch parts SW2r), SW2g (contact point c2), and SW2b (contact point c3) are respectively connected to the contact point r in such a state that the switch part SW1 (the contact points a1 and a2 of the switch part SW1) is connected to the contact points b2 and b3, whereby the maximum luminance reference voltages Vmax(B), Vmax(G), and Vmax(R) which have a higher voltage value in order of B, G, and k (Vmax(B)≧Vmax(G)≧Vmax(R)) or the minimum luminance reference voltages Vs(B), Vs(G), and Vs(R) which have a higher voltage value in order of B, G, and R (Vs(B)≧Vs(G)≧Vs(R)) can be generated.

The switch parts SW2r (the contact point c1 of the switch parts SW2r), SW2g (contact point c2), and SW2b (contact point c3) are respectively connected to the contact point g, whereby the maximum luminance reference voltages Vmax(B), Vmax(R), and Vmax(G) which have a higher voltage value in order of B, R, and G (Vmax(B)≧Vmax(R)≧Vmax(G)) or the minimum luminance reference voltages Vs(B), Vs(R), and Vs(G) which have a higher voltage value in order of B, R, and G (Vs(B)≧Vs(R)≧Vs(G)) can be generated.

The switch parts SW2r (the contact point c1 of the switch parts SW2r), SW2g (contact point c2), and SW2b (contact point c3) are respectively connected to the contact point b, whereby the maximum luminance reference voltages Vmax(G), Vmax(B), and Vmax(R) which have a higher voltage value in order of G, B, and R (Vmax(G)≧Vmax(B)≧Vmax(R)) or the minimum luminance reference voltages Vs(G), Vs(B), and Vs(R) which have a higher voltage value in order of G, B, and R (Vs(G)≧Vs(B)≧Vs(R)) can be generated.

The switch parts SW1, SW2r, SW2g, and SW2b are set in response to the order of the array of the sub pixels (color pixels) PXr, PXg, and PXb in each color pixel CPX in the display panel 170 and the electro-optic characteristics of the organic EL element OLED in each sub pixel. For example, when these switch parts are used with respect to one display panel 170, they are fixed to one setting.

Thus, in the Vmax(X) generation circuit 142-2 or the Vs(X) generation circuit 142-4 in the data driver 140 (gradation voltage generator 142) according to the present embodiment, the ladder resistors R1 to R4 are suitably set, whereby the light emission color (luminance gradation value) in the light emitting element (organic EL element OLED) of each color of R, G, and B is adjusted, and the maximum luminance reference voltages Vmax(R), Vmax(G), and Vmax(B) and the minimum luminance reference voltages Vs(R), Vs(G), an Vs(B), which specify the characteristics of the gamma correction curve used in the gamma correction processing in the γ curve generation circuit 142-1, can be set and supplied so as to obtain appropriate color balance. In the present embodiment, the minimum luminance reference voltages Vs(R), Vs(G), and Vs(B) correspond to a light emission start voltage in the organic EL element OLED of each color of R, G, and B.

TABLE 1

| | | | | | | | |
|---|---|---|---|---|---|---|---|
| Connection | SW1 | b1, b2 | b1, b2 | b1, b2 | b2, b3 | b2, b3 | b2, b3 |
| contact | SW2r | r | g | b | r | g | b |
| point | SW2g | r | g | b | r | g | b |
| | SW2b | r | g | b | r | g | b |

| | | | | | | |
|---|---|---|---|---|---|---|
| Voltage order | RGB | GRB | RBG | BGR | BRG | GBR |

Next, in the gradation voltage generator 142 applied to the present embodiment, the relation between the voltage value of the maximum luminance reference voltage and the minimum luminance reference voltage switched and set in a time sharing manner and the electro-optic characteristics (organic EL element OLED) of the light emitting element of each color of R, G, and B will be described.

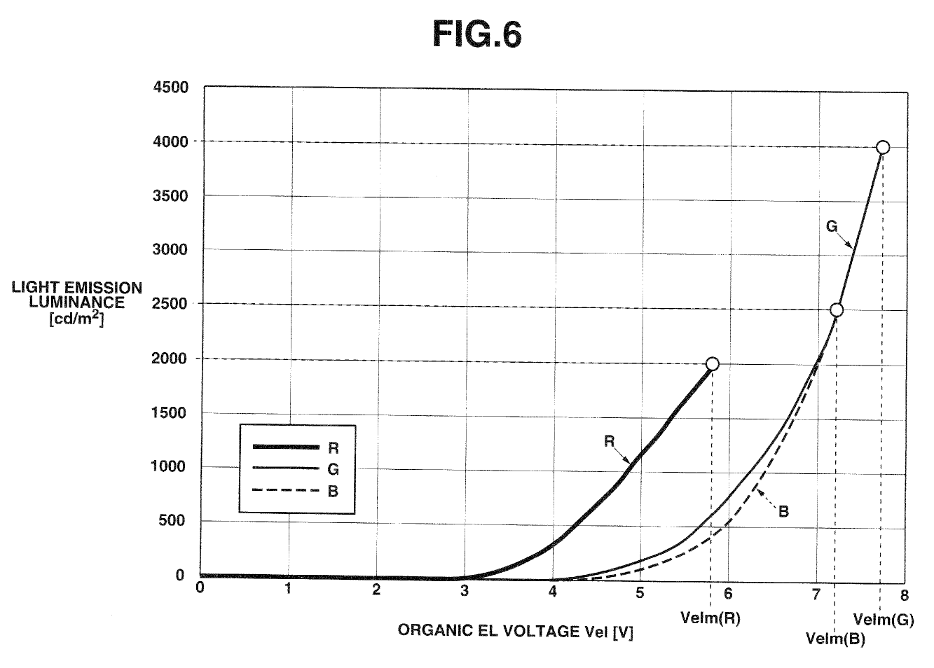

FIG. 6 is a voltage-luminance characteristic diagram showing a relation between a voltage (an organic EL voltage), applied to between an anode and a cathode of the organic EL element of each color of R, G, and B, and the light emission luminance.

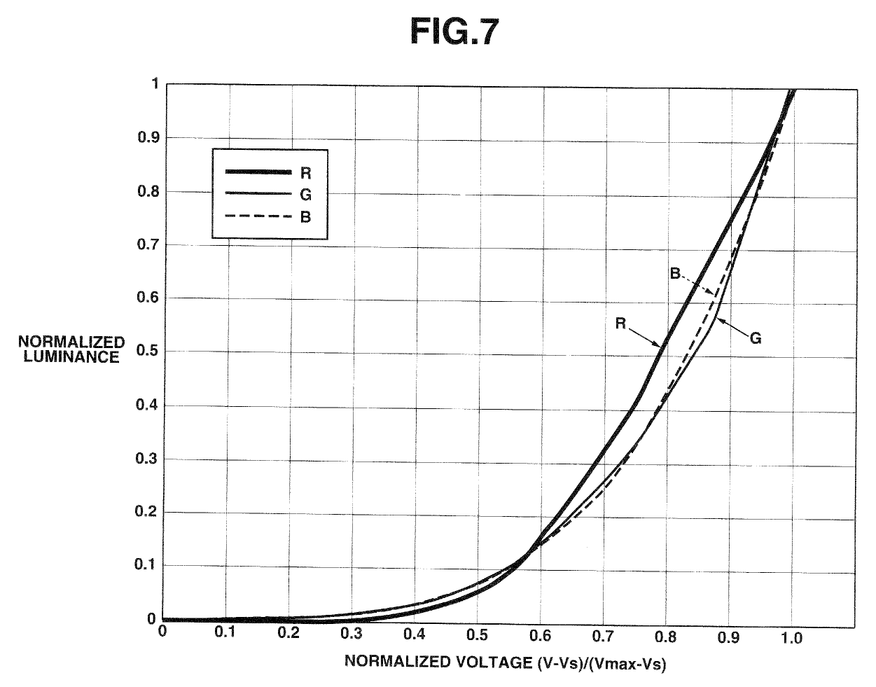

FIG. 7 is a normalized voltage-luminance characteristic diagram showing a relation between a normalized voltage and the light emission luminance in voltage-luminance characteristics of the organic EL element.

In order to realize the display pixel of each color of R, G, and B, when a pixel circuit design including a pixel aperture ratio and the device size of, for example, a transistor is substantially the same in each color, and, in addition, when the organic EL element having a device structure which is different for each color is applied, as shown in, for example, FIG. 6, a voltage-luminance characteristic curve showing a relation between the voltage (organic EL voltage) Vel, applied to between the anode and the cathode of the organic EL element and the light emission luminance is different for each color of R, G, and B, due to setting of a luminance balance in each color of R, G, and B in the realization of white display with the three colors and the difference in current efficiency of each device. Therefore, the organic EL voltages (maximum luminance light emitting voltages) Velm(R), Velm(G), and Velm(B) for light emission at a maximum (highest) gradation level in each color of R, G, and B differ for each color. In FIG. 6, the light emission luminance in the maximum luminance light emitting voltages Velm(R), Velm(G), and Velm(B) of each color of R, G, and B are respectively 2000 cd/m², 4000 cd/m², and 2500 cd/m², and the luminance balance is set so that R:G:B=4:8:5.

In FIG. 6, when the organic EL voltages (light emission start voltages) Vels(R), Vels(G), and Vels(B) as the minimum (lowest) luminance gradation in each color of R, G, and B are equalized, and, in addition, when the voltage (organic EL voltage) and the light emission luminance are respectively normalized, the relation between them is as shown in FIG. 7. In FIG. 7, a difference for each color between the organic EL voltage Vel and the light emission start voltage Vels divided by a difference between the maximum luminance light emitting voltage Velm and the light emission start voltage Vels to normalize voltage components ((Vel−Vels)/(Velm−Vels)), and each light emission luminance in the normalized voltage is divided by the maximum luminance to normalize luminance components.

According to FIG. 7, in the organic EL voltage Vel, the light emission start voltage for each color of R, G, and B (Vels(R), Vels(G), and Vels(B)) is corrected, and, in addition, normalized with the use of the maximum luminance light emitting voltage Velm, whereby output curves (gradation-voltage characteristic curves) of colors R, G, and B can be made substantially the same, and luminance curves (voltage-luminance characteristic curves) of R, G, and B can be made substantially equivalent. The output curves show the relation of an output voltage (analog gradation voltage) to the luminance gradation value in a digital-analog conversion circuit (gradation voltage generator) which supplies the gradation voltage corresponding to the display data (luminance gradation value) to the display pixel (organic EL element), and the luminance curves show the relation between the organic EL voltage corresponding to the output voltage (gradation voltage) and the light emission luminance of the organic EL element.

Namely, in the single digital-analog conversion circuit having a single (common) gamma characteristic, either or both of the maximum luminance reference voltages Vmax(R), Vmax(G), and Vmax(B) for generating the output voltage (maximum luminance light emission voltage) corresponding to the maximum (highest) luminance gradation value and the minimum luminance reference voltages Vs(R), Vs(G), and Vs(B) for generating the output voltage (light emission start voltage) corresponding to the minimum (lowest) luminance gradation value is switched and set for each of the display data of R, G, and B, whereby the gradation-luminance characteristic curve (gamma correction curve) can be made to correspond to each color, the gradation-luminance characteristic curve showing the relation of the light emission luminance in the organic EL element to the luminance gradation value of each color of R, G, and B included in the display data.

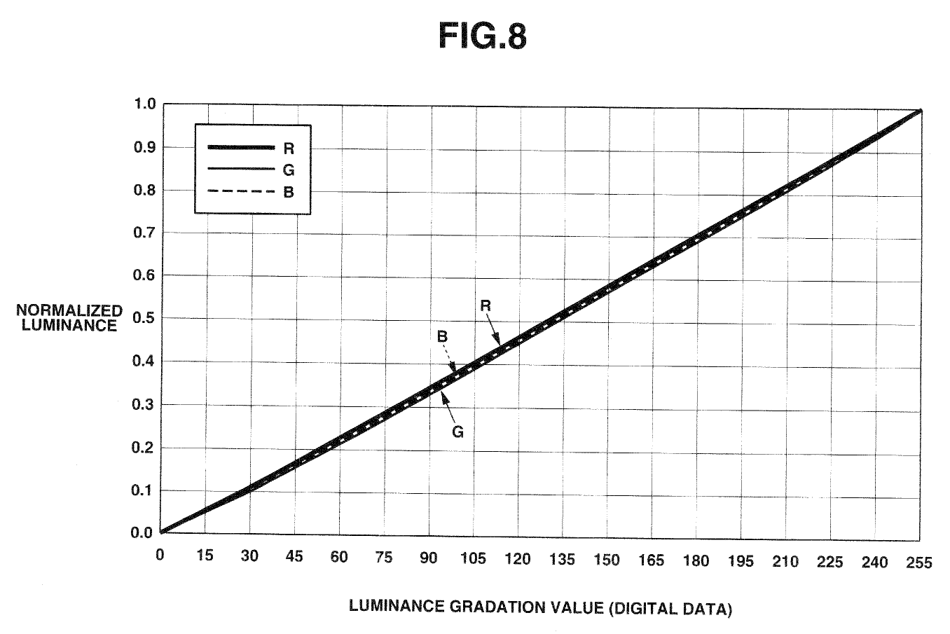

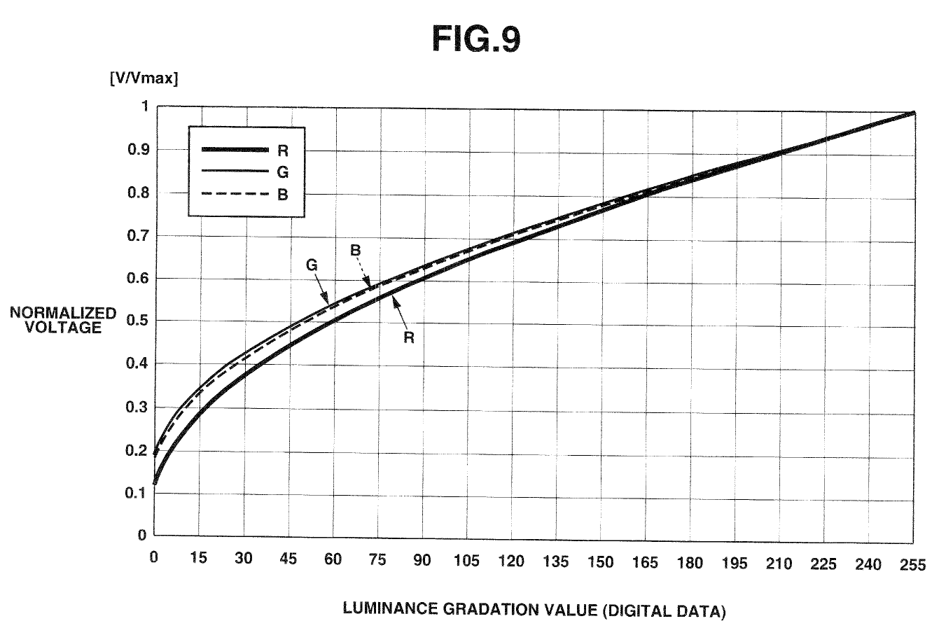

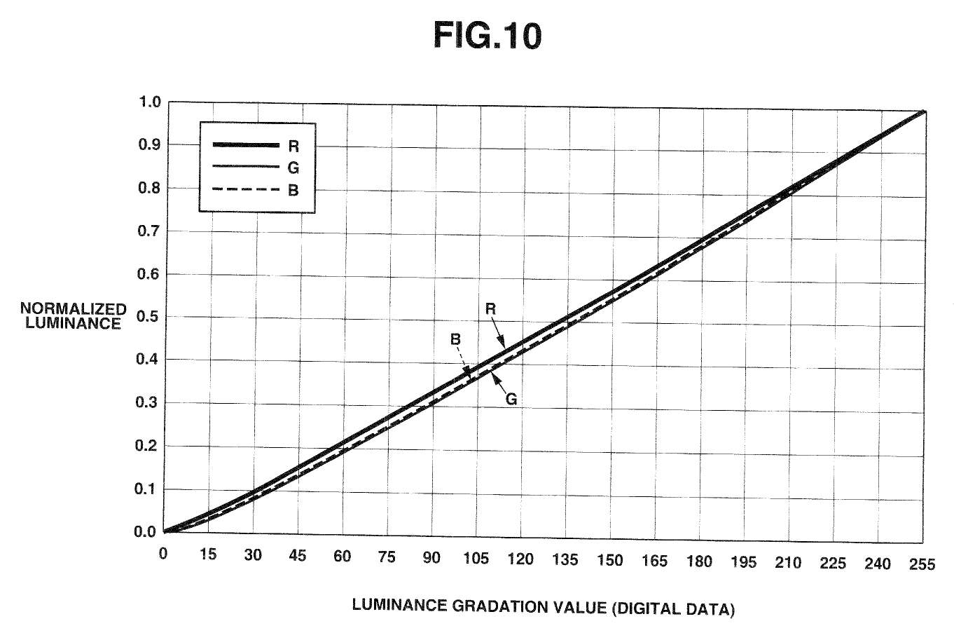

In the gradation voltage generator 142 according to the present embodiment, the relation of the light emission luminance to the luminance gradation value included in the display data is verified in detail. When with regard to the organic EL element of each color which is set so that R:G:B=4:8:5 as the luminance balance among R, G, and B, the light emission start voltage of each color of R, G, and B is switched and set so that, for example, Vs(R)=2V, Vs(G)=2.8V, and Vs(B)=3.4V, it is found that in the relation of the normalized luminance (the light emission luminance normalized by the maximum luminance) to the luminance gradation value of 8 bit 256 gradations, the gradation-luminance characteristic curves of R, G, and B colors substantially correspond to each other, as shown in FIG. 8, for example, and its variation can be controlled to less than 1%. In this case, the relation of the normalized voltage (the output voltage normalized by the maximum output voltage) to the luminance gradation value in the digital-analog conversion executed in the gradation voltage generator 142 (γ curve generation circuit 142-2) substantially corresponds in each color of R, G, and B, as shown in FIG. 9. Meanwhile, when the light emission start voltage is not switched and set for each color, in the relation of the normalized luminance to the luminance gradation value, a difference among the R, G, and B colors is generated, as shown in FIG. 10, for example, and it is observed that the variation in such difference reaches up to 2.7%.

FIG. 8 is a gradation-luminance characteristic diagram showing a relation between the luminance gradation value and the normalized light emission luminance in a case in which the light emission start voltage is switched and set for each color of R, G, and B in the gradation voltage generator according to the present embodiment.

FIG. 9 is a gradation-voltage characteristic diagram showing a relation between the luminance gradation value and the normalized output voltage of each color in the gradation voltage generator (γ curve generation circuit) according to the present embodiment.

FIG. 10 is a gradation-luminance characteristic diagram showing a relation between the luminance gradation value and the normalized light emission luminance in a case in which the light emission start voltage is fixed.

As descried in the above embodiment, in the single (common) γ curve generation circuit provided in the gradation voltage generator, synchronously with the timing of capturing the display data of each color of R, G, and B, the gradation voltage corresponding to the electro-optic characteristics of the organic EL element can be generated for each color of R, G, and B, based on the γ curve (gradation-voltage characteristic curve) specified by the application of the reference voltage switched in a time sharing manner of at least either or preferably both of the maximum luminance reference voltages Vmax(R), Vmax(G), and Vmax(B) and the minimum luminance reference voltages Vs(R), Vs(G), and Vs(B), and the organic EL element of each color can be made to emit light at the light emission luminance corresponding to the luminance gradation value included in the display data, on the basis of the voltage-luminance characteristic curve in the organic EL, element of each color of R, G, and B.

The demultiplexer 143 distributes in a time sharing manner the gradation voltage Vpix of each color (Vpix(r), Vpix(g), and Vpix(b)), sequentially output from the gradation voltage generator 142, on the basis of, for example, the RGB switching control signals S1 and S2 supplied as the data control signal from the system controller 150, to generate the gradation voltages of R, G, B colors Vpix(r), Vpix(g), and Vpix(h), and thus, to output in parallel the generated gradation voltages to the post stage latch circuit 144 through the individual signal lines. Namely, the demultiplexer 143 applied to the present embodiment has a function of converting in a time sharing manner the sequentially input serial signals (gradation voltages Vpix) into 1:3 (=the number of inputs:the number of outputs) to generate three parallel signals (gradation voltages Vpix(r), Vpix(g), and Vpix(b)).

The latch circuit 144 latches (temporarily holds) the respective gradation voltages Vpix(r), Vpix(g), and Vpix(b) output in parallel from the demultiplexer 143, and outputs the gradation voltages Vpix(r), Vpix(g), and Vpix(b) in parallel at the same timing to the data lines Ldr, Ldg, and Ldb in each column, to which the adjacent sub pixels of three colors R, G, and B (PXr, PXg, and PXb) are connected, on the basis of, for example, an output control signal OEN supplied as the data control signal from the system controller 150.

### (System Controller)

The system controller 150 generates a selection control signal, a power control signal, and a data control signal, controlling the operation state, to output these signals respectively to the select driver 120, the power driver 130, and the data driver 140, and to thereby operate these drivers at a predetermined timing. Based on the control by the system controller 150, these drivers generate and output respectively the selection signal Ssel, the power voltage Vcc and the gradation voltage Vpix (Vpix(r), Vpix(g), and Vpix(b)) to perform a series of drive control operations (display data capture operation/gradation voltage generating operation, write operation, holding operation, and light emitting operation) in each display pixel PIX (sub pixels PXr, PXg, and PXb), and thus, to display in the display area 110 the image information based on a video signal.

### (Display Signal Generation Circuit)

The display signal generation circuit 160 extracts the luminance gradation signal component from the video signal supplied from outside the display apparatus 100, for example, and supplies the luminance gradation signal component as the display data (continuous luminance gradation data (serial data) corresponding to each of the sub pixels R, G, B, R, G, B, R, . . . ), constituted of a digital signal, to the data driver 140 for each one line in the display area 110. When the video signal includes a timing signal component specifying the timing of displaying the image information, such as a television broadcast signal (composite video signal), the display signal generation circuit 160 may have a function of extracting the timing signal component to supply the extracted timing signal component to the system controller 150, in addition to the function of extracting the luminance gradation signal component. In this case, the system controller 150 generates control signals, which are respectively supplied to the select driver 120, the power driver 130, and the data driver 140, on the basis of the timing signal supplied from the display signal generation circuit 160.

### <Method of Driving Display Apparatus>

Next, a method of driving the display apparatus according to the present embodiment will be described.

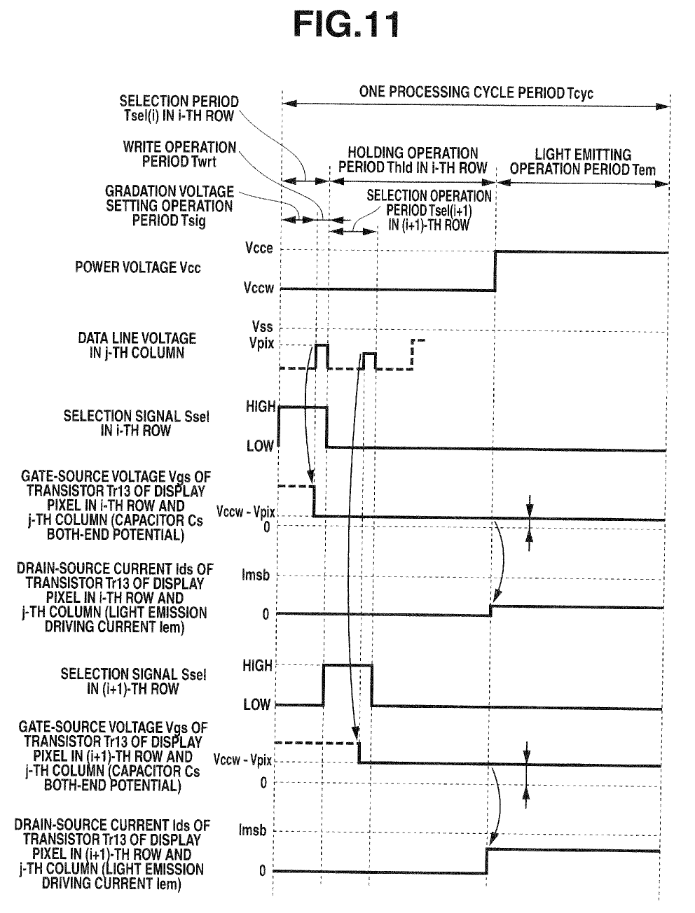

FIG. 11 is a timing chart showing an example of the method of driving the display apparatus according to the present embodiment.

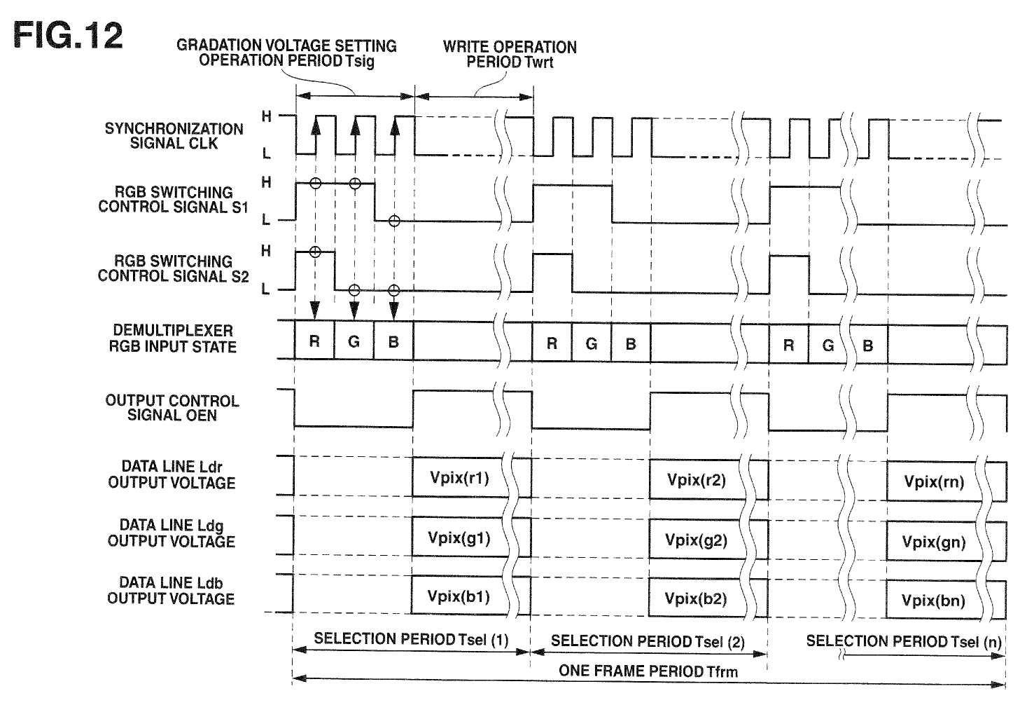

FIG. 12 is a timing chart showing a specific example of a selection operation applied to the method of driving the display apparatus according to the present embodiment.

In this example, for convenience of explanation, FIGS. 11 and 12 show the timing chart in the case where, regarding the display pixels PIX (sub pixels PXr, PXg, and PXb) arrayed in a matrix form in the display area 110, the display pixels PIX in i-th row, j-th column and (i+1)-th row, j-th column (i is an positive integer satisfying 1≦i≦n, and j is a positive integer satisfying 1≦j≦m) are made to emit light at the luminance gradation corresponding to the display data supplied from the display signal generation circuit 160.

As shown in, for example, FIG. 11, the drive control operation in the display apparatus 100 according to the present embodiment is set so that the gradation voltage setting operation (gradation voltage setting operation period Tsig), the write operation (write operation period Twrt), the holding operation (holding operation period Thld), and the light emitting operation (light emitting operation period Tem) are performed (Tcyc≧Tsig+Twrt+Thld+Tem).

In the gradation voltage setting operation, in the display pixels PIX in, for example, any of the group in the upper area and the group in the lower area including i-th row and (i+1)-th row, the display data (luminance gradation data), which is composed of R, G, and B and supplied through the shift register/data register 141 from the display signal generation circuit 160, is captured in the gradation voltage generator 142 in order of, for example, R, G, and B within one predetermined processing cycle period Tcyc, the digital-analog conversion processing is sequentially applied to the display data with the use of the gamma correction curve having characteristics corresponding to the color component of the display data, and the gradation voltages Vpix (Vpix(r), Vpix(g), and Vpix(b)) composed of the gamma corrected analog signal are generated.

In the write operation, the gradation voltages Vpix (Vpix(r), Vpix(g), and Vpix(b)) respectively generated for R, G, and B colors are output in parallel at the same timing to the sub pixels of R, G, and B colors (PXr, PXg, and PXb) through the data lines Ldr, Ldg, and Ldb in each column.

In the holding operation, the voltage component, which is written and set in between the gate and the source of the transistor Tr13, provided in the pixel driving circuit DC of the display pixel PIX of each color (sub pixels PXr, PXg, and PXb), by virtue of the write operation and corresponds to the gradation voltage Vpix (Vpix(r), Vpix(g), and Vpix(b)), is charged and held in the capacitor Cs.

In the light emitting operation, based on the voltage component held in the capacitor Cs by the holding operation, a light emission driving current Iem having a current value corresponding to the display data is applied to the organic EL element OLED to make the organic EL, element OLED emit light at a desired luminance gradation.

As shown in FIG. 12, the gradation voltage setting operation and the write operation are set so as to be executed within a selection period Tsel(i) in the relevant row (i-th row) (Tsel≧Tsig+Twrt). In the gradation voltage setting operation period Tsig, as shown in FIG. 12, setting is performed so that the display data capture operation and the gradation voltage generating operation are continuously performed as a series of operations in such a state that the power voltage Vcc (=Vccw) of a low level is applied to the power voltage line Lv. In the display data capture operation, the display data supplied in a time sharing manner in order of R, G, and B from the display signal generation circuit 160 through the shift register/data register 141 is captured in the gradation voltage generator 142. In the gradation voltage generating operation, the display data of each color of R, G, and B is sequentially digital-analog converted with the use of the gamma correction curve specified in its characteristics based on the maximum luminance reference voltages Vmax(R), Vmax(G), and Vmax(B) and the minimum luminance reference voltages Vs(R), Vs(G), and Vs(B) switched and set in accordance with the color of the display data, whereby the gamma-corrected gradation voltages Vpix (Vpix(r), Vpix(g), and Vpix(b)) are generated.

In the light emitting operation period Tem, the current value of the light emission driving current Iem passing through the organic EL element OLED follows the current value of a drain-source current Ids passing through between the drain and source of the transistor Tr13, provided in the pixel driving circuit DC, in the write operation period Twrt, and these current values are preferably equal to each other.

The above operations are executed based on various control signals supplied from the system controller 150. The one processing cycle period Tcyc applied to the drive control operation according to the present embodiment is set to, for example, a period required for displaying one pixel of the image information, regarding images in which one color pixel CPX (a set of sub pixels PXr, PXg, and PXb) is one frame. Namely, when one frame of an image is displayed in the display area 110 in which a plurality of the display pixels PIX are arrayed in a matrix form in the row and column directions, the one processing cycle period Tcyc is set to a period required for displaying one row of image, regarding images in which one row of the display pixels PIX is one frame.

Hereinafter, the above operations will be specifically described appropriately with reference to the timing charts of FIGS. 11 and 12.

### (Display Data Capture Operation/Gradation Voltage Generating Operation)

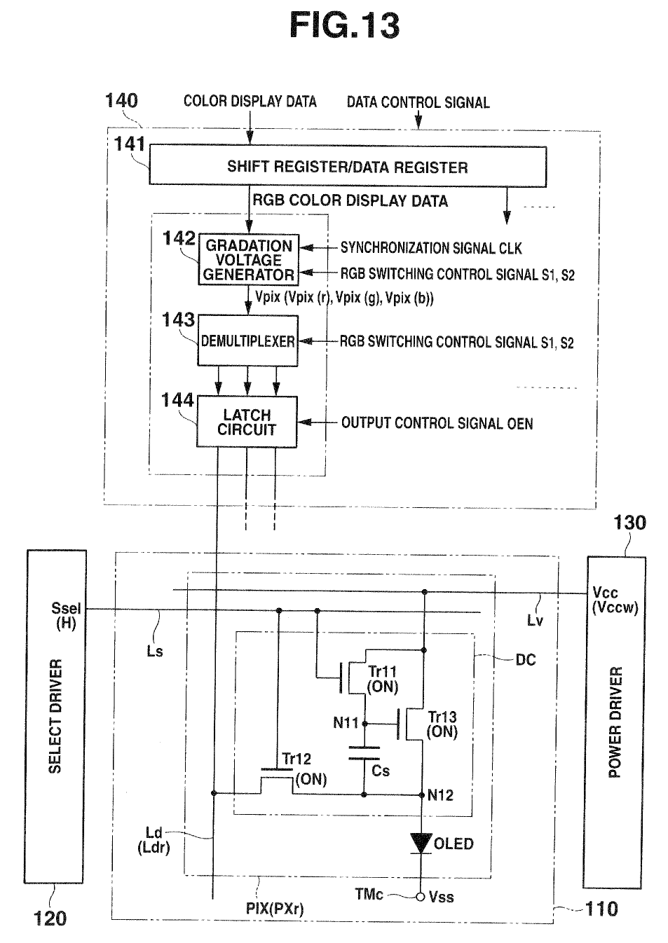

FIG. 13 is a conceptual diagram showing the capture operation for the display data and the gradation voltage generating operation in the display apparatus according to the present embodiment.

In the respective operation schematic diagrams shown in the drawings following FIG. 13, regarding the sub pixels of three colors R, G, and B (PXr, PXg, and PXb), only the sub pixel PXr is described as the display pixel PIX in which the gradation voltage Vpix corresponding to the display data is supplied to the data driver 140.

In the display data capture operation according to the present embodiment, as shown in FIGS. 11 to 13, in the gradation voltage setting operation period Tsig, in such a state that the low potential power voltage Vcc (=Vccw≦reference voltage Vss) of the write operation level is applied from the power driver 130 to the power voltage line Lv (in the display apparatus shown in FIG. 1, the power voltage line Lv commonly connected to all the display pixels PIX (sub pixels PXr, PXg, and PXb) of a group including i-th row) connected to the display pixel PIX in an i-th row, the selection signal Ssel of the selection level (high level) is applied from the select driver 120 to the select line Ls in the i-th row, and the display pixels PIX (sub pixels PXr, PXg, and PXb) in the i-th row is set in a selected state.

According to the above constitution, the transistor Tr11 provided in the pixel driving circuit DC of the display pixel PIX in the i-th row is turned on, the transistor Tr13 (drive transistor) is set in a diode-connection state, and the power voltage Vcc (=Vccw) is applied to the drain terminal and the gate terminal of the transistor Tr13 (contact point N11: one end side of the capacitor Cs). At the same time, the transistor Tr12 is also held in the ON state, and the source terminal of the transistor Tr13 (contact point N12: the other end side of the capacitor Cs) is electrically connected to the data line Ld in each column.

Meanwhile, synchronously with that timing, based on the data control signal supplied from the system controller 150, as shown in FIGS. 12 and 13, in the data driver 140, the display data supplied as the digital serial data in order of R, G, B, R, G, B, . . . from the display signal generation circuit 160 is sequentially captured through the shift register/data register 141 to be transferred in a time sharing manner to the gradation voltage generator 142 each provided so as to correspond for each three columns (data lines Ldr, Ldg, and Ldb) to which the sub pixels PIX of three colors of R, G, and B (PXr, PXg, and PXb) provided adjacent to one another are respectively connected (display data capture operation).

On the basis of the luminance gradation value of the display data (RGB display data) captured in order of R, G, and B, the gradation voltage generator 142 generates in a time sharing manner the gradation voltages Vpix (Vpix(r), Vpix(g), and Vpix(b)) for making the organic EL element OLED of the display pixels PIX of three colors of R, G, and B (sub pixels PXr, PXg, and PXb) emit light or emit no light (black display operation) at a predetermined luminance gradation.

Specifically, as shown in FIG. 12, in the rising timing of the synchronization signal CLK supplied from the system controller 150, when the signal levels of the RGB switching control signals S1 and S2 are respectively high (H, H), the switch SW(R) is brought into the conduction state by the switch control circuit 142-8 of the RGB switching switches 142-3 and 142-5, and the switches SW(G) and SW(B) are brought into the non-conduction state. According to this constitution, regarding the maximum luminance reference voltages Vmax(R), Vmax(G), and Vmax(B) previously set in the Vmax(X) generation circuit 142-2, the maximum luminance reference voltage Vmax(R) corresponding to red (R) color is applied to the γ curve generation circuit 142-1 through the switch SW(R) in the RGB switching switch 142-3. In addition, regarding the minimum luminance reference voltages Vs(R), Vs(G), and Vs(B) previously set in the Vs(X) generation circuit 142-4, the minimum luminance reference voltage Vs(R) corresponding to red (R) color is applied to the γ curve generation circuit 142-1 through the switch SW(R) of the RGB switching switch 142-5.

Further, in the rising timing of the synchronization signal CLK, when the signal levels of the RGB switching control signals S1 and S2 are respectively high (H) and low (L), the switch SW(G) is brought into the conduction state by the switch control circuit 142-8 of the RGB switching switches 142-3 and 142-5, and the switches SW(R) and SW(B) are Drought into the non-conduction state. According to this constitution, the maximum luminance reference voltage Vmax(G) corresponding to green (G) color is applied from the Vmax(X) generation circuit 142-2 to the γ curve generation circuit 142-1 through the switch SW(G) of the RGB switching switch 142-3, and the minimum luminance reference voltage Vs(G) corresponding to green (G) color is applied from the Vs(X) generation circuit 142-4 to the γ curve generation circuit 142-1 through the switch SW(G) of the RGB switching switch 142-5.

Further, in the rising timing of the synchronization signal CLK, when the signal levels of the RGB switching control signals S1 and S2 are respectively low (L, L), the switch SW(B) is brought into the conduction state by the switch control circuit 142-8 of the RGB switching switches 142-3 and 142-5, and the switches SW(R) and SW(G) are brought into the non-conduction state. According to this constitution, the maximum luminance reference voltage Vmax(B) corresponding to blue (B) color is applied from the Vmax(X) generation circuit 144-2 to the γ curve generation circuit 142-1 through the switch SW(B) in the RGB switching switch 142-3, and the minimum luminance reference voltage Vs(B) corresponding to blue (B) color is applied from the Vs(X) generation circuit 142-4 to the γ curve generation circuit 142-1 through the switch SW(B) of the RGB switching switch 142-5.

According to the above constitution, the maximum luminance reference voltages Vmax(R), Vmax(G), and Vmax(B) and the minimum luminance reference voltages Vs(R), Vs(G), and Vs(B) applied to the γ curve generation circuit 142-1, which is the digital-analog conversion circuit, are switched and set in accordance with the timing at which the display data is sequentially captured in the gradation voltage generator 142 (γ curve generation circuit 142-1) and the color, and the relevant characteristics (correction characteristics) are normalized so that the single gamma characteristics (γ curve) previously set in the γ curve generation circuit 142-1 correspond to the electro-optic characteristics of the organic EL element OLED of each color of R, G, and B. The display data (luminance gradation value) of each color is digital-analog converted in a time sharing mariner with the use of the gamma correction curve, and the gamma-corrected analog signal voltages as the gradation voltages Vpix of R, G, and B colors (Vpix(r), Vpix(g), and Vpix(b)) are sequentially output to the demultiplexer 143 (gradation voltage generating operation).

Subsequently, the gradation voltages Vpix of R, G, and B colors (Vpix(r), Vpix(g), and Vpix(b)) sequentially generated in and output from the gradation voltage generator 142 are distributed in a time sharing manner for each color component of R, G, and B by the demultiplexer 143, based on the RGB switching control signals S1 and S2. Specifically, when the signal levels of the RGB switching control signals S1 and S2 are respectively high (H, H), the demultiplexer 143 captures the gradation voltage Vpix(r) corresponding to red (R) color to supply the gradation voltage Vpix(r) to the latch circuit 144 through a first signal line. When the signal levels of the RGB switching control signals S1 and S2 are respectively high (H) and low (L), the demultiplexer 143 captures the gradation voltage Vpix(g) corresponding to green (G) color to supply the gradation voltage Vpix(g) to the latch circuit 144 through a second signal line. When the signal levels of the RGB switching control signals S1 and S2 are respectively low (L, L), the demultiplexer 143 captures the gradation voltage Vpix(b) corresponding to blue (B) color to supply the gradation voltage Vpix(b) to the latch circuit 144 through a third signal line.

Namely, the gradation voltages Vpix of R, G, and B colors (Vpix(r), Vpix(g), and Vpix(b)) supplied as the serial signals from the gradation voltage generator 142 are distributed to the individual gradation voltages of R, G, and B (Vpix(r), Vpix(g), and Vpix(b)) by the demultiplexer 143 to be sequentially supplied as parallel signals to the latch circuit 144 through the individual signal lines (the first to third signal lines).

Then, the gradation voltages Vpix(r), Vpix(g), and Vpix(b) supplied to the latch circuit 144 are individually latched (temporarily held) in the latch circuit 144. In the gradation voltage setting operation period Tsig in which the display data generating operation and the gradation voltage generating operation are executed, the gradation voltages Vpix(r), Vpix(g), and Vpix(b) are not output from the data driver 140 (latch circuit 144), and the data lines Ldr, Ldg, and Ldb in each column are held in a high impedance state. In the write operation to be described later, the gradation voltages Vpix(r), Vpix(g), and Vpix(b) are simultaneously and in parallel output to the data lines Ldr, Ldg, and Ldb in each column, to which the sub pixels of three colors R, G, and B (PXr, PXg, and PXb) provided adjacent to one another are respectively connected, at the timing at which the output control signal OEN supplied to the latch circuit 144 becomes a high level (H).

Thus, in the gradation voltage setting operation period Tsig, the gradation voltages Vpix are not applied to the source terminal of the transistor Tr13 (contact point N12) of the display pixel PIX (pixel driving circuit DC in the sub pixels PXr, PXg, and PXb), and a voltage is not written in between the gate and the source of the transistor Tr13 (both ends of the capacitor Cs). Therefore, the transistor Tr13 is not turned on, and the potential of the contact point N12 on the anode terminal side in the organic EL element OLED is lower than the reference voltage Vss applied to the cathode terminal TMc (namely, the organic EL element OLED is set in a reverse bias state), whereby the current is not applied to the organic EL element OLED, and thus the organic EL element does not emit light.

### (Write Operation)

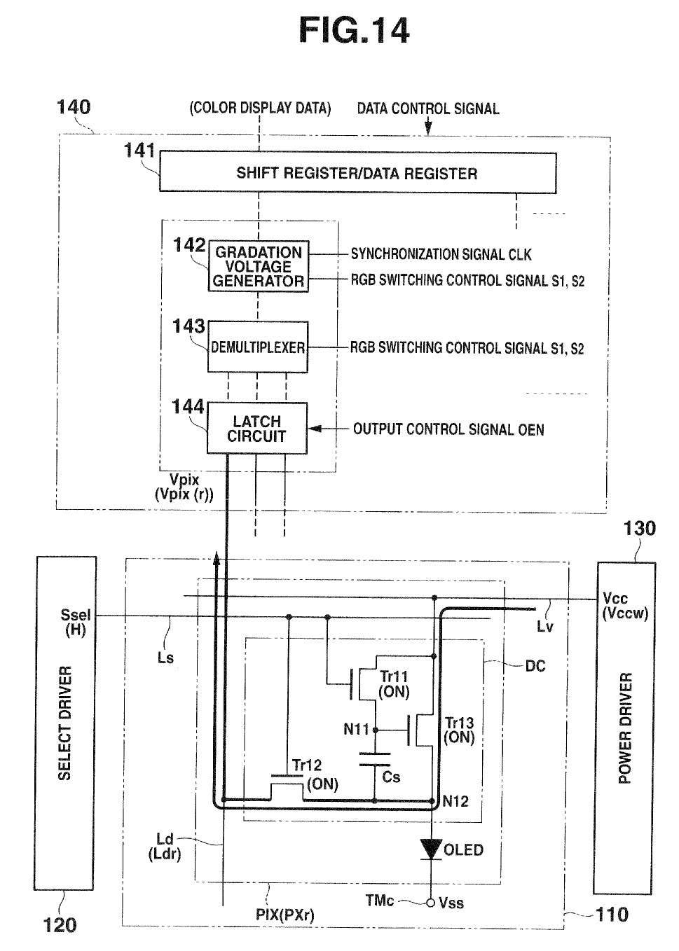

FIG. 14 is a conceptual diagram showing a write operation in the display apparatus according to the present embodiment.

As described above, with regard to each of the display pixels PIX (sub pixels PXr, PXg, and PXb) in the row set in the selected state, in the selection period Tsel(i), the display data is sequentially captured, and the gradation voltages Vpix(r), Vpix(g), and Vpix(h) are generated for each color component of R, G, and B. Thereafter, the write operation for simultaneously writing the gradation voltages Vpix(r), Vpix(g), and Vpix(b) in each of the display pixels PIX (sub pixels PXr, PXg, and PXb) in the relevant row is executed continuously.

In the write operation (write operation period Twrt), as shown in FIGS. 12 and 14, based on the output control signal OEN supplied as the data control signal from the system controller 150, at the timing at which the output control signal OEN reaches a high level, for example, the gradation voltages of R, G, and B colors Vpix(r), Vpix(g), and Vpix(b) generated in the gradation voltage setting operation period Tsig are simultaneously and in parallel applied from the latch circuit 144 to the data lines Ldr, Ldg, and Ldb in each column to which the sub pixels of three colors R, G, and B (PXr, PXg, and PXb) are respectively connected. In the write operation period Twrt, as with the gradation voltage setting operation period Tsig, the low potential power voltage Vcc (=Vccw≦reference voltage Vss) for writing is applied from the power driver 130 to the power voltage line Lv.

The gradation voltages of R, G, and B colors Vpix(r), Vpix(g), and Vpix(b) generated in the data driver 140 (γ curve generation circuit 142-1) in the gradation voltage setting operation period Tsig are set so as to have a voltage amplitude of a negative potential relatively on the basis of the low potential power voltage Vcc (=Vccw) of the write operation level applied from the power driver 130 to the power voltage line Lv. Namely, as the gradation becomes higher, the gradation voltage Vpix is lower on the negative potential side (the absolute value of the voltage amplitude is larger).

According to the above constitution, as shown in FIG. 14, the gradation voltages Vpix (Vpix(r), Vpix(g), and Vpix(b)) are applied to the source terminal (contact point N12) of the transistor Tr13 in the display pixel PIX (display driving circuit DC) set in the selected state, and therefore, the voltage Vgs corresponding to the gradation voltage Vpix is written and set in between the gate and the source of the transistor Tr13 (both ends of the capacitor Cs). In this write operation, the voltage component is not set by applying a current corresponding to the display data to the gate terminal and the source terminal of the transistor Tr13, but since the desired voltage (gradation voltage Vpix) is directly applied the potential of each terminal and each contact point can be immediately set in the desired state.

Also in the write operation period Twrt, the voltage value of the gradation voltage Vpix, applied to the contact point N12 on the anode terminal side of the organic EL element OLED is set so as to be lower than the reference voltage Vss applied to the cathode terminal TMc (namely, the organic EL element OLED is set in a reverse bias state), whereby the current is not applied to the organic EL element OLED, and thus the organic EL element OLED does not emit light.

### (Holding Operation)

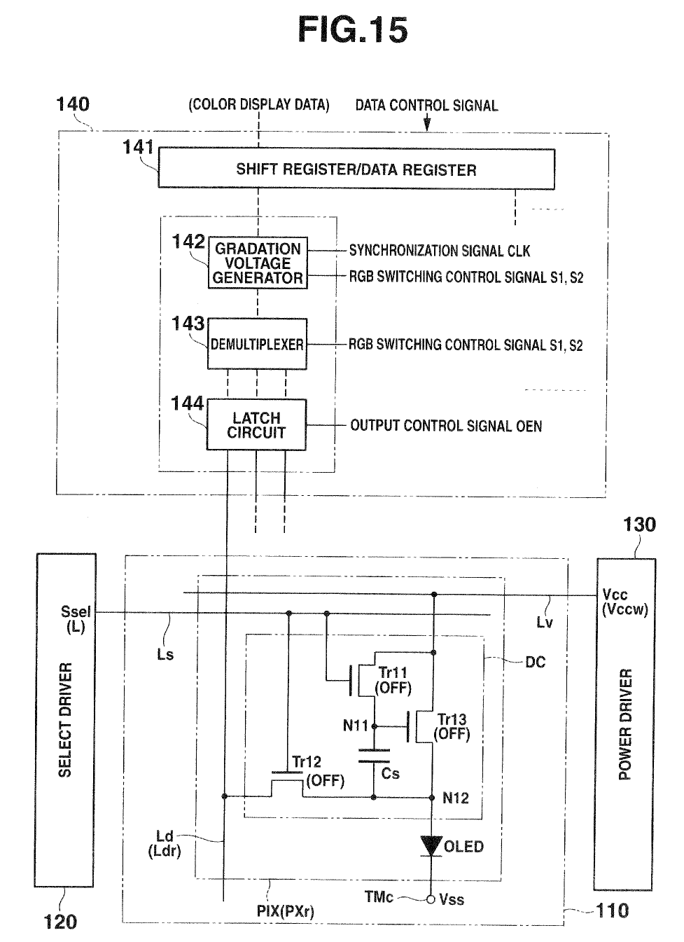

FIG. 15 is a conceptual diagram of the holding operation in the display apparatus according to the present embodiment.

In the holding operation (holding operation period Thld) after the gradation voltage setting operation (the display data capture operation and the gradation voltage generating operation) and the write operation, as shown in FIG. 11, the selection signal Ssel of the non-selection level (low level) is applied to the select line Ls in the i-th row, whereby, as shown in FIG. 15, the transistors Tr11 and Tr12 are turned off, and the diode-connection state in the transistor Tr13 is released. At the same time, the electrical connection between the source terminal (contact point N12) of the transistor Tr13 and the data line Ld is interrupted, and the voltage component corresponding to the gradation voltages Vpix (Vpix(r), Vpix(g), and Vpix(b)) is charged (held) in between the gate and the source of the transistor Tr13 (both ends of the capacitor Cs).

In the method of driving the display apparatus according to the present embodiment, as shown in FIGS. 11 and 12, in the holding operation period Thld after the gradation voltage setting operation and the write operation applied to the display pixels PIX in the i-th row, the selection signal Ssel of the selection level (high level) is applied from the select driver 120 to the select line Ls in the (i+1)-th row, whereby the display pixels PIX (sub pixels PXr, PXg, and PXb) in the (i+1)-th row is set in the selected state, and a series of processing operations including the gradation voltage setting operation and the write operation similar to the above, is executed for each row until the termination of the selection period Tsel in the last row (n/2-th row or n-th row) of the same group.

Namely, the selection signals Ssel of the selection level are sequentially applied at different timings from the select driver 120 to the select line Ls in each row, whereby in the display pixel PIX after the (i+1)-th row, the gradation voltage setting operation and the writing operation are sequentially executed in each row. Thus, in the holding operation period Thld of the display pixels PIX in the i-th row, the holding operation is continued until the voltage component (gradation voltage Vpix) corresponding to the display data is sequentially written in the display pixels PIX in all of the other rows in the same group.

### (Light Emitting Operation)

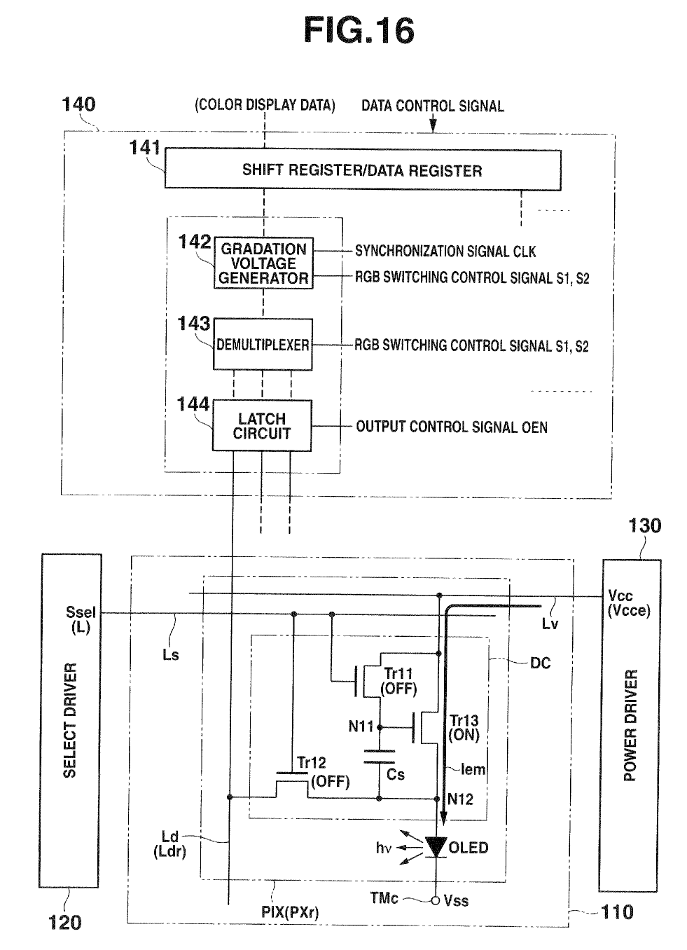

FIG. 16 is a conceptual diagram showing the light emitting operation in the display apparatus according to the present embodiment.

In the light emitting operation (light emitting operation period Tem) after the termination of the gradation voltage setting operation, the write operation, and the holding operation in an arbitrary group, as shown in FIG. 11, the high potential power voltage Vcc (=Vcc>Vss) of the light emitting operation level is applied from the power driver 130 to the power voltage line Lv connected to the display pixels PIX (sub pixels PXr, PXg, and PXb) in each row in such a state that the selection signal Ssel of the non-selection level (low level) is applied to the select line Ls in each row in the relevant group.

According to the above constitution, the transistor Tr13 is operated in a saturation region. In addition, the voltage corresponding to the voltage component (Vccw−Vpix), written and set in between the gate and the source of the transistor Tr13 by the write operation, is applied to the anode side (contact point N12) of the organic EL element OLED, and the reference voltage Vss (for example, a ground potential) is applied to the cathode terminal TMc, whereby the organic EL element OLED is set in a forward bias state. Thus, as shown in FIG. 16, the light emission driving current Tem (the drain-source current Ids in the transistor Tr13) having a current value corresponding to the display data (namely, the gradation voltages of R, G, and B colors (Vpix(r), Vpix(g), and Vpix(b))) passes from the power voltage line Lv to the organic EL element OLED through the transistor Tr13, whereby the organic EL element OLED emits light at a desired luminance gradation. For the next one processing cycle period Tcyc, the light emitting operation is continuously executed until the timing at which the power voltage Vcc (=Vccw) of the write operation level is applied from the power driver 130.

In a series of processes in the method of driving the display apparatus, when drive control for making all the display pixels PIX in the relevant group simultaneously emit light is performed after the termination of the write operation to the display pixels PIX in all rows in each group, the holding operation is provided, for example, between the write operation and the light emitting operation, as described later. In this case, the length of the holding operation period Thld is different for each row. Meanwhile, when such drive control is not performed, the holding operation may not be performed.

As described above, according to the display apparatus according to the present embodiment and the method of driving the display apparatus, the display apparatus has the data driver (display driving device) which is provided with the digital-analog conversion circuit having the single (common) gamma characteristics, sequentially switches and sets the gradation reference voltage, applied to the digital-analog conversion circuit, in response to, for example, the timing of supplying the display data of three colors of R, G, and B, and generates the gradation voltage corresponding to the display data (luminance gradation value) of each color of R, G, and B by performing the digital-analog conversion processing in a time sharing manner with the use of the gamma correction curve having characteristics corresponding to the electro-optic characteristics of the organic EL element OLED of each color of R, G, and B. Therefore, the display data of each color supplied as the serial data can be gamma-corrected in the single circuit configuration, and while the circuit size of the display apparatus can be substantially reduced, the display pixel (organic EL element) of each color can emit light at an appropriate luminance gradation level in response to the display data.

Further, since the gradation signal (gradation voltage) generated in and output from the data driver (display driving device) according to the present embodiment is a voltage signal, the data driver is different from a current driver which directly sets the current value of the drain-source current Ids applied to the transistor Tr13 in the write operation period, for example. Therefore, even if the current value of the drain-source current Ids applied to the transistor Tr13 in the write operation period is very small, it is possible to immediately set the gate-source voltage Vgs corresponding to the drain-source current Ids applied to the transistor Tr13. Thus, it is possible to favorably realize the write operation in which, within the selection period set to be relatively short, the gradation voltage Vpix is written in between the gate and the source of the transistor Tr13 and in the capacitor Cx, in addition to the capture of the display data and the generation and holding of the gradation voltage Vpix.

### <Specific Example of Driving Method>

Next, in the present embodiment, the driving method specific to the display apparatus 100 having the display area 110 as shown in FIG. 1 will be specifically described.

In the display apparatus (FIG. 1) according to the present embodiment, the display pixels PIX arrayed in the display area 110 are divided into a group in the upper area of the display area 110 and a group in the lower area, and the independent power voltage Vcc is applied for each group through the individual power voltage lines Lv branched from the first power voltage line Lv1 or the second power voltage line Lv2, whereby a plurality of rows of display pixels PIX (sub pixels PXr, PXg, and PXb) included in each group can simultaneously emit light.

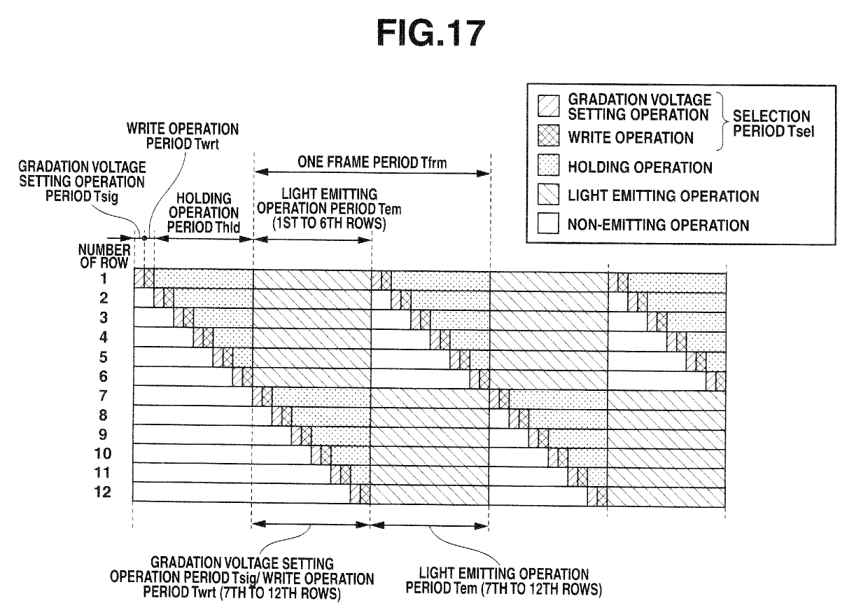

FIG. 17 is an operation timing diagram schematically showing a specific example of the method of driving the display apparatus having such display area, according to the present embodiment.

In the operation timing diagram of FIG. 17, for convenience of explanation, 12 rows of display pixels (n=12: 1st to 12th rows) are arrayed in the display area, and divided into a group including the display pixels in 1st to 6th rows (corresponding to the upper area) and a group including the display pixels in 7th to 12th rows (corresponding to the lower area).

In the drive control method in the display apparatus 100 according to the present embodiment, as shown in, for example, FIG. 17, while with respect to the display pixels PIX (sub pixels PXr, PXg, and PXb) in each row of the display area 110, a processing for continuously executing the gradation voltage setting operation (display data capture operation and the gradation voltage generating operation) and the write operation is sequentially repeated in each row, at the timing at which the write operation is terminated with respect to the pixel driving circuit DC in the display pixels PIX in the 1st to 6th rows or the 7th to 12th rows, which have been previously divided into groups, a processing for making all the display pixels PIX, included in the relevant group, simultaneously emit light at the luminance gradation corresponding to the display data is sequentially repeated in each group, whereby the image information corresponding to one screen of the display area 110 is displayed.

Specifically, with respect to the display pixels PIX arrayed in the display area 110, a series of processing operations, including the gradation voltage setting operation, the write operation, and the holding operation is repeatedly executed in each row in sequence from the display pixels PIX in the 1st row in such a state that the low potential power voltage Vcc (=Vccw) is applied through the first power voltage line Lv1 commonly connected to the display pixels PIX in the group of the display pixels PIX in the 1st to 6th rows. According to this constitution, the gradation voltages Vpix (Vpix(r), Vpix(g), and Vpix(b)) generated in accordance with the luminance gradation value included in the display data are written in the pixel driving circuit CD of the display pixel PIX in each row. The display pixel PIX in the row with which the write operation is terminated shifts to the holding operation.

Then, the high potential power voltage Vcc (=Vcce) is applied through the first power voltage line Lv in the group at the timing at which the writing operation is terminated with respect to the display pixels PIX in the 6th row, whereby 6 rows of the display pixels PIX in the relevant group are made to simultaneously emit light at the luminance gradation based on the gradation voltage Vpix written in each display pixel PIX. The light emitting operation is continued until the Liming at which the next gradation voltage setting operation is started with respect to the display pixels PIX in the first row (the light emitting operation period Tem in 1st to 6th rows). In this driving method, after the write operation for the display pixels PIX in 6th row, which is the last row in the relevant group, the display pixel PIX emits light without shifting to the holding operation (the display pixel PIX does not have the holding operation period Thld).

Further, in the group of the display pixels PIX in the 7th to 12th rows, the low potential power voltage Vcc (=Vccw) is applied through the second power voltage line Lv2 commonly connected to the display pixels PIX in the relevant group at the timing at which the write operation for the display pixels PIX in the 1st to 6th rows is terminated (or the timing at which the light emitting operation of the display pixels PIX in the 1st to 6th rows is started), and a series of processing operations, including the gradation voltage setting operation, the write operation, and the holding operation is repeatedly executed in each row in sequence from the display pixels PIX in the 7th row. Further, the high potential power voltage Vcc (=Vccw) is applied through the second power voltage line Lv2 in the relevant group at the timing at which the write operation for the display pixels PIX in 12th row is terminated. According to this constitution, 6 rows of the display pixels PIX in the relevant group are made to simultaneously emit light at the luminance gradation based on the gradation voltage Vpix written in each display pixel PIX (the light emitting operation period Tem in 7th to 12th rows). In the period in which the gradation voltage setting operation, the write operation, and the holding operation are executed with respect to the display pixels PIX in 7th to 12th rows, the operation in which the display pixels PIX in 1st to 6th rows simultaneously emit light is continued as described above.

As described above, when with respect to all the display pixels PIX arrayed in the display area 110, a series of processing operations, including the gradation voltage setting operation, the write operation, and the holding operation is sequentially executed at a predetermined timing for each of the display pixels PIX in each row, and the drive control is performed so that all the pixels PIX in each previously set group are made to simultaneously emit light at the time when the write operation for the display pixels PIX in all rows included in the relevant group is terminated.

Thus, according to the above method of driving the display apparatus, not all display pixels in the same group emit light in the period in which the gradation voltage setting operation and the write operation are executed with respect to the display pixels in each row in the relevant group before the light emitting operation period Tem, and therefore, the display pixels can be set in a non-emitting state (black display state).

In the operation timing diagram of FIG. 17, the display pixels PIX in 12th row constituting the display area 110 are divided into two groups and controlled so that the light emitting operation is simultaneously executed at different timings for each group, whereby a ratio (black insertion ratio) of the black display period performed by the non-emitting operation in 1 frame period Tfrm can be set to 50%. In order to clearly visually recognize a video image free from blurs by human vision, in general, a black insertion ratio of not less than 30% is needed, and therefore, according to the present driving method, it is possible to realize a display apparatus having a relatively favorable display image quality.

In the display area 110 shown in FIG. 1, the plurality of display pixels PIX are divided into two groups for each continuous row; however, the invention is not limited thereto. The display pixels PIX may be divided into an arbitrary number of groups, such as three or four groups, or may be divided into groups for each discontinuous row, such as even number rows and odd number rows. According to such a constitution, a light emission time and a black display time (black display state) can be arbitrarily set in accordance with the number of groups, whereby the display image quality can be improved.

Further, the plurality of display pixels PIX arrayed in the display area 110 need not be divided into groups as above, and the power voltage Vss may be independently applied at different timings to the power voltage lines individually arranged (connected) for each row, whereby the display pixels PIX may be made to emit light for each row. Alternatively, the common power voltage Vcc may be applied simultaneously to one screen of all the display pixels PIX arrayed in the display area 110, whereby one screen of all the display pixels in the display area 110 may be made to simultaneously emit light.

### Second Embodiment

Next, a second embodiment according to the invention will be described. The entire constitution of the display apparatus in the second embodiment is equivalent to that in the first embodiment, and therefore, in the following description, there will be described in detail the constitution of the data driver and the driving method specific to the second embodiment.

In the first embodiment, in accordance with the timing at which the display data of each color of R, G, and B (luminance gradation value) is sequentially supplied to the data driver 140 (gradation voltage generator 142), the maximum luminance reference voltages Vmax(R), Vmax(G), and Vmax(B) and the minimum luminance reference voltages Vs(R), Vc(G), and Vs(B) are switched and set so that the characteristics of the gamma correction curve in the γ curve generation circuit (gamma correction circuit) 142-1 are corresponded to the electro-optic characteristics of the organic EL element OLED of each color of R, G, and B.

On the other hand, in the second embodiment, any one of the maximum luminance reference voltages Vmax(R), Vmax(G), and Vmax(B) and the minimum luminance reference voltages Vs(R), Vc(G), and Vs(B) is switched and set.

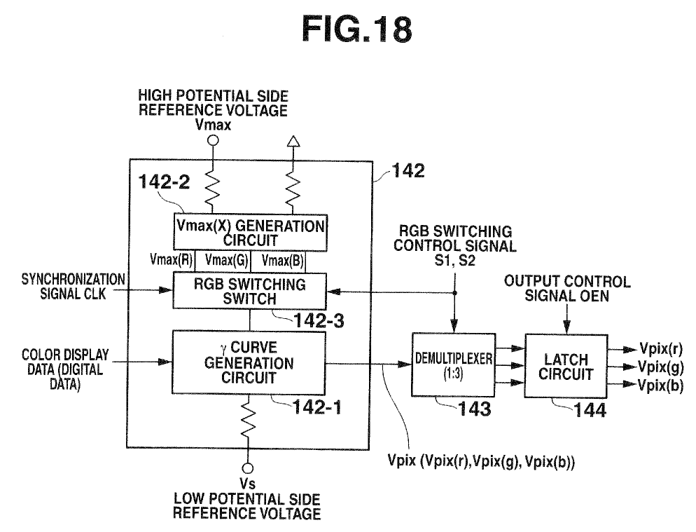

FIG. 18 is a configuration diagram of an essential part of the data driver in the second embodiment applied to the display apparatus according to the invention.

Any description of the constitution similar to the first embodiment is simplified or omitted. Since the method of driving the display apparatus in the second embodiment is the same as the first embodiment, the description thereof is omitted.

The data driver 140 applied to the display apparatus according to the second embodiment, as shown in FIG. 18, has a configuration in which the minimum reference voltage generation circuit 142-4 and the RGB switching switch 142-5 in the first embodiment for switching and setting for each color the minimum luminance reference voltages Vs(R), Vs(G), and Vs(B) in the γ curve generation circuit 142-1 (see, FIG. 4) are omitted.

Namely, in the present embodiment, the single gamma characteristics previously set in the γ curve generation circuit 142-1 are specified so as to correspond to the electro-optic characteristics of the organic EL element OLED of each color, based only on the maximum luminance reference voltages Vmax(R), Vmax(G), and Vmax(B) switched and set corresponding to each color of R, G, and B.

Thus, according to the display apparatus using the data driver (display driving device) 140 having the above circuit configuration, compared with the case where both the maximum luminance reference voltages Vmax(R), Vmax(G), and Vmax(B) and the minimum luminance reference voltages Vs(R), Vs(G), and Vs(B) are switched and set as shown in the first embodiment, the gamma correction curve used in the digital-analog conversion processing for the display data (luminance gradation value) of each color of R, G, and B is somewhat inferior in the performance following the electro-optic characteristics of the organic EL element OLED of each color of R, G, and B (namely, this gamma correction curve does not closely correspond to the original gamma correction curve for each color of R, G, and B); however, the minimum reference voltage generation circuit 142-4 and the RGB switching switch 142-5 can be omitted in the gradation voltage generator 142, thereby contributing to the size reduction of the circuit configuration in the display apparatus.

### Third Embodiment

In the first embodiment, the characteristics of the gamma correction curve in the γ curve generation circuit (gamma correction circuit) 142-1 are switched corresponding to the display data (luminance gradation value) of each color or R, G, and B sequentially supplied to the data driver 140 (gradation voltage generator 142), and the gradation voltages Vpix (Vpix(r), Vpix(g), and Vpix(b)) corresponding to the electro-optic characteristics of the organic EL element OLED of each color of R, G, and B are generated. Thereafter, the gradation voltages Vpix are distributed in a time sharing manner by the demultiplexer 143 so as to correspond to each color of R, G, and B, and further temporarily held in the latch circuit 144 to be simultaneously applied to the display pixels PIX (sub pixels PXr, PXg, and PXb) of each color of R, G, and B at a predetermined timing, and thus, to be written in the display pixels PIX.

In contrast, in the third embodiment, the gradation voltages Vpix (Vpix(r), Vpix(g), and Vpix(b)), divided in a time sharing matter by the demultiplexer 143 so as to correspond to each color of R, G, and B, are not latched, but sequentially applied to the display pixels PIX (sub pixels PXr, PXg, and PXb) of each color of P, G, and B to be written in the display pixels PIX.

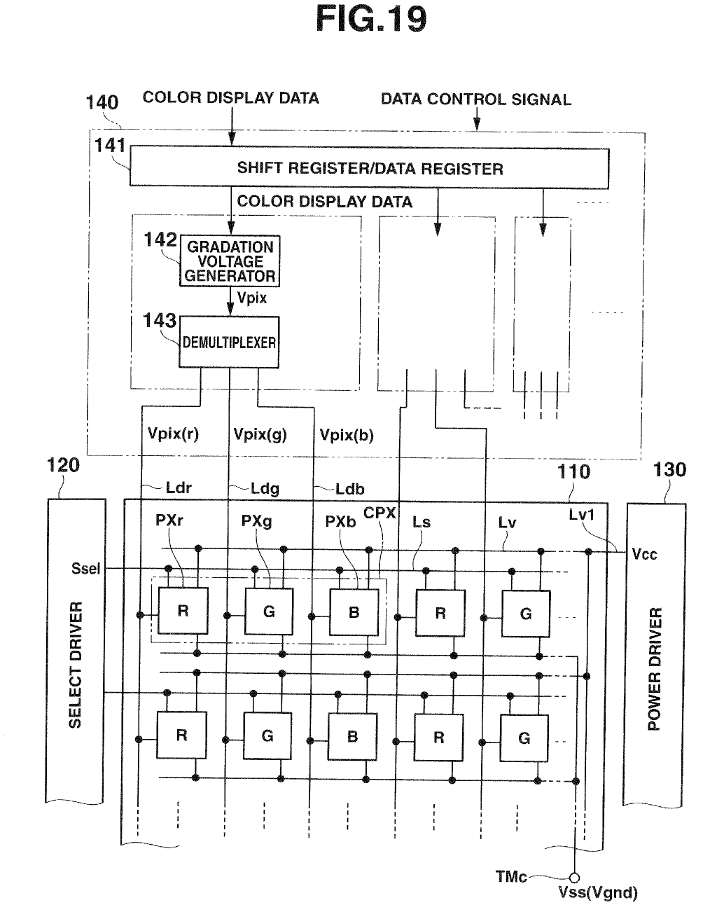

FIG. 19 is a schematic configuration diagram showing an example of a display panel and the data driver applicable to a display apparatus according to the third embodiment.

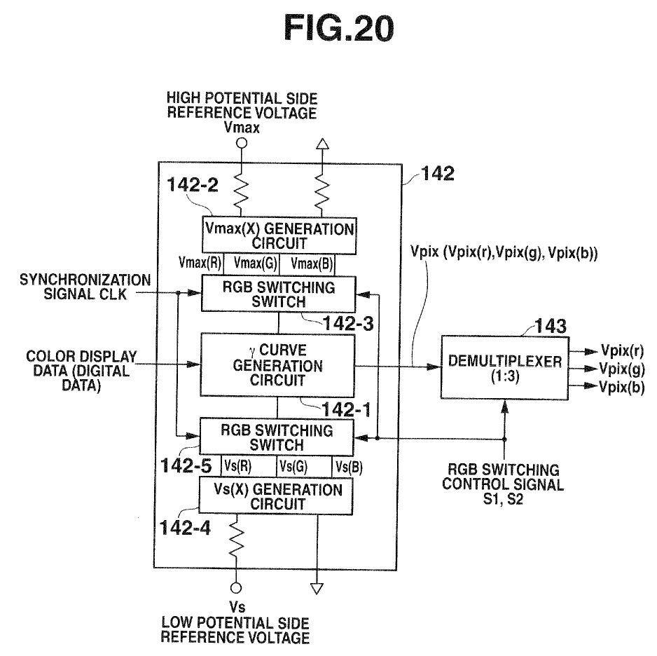

FIG. 20 is a configuration diagram of an essential part of the data driver according to the present embodiment.

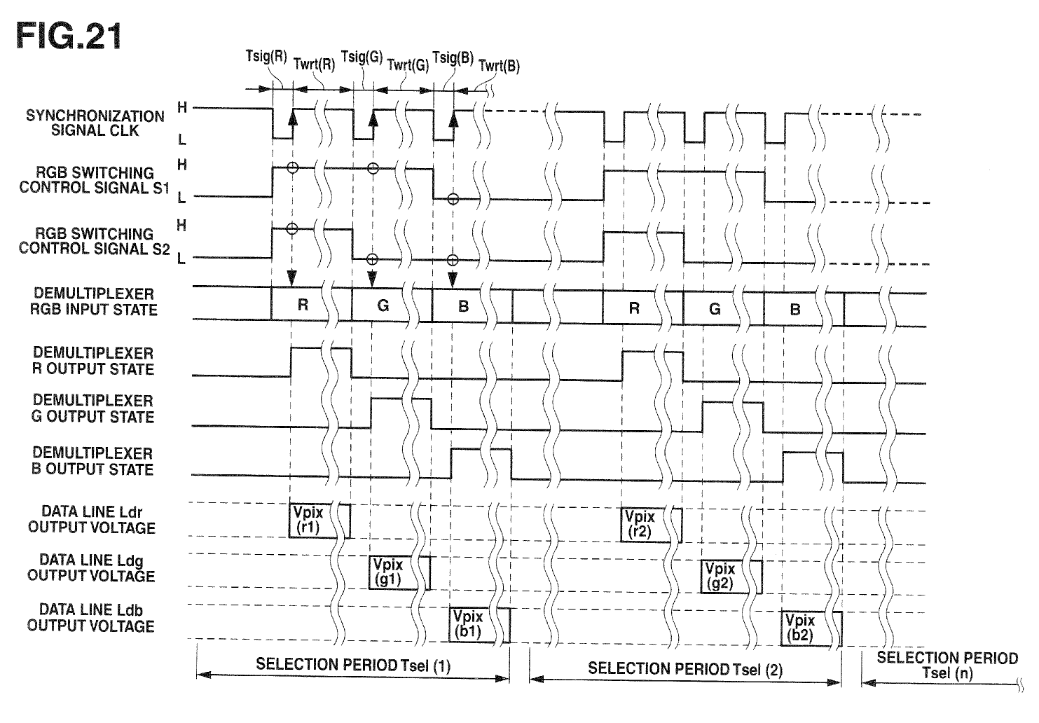

FIG. 21 is a timing chart showing an example of a method of driving the display apparatus according to the present embodiment.

Any description of the constitution (see, FIGS. 1 to 4) and the driving method (see, FIGS. 11 and 12) similar to the first embodiment is simplified or omitted.

The data driver 140 applied to the display apparatus according to the third embodiment, as shown in FIGS. 19 and 20, has a configuration in which the latch circuit 144 in the first embodiment (see, FIGS. 2 and 4A) for temporarily holding (latching) the gradation voltages Vpix, generated in the γ curve generation circuit 142-1 and time-divided by the demultiplexer 143, is omitted.

Namely, in the third embodiment, the gradation voltages Vpix (Vpix(r), Vpix(g), and Vpix(b)) including the serial data generated by the execution of the digital-analog conversion processing in order of R, G, and B by the γ curve generation circuit 142-1 are distributed for each color of R, G, and B by the demultiplexer 143 to be sequentially applied in order of R, G, and B to the data lines Ld (Ldr, Ldg, and Ldb) in each column connected with the display pixels PIX (sub pixels PXr, PXg, and PXb) of each color of R, G, and B. According to this constitution, the write operation is executed so that the gradation voltage Vpix corresponding to each color of R, G, and B (Vpix(r), Vpix(g), and Vpix(b)) is sequentially applied to the display pixels Vpix (Vpix(r), Vpix(g), and Vpix(b)) in a specific row set in the selected state to be held in the capacitor Cs of each pixel driving circuit DC.

In the drive control operation in the display apparatus in the third embodiment, the gradation voltage setting operation (gradation voltage setting operation period Tsig) and the write operation (write operation period Twrt) executed in the selection period Tsel in the driving method shown in the first embodiment (see, FIG. 11) are continuously executed as a series of operations for each display data of each color of R, G, and B, and, at the same time, sequentially executed at such a timing that these operations do not overlap with each other in each color of R, G, and B (at different timings), as shown in FIG. 21, for example.

Specifically, as shown, for example, in FIG. 11, the low potential power voltage Vcc (=Vccw) of the write operation level is applied from the power driver 130 to the power voltage line Lv connected to the display pixels PIX (sub pixels PXr, PXg, and PXb) in the i-th row, and, at the same time, the selection signal Ssel of the selection level (high level) is applied from the select driver 120 to the select line Ls in the i-th row, whereby the display pixel PIX in the i-th row is set in the selected state (selection period Tsel(i)).

In the selection period Tsel(i), as shown in, for example, FIG. 21, the display data as the serial data supplied to the data driver 140 in order of R, G, B, R, G, B, . . . is sequentially captured through the shift register/data register 141. In the gradation voltage setting operation period Tsig(R) in the selection period Tsel(i), the display data of red (R) color is transferred to the gradation voltage generator 142 (R display data capture operation), and, based on the maximum luminance reference voltage Vmax(R) and the minimum luminance reference voltage Vs(R) applied to the γ curve generation circuit 142-1 at the rising timing of the synchronization signal CLK, the characteristics of the gamma correction curve are specified so as to correspond to the electro-optic characteristics of the organic EL element OLED of the red color. The display data is digital-analog converted with the use of the specified gamma correction curve, and the gamma-corrected gradation voltage Vpix(r) including the analog signal voltage is output to the demultiplexer 143 (R gradation voltage generating operation).

In the write operation period Twrt(R) after the termination of the gradation voltage setting operation period Tsig(R), the gradation voltage Vpix(r) of red (R) color input to the demultiplexer 143 is output to the data line Ldr connected with the sub pixel PXr of red (R) color, based on the RGB switching control signals S1 and S2. In the operation where the gradation voltage Vpix(r) corresponding to the display data of red (R) color is generated to be output to the data line Ldr, the signal levels of the RGB switch control signals S1 and S2 are respectively set to be high (H, H).

According to the above constitution, as with the first embodiment (see FIG. 14), among the display pixels PIX set in the selected state, the gradation voltage Vpix(r) is applied to the source terminal of the transistor Tr13 (contact point N12) of the sub pixel PXr of red (R) color (image driving circuit DC), and the voltage Vgs corresponding to the gradation voltage Vpix(r) is written and set in between the gate and the source of the transistor Tr13 (both ends of the capacitor Cs) (R write operation).

After the termination of a series of operations where the gradation voltage Vpix(r) corresponding to the display data of red (R) color is generated to be written in the display pixel PIX (sub pixel PXr) (gradation voltage setting operation period Tsig(R) and write operation period Twrt(R)), in the gradation voltage setting operation period Tsig(G), the display data of green (G) color is captured, and the gradation voltage Vpix(g) is generated in a similar manner to the above (G display data capture operation and G gradation voltage generating operation).

At this time, the maximum luminance reference voltage Vmax(G) and the minimum luminance reference voltage Vs(G) are applied to the γ curve generation circuit 142-1 synchronously with the timing at which the display data of green (G) color is transferred through the shift register/data register 141, whereby the characteristic of the gamma correction curve is specified so as to correspond to the electro-optic characteristics of the organic EL element OLED of the green color. The display data is digital-analog converted with the use of the specified gamma correction curve, and the gamma-corrected gradation voltage Vpix(g) is generated.

In the write operation period Twrt(G) after the termination of the gradation voltage setting operation period Tsig(G), the gradation voltage Vpix(g) generated by the γ curve generation circuit 142-1 is output to the data line Ldg connected with the sub pixel PXg of green (G) color, based on the RGB switching control signals S1 and S2 input to the demultiplexer 143. In the operation where the gradation voltage Vpix(g) corresponding to the display data of green (G) color is generated to be output to the data line Ldg, the signal levels of the RGB switch control signals S1 and S2 are respectively set to be high (H) and low (L), whereby the voltage Vgs corresponding to the gradation voltage Vpix(g) is written and set in the sub pixel PXg of green (G) color (G write operation).

Subsequently, in a similar manner, the display data of blue (B) color is captured to generate the gradation voltage Vpix(b) in a gradation voltage setting operation period Tsig(B) (B display data capture operation and B gradation voltage generating operation), and the voltage Vgs corresponding to the gradation voltage Vpix(b) is written in the sub pixel PXb of blue (B) color through the data line Ldb in the write operation period Twrt(B) (B write operation).

At this time, the maximum luminance reference voltage Vmax(B) and the minimum luminance reference voltage Vs(B) are applied to the γ curve generation circuit 142-1 synchronously with the timing at which the display data of blue (B) color is transferred through the shift register/data register 141, whereby the characteristic of the gamma correction curve is specified so as to correspond to the electro-optic characteristic” of the organic EL element OLED of the blue color, and the display data is digital-analog converted with the use of the specified gamma correction curve to generate the gamma-corrected gradation voltage Vpix(b). In the operation where the gradation voltage Vpix(b) corresponding to the display data of blue (B) color is generated to be output to the data line Ldb, the signal levels of the RGB switch control signals S1 and S2 are respectively set to be low (L, L).

As described above, in the third embodiment, with respect to the display data of each color of R, G, and B supplied as the serial data, a series of operations, including the gradation voltage setting operation and the write operation is sequentially executed in order of R, G, and B at timings different from each other (so as not to temporally overlap with each other) during the selection period Tsel(i) in each row (i). Namely, the gradation voltage Vpix gamma-corrected corresponding to the display data is generated substantially at the same time as the capture operation for the relevant display data, and the operation where the gradation voltage Vpix is written in order of R, G, B, R, G, B, R, . . . in the display pixels PIX (sub pixels PXr, Pxg, and Pxb) in the row set in the selected state is repeatedly executed.

The gradation voltage setting operation and the write operation based on the display data are executed with respect to the display pixels PIX in the last row (n/2-th row or n-th row) in an arbitrary group set in the display area 110, and thereafter, as shown in FIG. 11, the high potential power voltage Vcc (=Vcce) of the light emitting operation level is applied from the power driver 130 to the power voltage line Lv connected to the display pixels PIX (sub pixels PXr, PXg, and PXb) in each row in such a state that the selection signal Ssel of a non-selection level (low level) is applied to the select line Ls in each row included in the relevant group.

According to the above constitution, the light emission driving current Iem (the drain-source current Ids in the transistor Tr13) having the current value based on the display data (the gradation voltages of R, G, and B colors (Vpix(r), Vpix(g), and Vpix(b))) is applied from the power voltage line Lv to the organic EL element OLED through the transistor Tr13 of each display pixel PIX (pixel driving circuit DC), whereby the organic EL element OLED emits light at a desired luminance gradation.

Thus, according to the display apparatus using the data driver (display driving device) 140 having the above circuit configuration, the gradation voltage Vpix (Vpix(r), Vpix(g), and Vpix(b)) corresponding to the display data of each color of R, G, and B (luminance gradation value) is sequentially generated to be sequentially applied to the data lines Ld (Ldr, Ldg, and Ldb) in each column connected with the display pixels PIX of each color of R, G, and B (sub pixels PXr, PXg, and PXb). Therefore, although the write operation period Twrt of each color set during the selection period Tsel may be relatively shortened, the latch circuit 144 can be omitted, thereby contributing to the size reduction of the circuit configuration of the display apparatus.

As described also in the first embodiment, the gradation signal (gradation voltage Vpix) generated in the data driver (display driving device) 140 is a voltage signal, and therefore, even if the current value of the drain-source current Ids passing through the transistor Tr13 in the write operation period is very small, the gate-source voltage Vgs corresponding to the current Ids can be immediately set, and the operation for capturing the display data of each color of R, G, and B and the operation for generating and writing the gradation voltage Vpix can be executed in a relatively short time within the selection period Tsel.

In the third embodiment, as with the first embodiment, the single gamma characteristics (correction characteristics) provided in the γ curve generation circuit 142-1 are specified so as to correspond to the electro-optic characteristics of the organic EL element OLED of each color, based on the maximum luminance reference voltages Vmax(R), Vmax(G), and Vmax(B) and the minimum luminance reference voltages Vs(R), Vs(G), and Vs(B) switched and set corresponding to each color of R, G, and B. However, the invention is not limited thereto. As shown in the second embodiment, the characteristics of the gamma correction curve may be specified based on any one of the maximum luminance reference voltages Vmax(R), Vmax(G), and Vmax(B) and the minimum luminance reference voltages Vs(R), Vs(g), and Vs(B).

### APPLICATION EXAMPLE OF THE INVENTION

Next, there will be described a case where the above display apparatus has a constitution in which the influence of the change in the characteristics of each of the display pixels PIX arrayed in the display area 110 (such as temporal changes of a threshold value voltage Vth of the transistor Tr13 forming the pixel driving circuit DC) is compensated to allow a favorable display image quality to be maintained.

The display pixels PIX shown in the above embodiments has a source-follower type circuit configuration in which the transistor Tr13, which is a drive transistor provided in the pixel driving circuit DC, and the organic EL element OLED, which is a light emitting element, are connected in series between a predetermined power voltage Vcc and a predetermined reference voltage Vss (=Vgnd) applied to the power voltage line Lv, and the current value of the light emission current Iem passing through the organic EL element OLED is specified based on the gate-source voltage Vgs of the transistor Tr13. It is known that, in a thin-film transistor used in the transistor Tr13, the threshold value voltage Vth increases in accordance with the driving history, and that in the organic EL element OLED, the conduction resistance increases in accordance with the driving history.

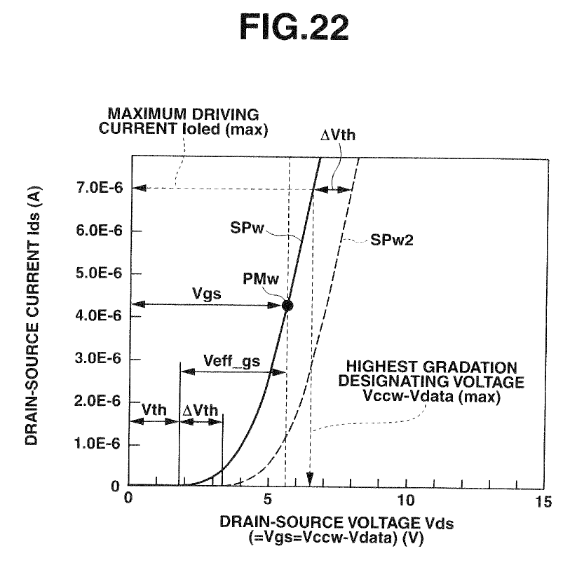

FIG. 22 is a characteristic diagram showing operation characteristics of a drive transistor in the write operation for the display pixel.

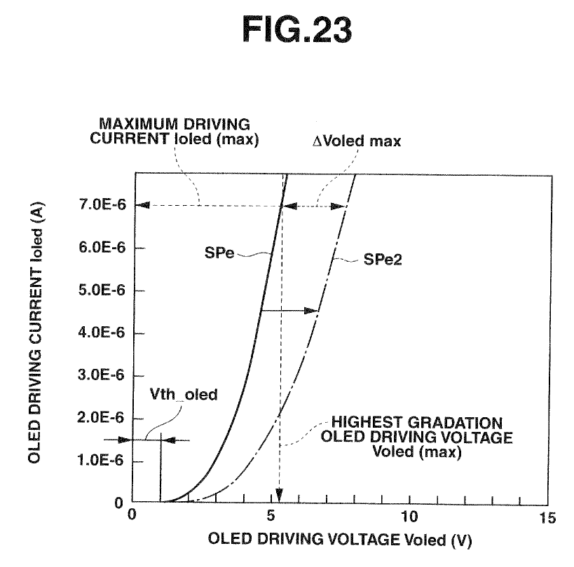

FIG. 23 is a characteristic diagram showing a relation between the driving current and the driving voltage of the organic EL element.

In FIG. 22, a solid line SPw is a characteristic line showing a relation between the drain-source voltage Vds and the drain-source current Ids in an initial state when an n-channel type thin-film transistor is used as a drive transistor (transistor Tr13) and when the display pixel PIX (pixel driving circuit DC) shown in FIG. 3 is set in the selected state, the transistor Tr11 is turned on, and the drive transistor (transistor Tr13) is diode-connected. A broken line SPw2 shows an example of the characteristic line upon the occurrence of the characteristic changes (the changes of the threshold value voltage Vth) with the driving history of the drive transistor. A point PMw on the characteristic line SPw shows an operating point of the drive transistor. In FIG. 23, a solid line SPe is a characteristic line showing a relation between a driving voltage Voled applied to between the anode and the cathode of the organic EL element OLED in the initial state and a driving current Ioled passing through between the anode and cathode. A dashed line SPe2 shows an example of the characteristic line upon the occurrence of the characteristic changes (the changes of the conduction resistance) with the driving history.

As shown in FIG. 22, the characteristic changes with the driving history of the drive transistor are changed into such a shape (broken line SPw2) that is substantially parallel to the initial characteristic line (solid line SPw). Therefore, a value of a writing voltage Vdata required for obtaining the driving current (drain-source current Ids) corresponding to the luminance gradation value of the display data should be set to a voltage value increased by a change amount ΔVth of the threshold value voltage Vth.

As shown in FIG. 23, the characteristic variation due to the increase of resistance of the organic EL element OLED with the driving history is basically changed to the initial characteristic line (solid line SPe) in such a direction that the rate of increase of the OLED driving current Ioled to the OLED driving voltage Voled is reduced. Namely, the OLED driving voltage Voled is increased by the characteristic line SPe2—the characteristic line SPe so as to apply the OLED driving current Ioled required for making the organic EL element OLED emit light at the luminance gradation based on the display data (luminance gradation value). This increase of the OLED driving voltage Voled is the largest at the maximum gradation at which the driving current Ioled is the maximum value (maximum driving current) Ioled(max), as shown by ΔVoled max in FIG. 23.

The relation between the device characteristics of the organic EL element and the voltage-current characteristics of the organic EL element will be verified in detail.

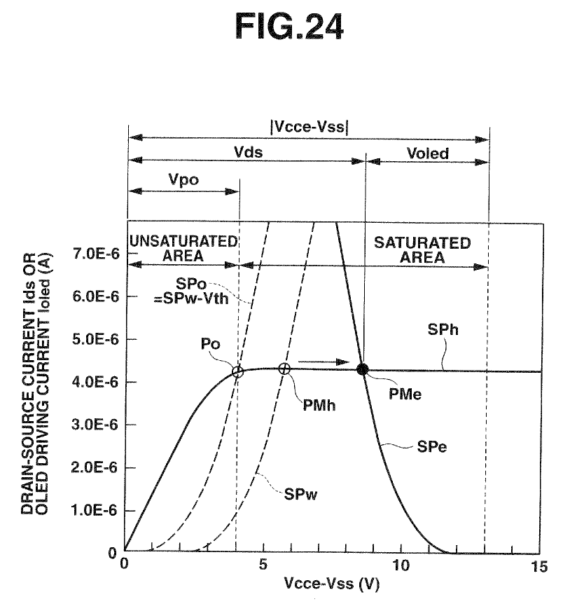

FIG. 24 is a characteristic diagram showing operation characteristics of the drive transistor in the light emitting operation of the display pixel.

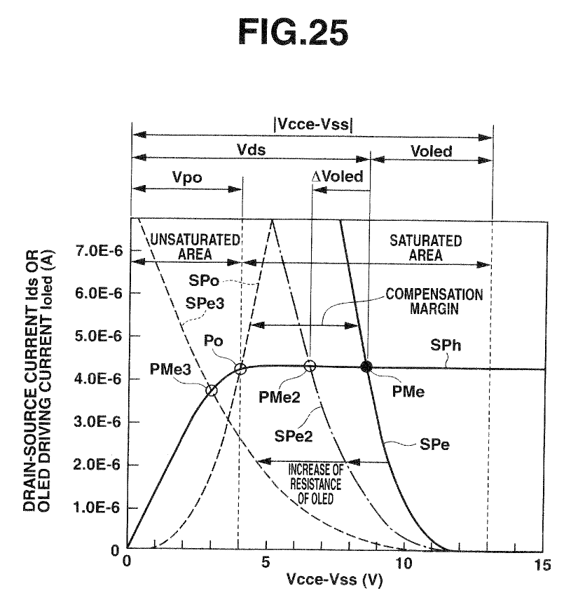

FIG. 25 is a characteristic diagram showing load characteristics of the organic EL element.

As described above, the organic EL element OLED increases its resistance with the driving history and changes in such a direction that the rate of increase of the OLED driving current Ioled to the OLED driving current Voled is reduced. Namely, the organic EL element OLED changes in such a direction that the inclination of the load line SPe of the organic EL element OLED shown in FIG. 24 is reduced. FIG. 25 shows changes of the load line SPe in the organic EL element OLED with the driving history, and the load line changes like SPe→SPe2→SPe3. Accordingly, the operating point of the drive transistor (transistor Tr13) is moved on a characteristic line SPh of the drive transistor like PMe→PMe2→PMe3, based on the driving history.

At this time, while the operating point of the drive transistor is within a saturated area on the characteristic line SPh (PMe→PMe2), the OLED driving current Ioled maintains a value of an expectation current in the write operation. However, when the operating point enters an unsaturated area (PMe3), the OLED driving current Ioled is smaller than the expectation current in the write operation. Namely, since the current value of the OLED driving current Ioled passing through the organic EL element OLED is distinctly different from the current value of the expectation current in the write operation, the display characteristics are changed. In FIG. 25, a pinch-off point Po is at the boundary between the unsaturated area and the saturated area. Namely, the potential difference between the operation point PMe and the pinch-off point Po in the light emission is a compensation margin for maintaining the OLED driving current Ioled in the light emission against an increase in resistance of the organic EL element. In other words, the potential difference above the characteristic line SPh of the drive transistor between a trajectory SPo of the pinch-off point and the load line Spe of the organic EL element OLED at each Ioled level corresponds to the compensation margin. As shown in FIG. 25, the compensation margin decreases as the value of the OLED driving current Ioled increases, whereas the compensation margin increases as the voltage Vcce−Vss applied to between the power voltage line Lv and the cathode terminal TMc of the organic EL element OLED increases.

Next, the relation between the device characteristics of the transistor and the voltage-current characteristics will be verified.

In the voltage gradation control using the transistor Tr13 used in the display pixel PIX (pixel driving circuit DC), it is assumed that the writing voltage Vdata is set based on the initial characteristics (characteristic line SPw) of the previously set drain-source voltage Vds and the previously set drain-source current Ids of the transistor. However, as shown in FIGS. 22 and 23, the threshold value voltage Vth increases in response to the driving history, whereby the current value of the light emitting driving current (OLED driving current Ioled) supplied to the organic EL element OLED does not corresponded to the display data (write voltage), and the organic EL element OLED cannot be made to emit light at an appropriate luminance gradation. Especially, it has been known that when an amorphous silicon transistor is used as a transistor used in the pixel driving circuit DC, the device characteristics are significantly varied.

Specifically, for example, in the voltage-current characteristics of an n-channel amorphous silicon transistor (corresponding to the relation between the drain-source voltage Vds and the drain-source current Ids shown in FIGS. 22 and 23), a gate electric field is offset by carrier trapping into a gate Insulation film due to the driving history or changes over time of the amorphous silicon transistor, resulting in an increase of the threshold value voltage Vth (initial state: shifting from the characteristic line SPw to the characteristic line SPw2 on a high voltage side). Due to this, when the drain-source voltage Vds applied to the amorphous silicon transistor is constant, the drain-source current Ids decreases, and the light emission luminance of the light emitting element (organic EL element OLED) also decreases.

In such a variation of the device characteristics of the transistor, the threshold value voltage Vth mainly increases, and a voltage-current characteristic line (V-I characteristic line) of the amorphous silicon transistor, as shown in FIGS. 22 and 23, has such a shape that the V-I characteristic line SPw in the initial state is moved substantially in parallel. Therefore, the V-I characteristic line SPw2 after variation can be interpreted to substantially correspond to the voltage-current characteristics at the time when a constant voltage (corresponding to an offset voltage Vofst to be described later) corresponding to the change amount ΔVth of the threshold value voltage Vth is uniquely added to the drain-source voltage Vds in the V-I characteristic line SPw in the initial state (namely, at the time when the V-I characteristic line SPw is moved in parallel by ΔVth).

In other words, in the operation for writing the display data in the display pixel (pixel circuit part DCx), the write voltage (corresponding to a correction gradation voltage VRpix to be described later) corrected by the addition of the constant voltage (offset voltage Vosft) corresponding to the change amount of the device characteristics (the change amount ΔVth of the threshold value voltage Vth) of the drive transistor (transistor Tr13) provided in the display pixel is applied to the source terminal of the drive transistor (contact point N12). According to this constitution, a shift in the voltage-current characteristics due to the variation of the threshold value voltage Vth of the drive transistor is compensated, and the light emitting driving current Iem having a current value based on the display data can be applied to the organic EL element OLED, whereby the organic EL element OLED can be made to emit light at a desired luminance gradation.

### FIRST APPLICATION EXAMPLE

Hereinafter, an application example of the display apparatus which can compensate for the influence of the characteristic variation in the above display pixel will be described.

### <Display Device/Data Driver>

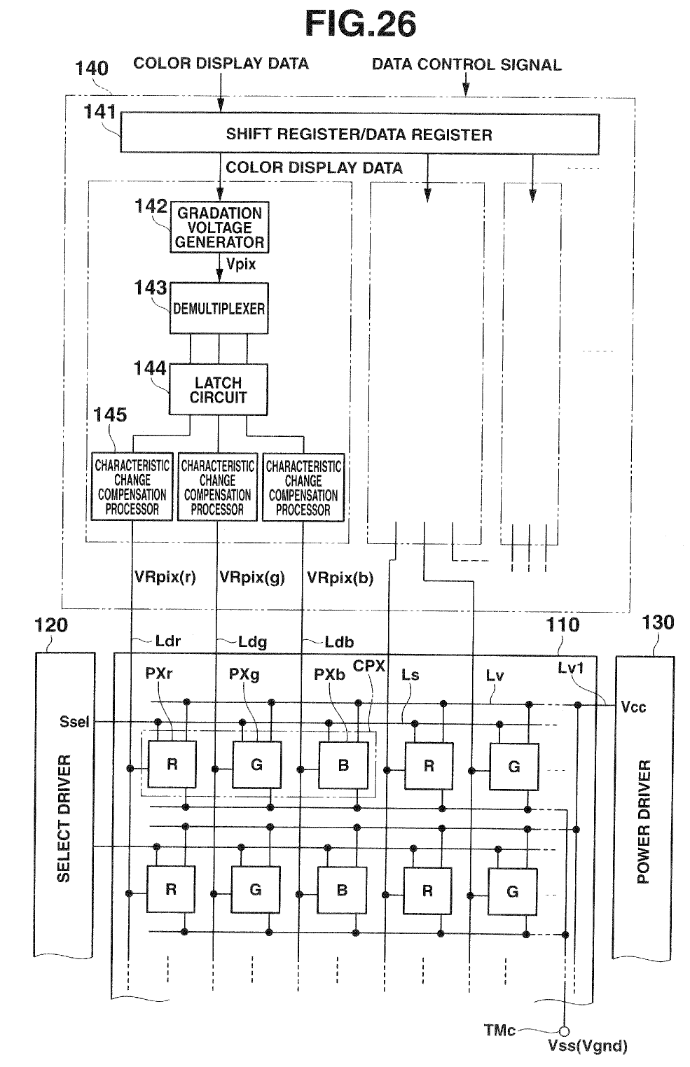

FIG. 26 is a schematic configuration diagram showing a display panel and a data driver in a first application example of the display apparatus according to the invention.

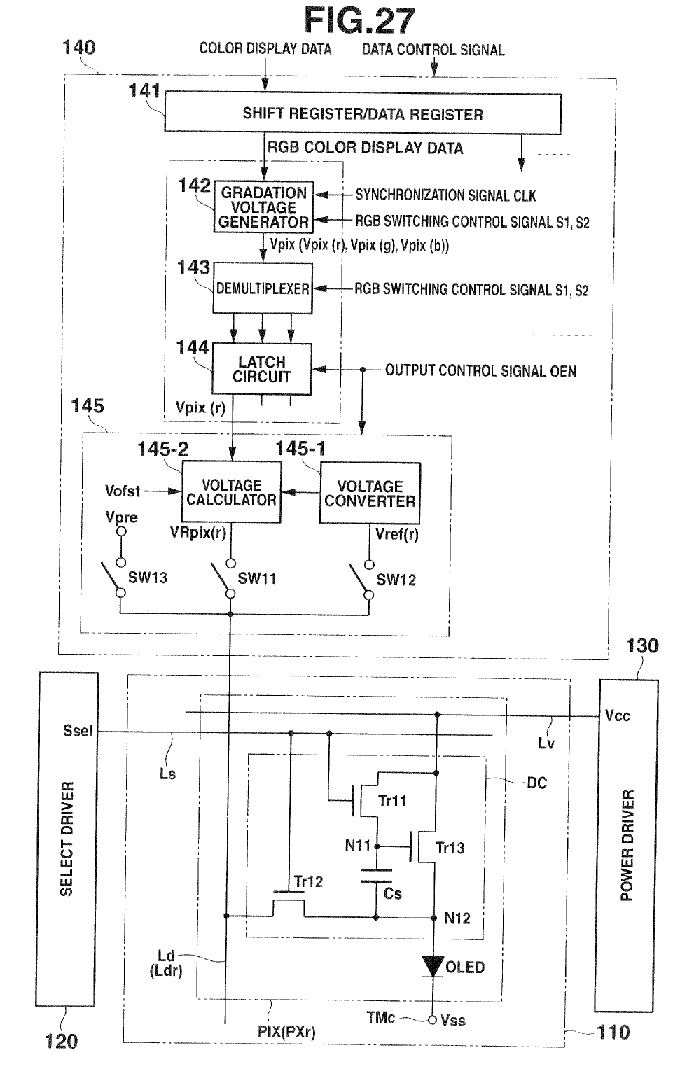

FIG. 27 is a configuration diagram of an essential part of the data driver according to the present application example.

In this application example, the data driver having a configuration specific to the present application example will be described in detail, and a description of the device configuration similar to the first embodiment (see, FIGS. 1 to 5) or the second embodiment (see, FIG. 18) is simplified or omitted.

In the display apparatus according to the present application example, as shown in, for example, FIG. 26, the data driver (display driving device) 140 shown in the first or second embodiment is provided with the shift register/data register 141, the gradation voltage generator 142, the demultiplexer 143, the latch circuit 144, and a characteristic change compensation processor (characteristic change compensation circuit) 145. The characteristic change compensation processor 145, as shown in FIG. 27, is provided with a voltage converter (characteristic change detecting part) 145-1, a voltage calculator (corrected gradation signal generator) 145-2, and connection path switching switches (hereinafter referred to as “switching switches”) SW11 to SW13. These components are respectively provided for each of the data lines Ldr, Ldg, and Ldb in each column connected with the display pixels PIX of each color of R, G, and B (sub pixels PXr, PXg, and PXb), and m sets of these components are provided in the display apparatus 100 according to this application example.

As shown in the above embodiments, in the gradation voltage generator 142, the demultiplexer 143, and the latch circuit 144, the gradation voltages Vpix (Vpix(r), Vpix(g), and Vpix(b)) corresponding to the display data for each of the display pixels PIX of each color of R, G, and B (sub pixels PXr, PXg, and PXb), which are sequentially supplied from the display signal generation circuit 160 and are captured through the shift register/data register 141, are generated in a time sharing manner to be distributed corresponding to each color of R, G, and B, and thus, to be held.

In the initial state where the threshold value voltage Vth of the transistor Tr13 for driving light emission, provided in the display pixels PIX (pixel driving circuit DC) of each color of R, G, and B, is not varied, the gradation voltages Vpix (Vpix(r), Vpix(g), and Vpix(b)) generated by the gradation voltage generator 142 are set to a voltage value for allowing the organic EL element OLED to emit light or emit no light at the luminance gradation based on the display data. Namely, the voltage value of the gradation voltages Vpix (Vpix(r), Vpix(g), and Vpix(b)) is set so that a potential difference between the power voltage line Lv and the data line Ld, which causes the current of the luminance gradation based on the display data to be applied to the transistor Tr13 when the transistor Tr13 is in the state of the V-I characteristic line SPw, is generated.

In parallel with the gradation voltage setting operation period Tsig related to the operation for capturing the display data, and the respective operations for generating, distributing, and holding the gradation voltages Vpix (Vpix(r), Vpix(g), and Vpix(b)) performed by the gradation voltage generator 142, the demultiplexer 143, and the latch circuit 144, the characteristic change compensation processor 145 detects the state (the change amount of the threshold value voltage of the drive transistor) of the characteristic change of each display pixel subjected to the write operation to correct the gradation voltages Vpix (Vpix(r), Vpix(g), and Vpix(b)) and generate the correction gradation voltages VRpix (VRpix(r), VRpix(g), and VRpix(b)) in the write operation applied to each of the display pixels PIX, and thus, to supply the correction gradation voltages VRpix to the display pixels PIX (sub pixels PXr, PXg, and PXb) of each color through the data lines Ld (Ldr, Ldg, and Ldb) in each column.

The voltage converter 145-1 applies a predetermined precharge voltage Vpre to the data lines Ld (Ldr, Ldg, and Ldb) of each color of R, G, and B (in each row) to read the potentials (reference voltages Vref (Vref(r), Vref(g), and Vref(b)) of the data lines Ld after a predetermined transient response period (a natural migration period) Ttrs has passed, and thus, to generate first compensation voltage components a·Vref (a·Vref(r), a·Vref(g), and a·Vref(b)), which are a product of a coefficient a (a is an arbitrary number) used for estimating the threshold value voltage Vth after the variation of the transistor Tr13 of each display pixel PIX (pixel driving circuit DC) and the reference voltage Vref. The voltage converter 145-1 then outputs the first compensation voltage component to the voltage calculator 145-2, to be described later.

When the pixel driving circuit DC has the circuit configuration shown in FIG. 3, such a setting is performed that the current applied to the data line Ld in the write operation is drawn from the data line Ld in the direction of the data driver 140. Therefore, the first compensation voltage component a·Vref is set to be a voltage (a·Vref<Vccw−Vth1−Vth2: Vth1 and Vth2 respectively correspond to the threshold value voltages of the transistor Tr13 and the transistor Tr12) which causes the current to flow from the power voltage line Lv to pass through between the drain and source of the transistor Tr13, through between the drain and source of the transistor Tr12, and through the data line Ld.

The voltage calculator (calculation circuit part) 145-2 adds and subtracts in an analog manner the gradation voltages Vpix of each color of R, G, and B (Vpix(r), Vpix(g), and Vpix(b)) generated in the gradation voltage generator 142, the first compensation voltage components a·Vref (a·Vref(r), a·Vref(g), and a·Vref(b)) of each color of R, G, and B generated in the voltage converter 145-1, and second compensation voltage components Vofst previously set based on the variation characteristics of the threshold value voltage Vth of the transistor Tr13, and outputs the resultant voltage component as the correction gradation voltages (correction gradation signal) of each color of R, G, and B VRpix (VRpix(r), VRpix(g), and VRpix(b)) to the data lines Ld in each column. Specifically, the voltage calculator 145-2 sets the correction gradation voltage VRpix so as to satisfy equation (11) in the write operation, to be described later:

VRpix=a·Vref−Vpix+Vofst (11)

The switching switches SW11 to SW13 perform an ON operation or an OFF operation at a predetermined timing on the basis of the data control signal supplied from the system controller 150. The switching switch SW11 is connected to between the data line Ld and the voltage calculator 145-2 and controls the timing of applying the correction gradation voltage VRpix from the voltage calculator 145-2 to the data line Ld. The switching switch SW12 is connected to between the data line Ld and the voltage converter 145-1 and controls the timing at which the potential (reference voltage Vref) of the data line Ld is read by the voltage converter 145-1. The switching switch SW13 is connected to between the data line Ld and a terminal for applying a precharge voltage Vpre (precharge voltage source) and controls the timing of applying the precharge voltage Vpre to the data line Ld. These switching switches SW11 to SW13 are preferably equivalent to one another in the resistance and the capacity.

In this application example, the system controller 150 has the function shown in the first embodiment, and, in addition, supplies the data control signal to the data driver 140 to thereby causes the data driver 140 to perform a series of drive control operations (a precharge operation and a characteristic change detection operation including a reference voltage reading operation after the transient response period has passed) for each display pixel PIX (pixel driving circuit DC) in which the correction gradation voltage VRpix corresponding to the characteristic change (the change amount ΔVth of the threshold value voltage of the transistor Tr13) of the display pixels PIX of each color of R, G, and B is generated, and the system controller 150 performs control to display image information based on a video signal in the display area 110.

### <Method of Driving Display Apparatus>

Next, a method of driving the display apparatus according to this application example will be described.

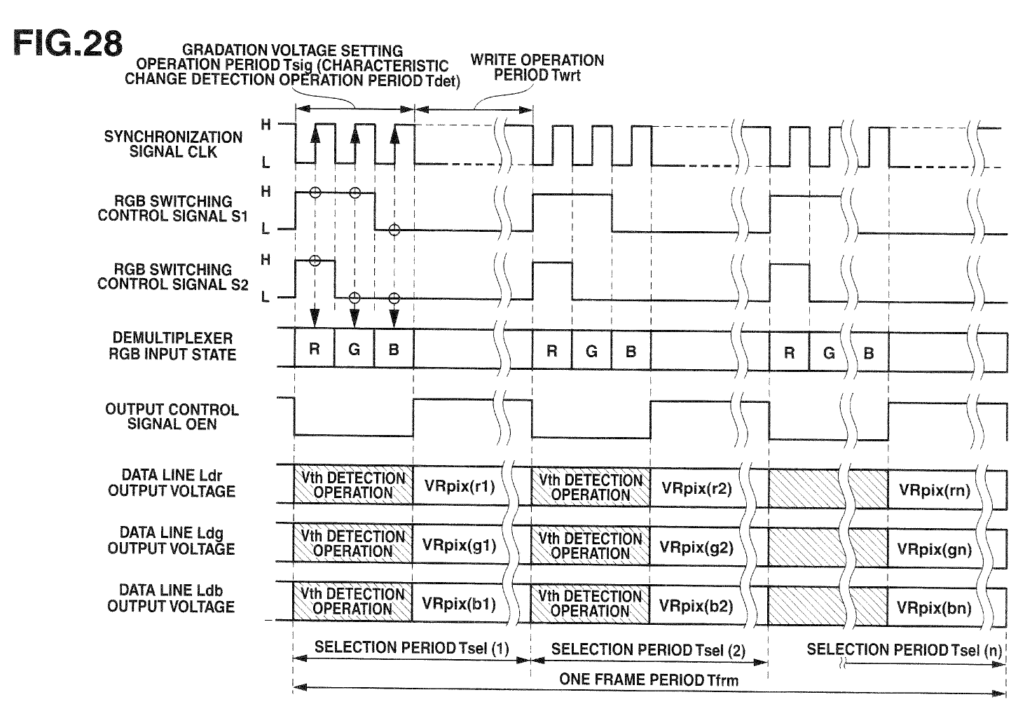

FIG. 28 is a timing chart showing an example of the method of driving the display apparatus according to this application example.

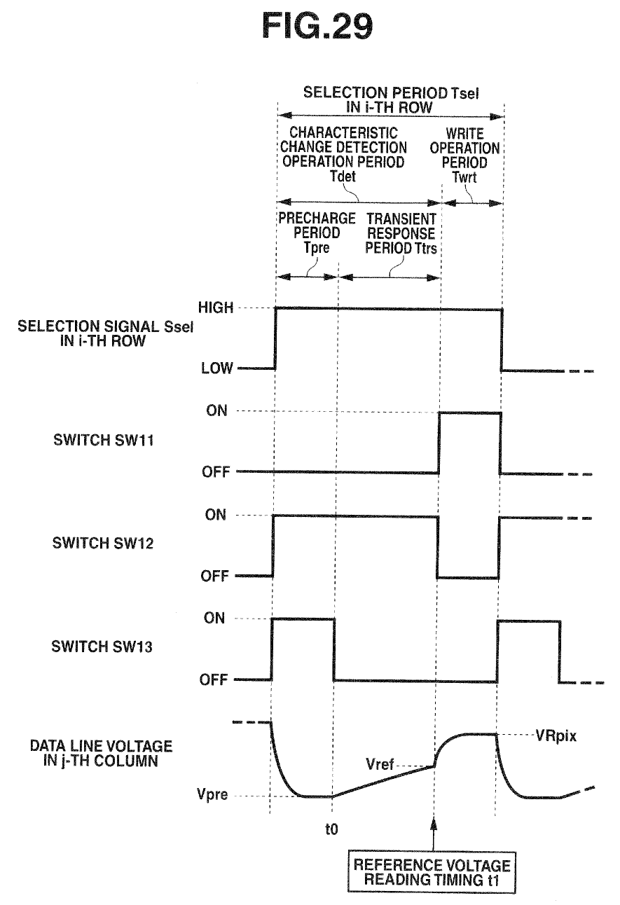

FIG. 29 is a timing chart showing a specific example of each operation during a selection period in the method of driving the display apparatus according to this application example.

The method of driving the display apparatus according to this application example will be described appropriately with reference to the driving method shown in the first embodiment (FIG. 11).

In the driving control operation of the display apparatus 100 according to the present embodiment, in the driving method shown in the first embodiment (see FIG. 11), as shown in, for example, FIGS. 28 and 29, in parallel with the gradation voltage setting operation (gradation voltage setting operation period Tsig in which the display data capture operation and the gradation voltage generating operation are executed) executed in the selection period Tsel of the display pixels PIX in the i-th row, a series of characteristic change detection operations (in the drawing, “Vth detection operation”: characteristic change detection operation period Tdet≧Tpre+Ttrs) is executed with respect to the display pixels PIX in the i-th row, the series of characteristic change detection operations including the precharge operation (precharge period Tpre) for applying a predetermined recharge voltage Vpre through the data line Ld in each column and the reference voltage reading operation for reading the reference voltage Vref based on the characteristic change (the device characteristics of the transistor Tr13) of each display pixel PIX after the predetermined transient response period Ttrs has passed.

### (Characteristic Change Detection Operation)

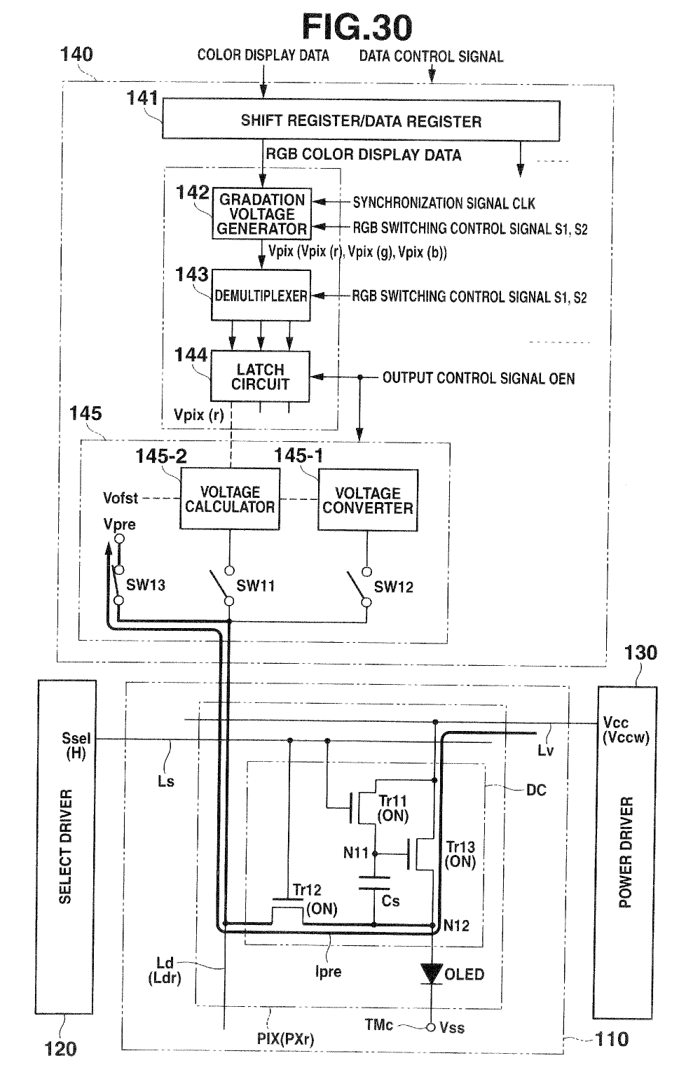

FIG. 30 is a conceptual diagram showing the precharge operation in the display apparatus according to the present application example.

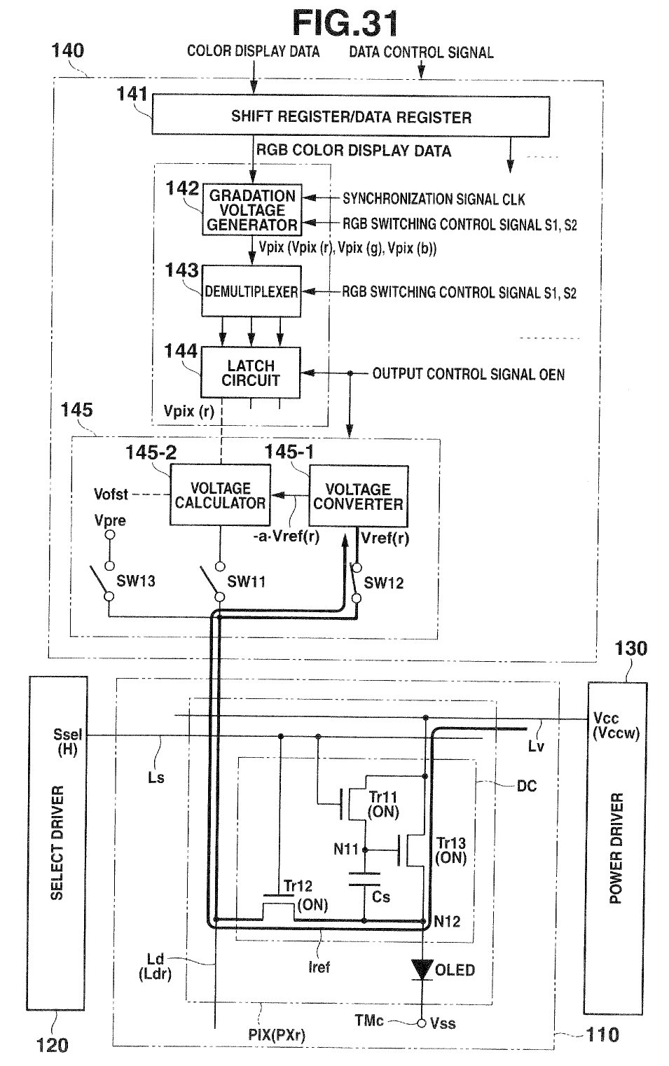

FIG. 31 is a conceptual diagram snowing the reference voltage reading operation in the display apparatus according to the present application example.

In the precharge operation (precharge period Tpre), as shown in FIGS. 29 and 30, the selection signal Ssel of the selection level (high level) is applied to the select line Ls in the i-th row aid sets the display pixels PIX in the i-th row to the selected state. In addition, in the characteristic change compensation processor 145 in the data driver 140, the switching switch SW11 is turned off, whereas the switching switches SW12 and SW13 are turned on in such a state that the power voltage Vcc (=Vccw) of the write operation level is applied to the power voltage lines Lv in the i-th row (the power voltage lines Lv commonly connected to all the display pixels PIX including the i-th row), whereby a predetermined precharge voltage Vpre is applied to each data line Ld, the drain-source current Lds corresponding to the precharge voltage Vpre is applied to each of the transistors (drive transistor) Tr13 in the pixel driving circuit DC of each of the display pixels PIX in the i-th row, and the voltage component corresponding to the drain-source current Ids is held in between the gate and the source of each of the transistors Tr13 (an electric charge corresponding to the precharge voltage Vpre is accumulated in the capacitor Cs).

In this application example, the maximum value of the threshold value voltage Vth after the variation of the device characteristics of the transistor Tr13 provided in the pixel driving circuit DC of the display pixel PIX is a sum of an initial threshold value voltage Vth0 of the transistor Tr13 and a voltage ΔVth_max where the change amount ΔVth of the threshold value voltage Vth of the transistor Tr13 is maximum. Meanwhile, in the transistor Tr12 provided in the pixel driving circuit DC of the display pixel PIX connected to the data line Ld, the maximum value of the drain-source current Vds is the initial drain and source voltage Vds12 and a maximum value ΔVds12_max of a variation value ΔVds12 of the drain-source voltage Vds12 based on the increase of resistance of the transistor Tr12.

When the amount of voltage drop due to the wiring resistance between the power voltage line Lv and the data line Ld is Vvd, the relation between a voltage applied to between the power voltage line Lv and the data line Ld by the application of the precharge voltage Vpre and a voltage applied to between the drain and source of the transistor Tr13 and between the drain and source of the transistor Tr12 is set to satisfy the following formula (12):

Vccw−Vpre≧Vth0+ΔVth_max+Vds12+ΔVds12_max+Vvd (12)

As shown in FIG. 29, the selection signal Ssel output to the select line Ls is at a high level of positive voltage in the characteristic change detection operation period Tdet. However, if a low level is a negative potential during other than the characteristic change detection operation period Tdet, that is not to say that the voltage applied to the gate electrode of the transistor Tr12 during the operation period is not substantially inclined toward the positive voltage, and therefore, ΔVds12_max can be rendered negligibly smaller than ΔVth_max. Under such conditions, the formula (12) can be replaced by the following formula (13):

Vccw−Vpre≧Vth0+ΔVth_max+Vds12+Vvd (13)

According to the above constitution, the potential difference (Vccw−Vpre) is applied to the transistors Tr12 and Tr13, and the voltage component in accordance with the precharge voltage Vpre is applied to between the gate and the source of the transistor Tr13 (both ends of the capacitor Cs). At this time, the voltage component applied to between the gate and the source of the transistor Tr13 has a large potential difference which is not less than the threshold value voltage due to the variation in the transistor Tr13. Therefore, the transistor Tr13 is turned on, and the precharge current Ipre corresponding to the potential component passes through between the drain and source of the transistor Tr13. Thus, a charge corresponding to the potential difference based on the precharge current Ipre is immediately accumulated in the both ends of the capacitor Cs (namely, the potential component corresponding to the precharge voltage Vpre is charged in the capacitor Cs).

In the pixel driving circuit DC having the circuit configuration shown in FIG. 30, as with the write operation shown in the above embodiments, the precharge voltage Vpre is set to be a negative potential with respect to the power voltage Vccw of the write operation level (low level), applied from the power driver 130 to the display pixels PIX, so as to allow the precharge current Ipre to be drawn from the data line Ld in the direction of the data driver 140 (Vpre<Vccw≦0).

In the above precharge operation, when the signal applied to the source terminal of the transistor Tr13 through the data line Ld is a current signal, the potential change may be delayed due to the wiring capacitance and wiring resistance parasitic in the data line Ld and a capacitance component provided in the pixel driving circuit DC of each display pixel PIX. However, since the precharge voltage Vpre is a voltage signal, it can be immediately charged at the initial stage of the precharge period Tpre. The signal rapidly approximates to the precharge voltage Vpre and thereafter to be gradually changed so as to converge to the precharge voltage Vpre within the remaining time of the precharge period Tpre.

In the precharge period Tpre, the voltage value of the precharge voltage Vpre applied to the contact point N12 on the anode terminal side of the organic EL element OLED is set to be lower than the reference voltage Vss applied to the cathode terminal TMc, and, in addition, the power voltage Vccw of the write operation level is set to be not more than the reference voltage Vss; therefore, since a forward bias is not applied to the organic EL element OLED, the current is not applied to the organic EL element OLED, and thus, the organic EL element OLED does not emit light.

Subsequently, as shown in FIG. 29, the switching switch SW13 is turned off immediately after the precharge operation, whereby the application of the precharge voltage Vpre to the display pixels PIX (pixel driving circuit DC) in the i-th row set in the selected state is stopped, and the potential of each data line Ld after a predetermined transient response period Ttrs has passed is read, whereby the reference voltage Vref corresponding to the voltage component (remaining in the capacitor Cs) held between the gate and source of the transistor Tr13 is obtained.

When the application of the precharge voltage Vpre to the data line Ld is stopped, the transistors Tr11 and Tr12 of the pixel driving circuit DC are held in the ON state. Therefore, while the other end side of the capacitor Cs (contact point N12) is set to the high impedance state, a potential difference not less than the threshold value voltage (Vth0+ΔVth_max) after the variation of the transistor Tr13 is held by the precharge operation. Thus, the transistor Tr13 maintains the ON state, a transient current Iref is flowed from the power voltage line Lv through the transistor Tr13, and, at the same time, the potential on the source terminal side of the transistor Tr13 (contact point N12: the other end side of the capacitor Cs) gradually increases so as to approach the potential on the drain terminal side (the power voltage line Lv side). With this increase, the potential of the data line Ld electrically connected through the transistor Tr12 therefore gradually increases.

In the transient response period Ttrs, a part of the charge accumulated in the capacitor Cs is discharged to reduce the gate-source voltage Vgs of the transistor Tr13; therefore, as shown in FIG. 29, the potential of the data line Ld is changed from the precharge voltage Vpre applied by the precharge operation in such a direction to converge to the threshold value voltage (Vth0+ΔVth) due to the variation of the transistor Tr13. If the transient response period Ttrs is set to be a sufficiently long time, the potential difference Vccw−V(t) is changed so as to converge to Vth0+ΔVth. In this case, white V(t) is a potential of the data line Ld displaced by a time t, V(t) is the precharge voltage Vpre at the end timing t0 of the precharge period Tpre (or at the start timing of the transient response period Ttrs). When the transient response period Ttrs is set to be a sufficiently long time, the selection period Tsel becomes long, leading to a substantial deterioration in the display characteristics, especially moving image display characteristics.

Thus, in this application example, the transient response period Ttrs is set to an arbitrary time that is shorter than the time at which the gate-source voltage Vgs of the transistor Tr13 (the potential on the source terminal side of the transistor Tr13) converges to the threshold value voltage after variation (Vth0+ΔVth) and can secure a sufficient time, which is the precharge period Tpre described above and the write operation period Twrt to be described later, within a predetermined selection period Tsel. Namely, the end timing of the transient response period Ttrs (referred to as “reference voltage reading timing t1” in the drawings) is set to a specific time when the gate-source voltage Vgs of the transistor Tr13 (the potential on the source terminal side of the transistor Tr13) is in the process of changing.

Also in the transient response period Ttrs, the voltage value applied to the contact point N12 on the anode terminal side of the organic EL element OLED is set to be lower than the reference voltage Vss applied to the cathode terminal TMc; therefore, since the organic EL element OLED is still not in the forward bias state, the organic EL element OLED does not emit light.

In the reference voltage reading operation after the transient response period Ttrs has passed, as shown in FIGS. 29 and 31, in the reference voltage reading timing t1 that is the end timing of the transient response period Ttrs, the potential of the data line Ld (reference voltage Vref) is read by the voltage converter 145-1 connected to the data line Ld through the switching switch SW12.

As described above, the data line Ld is in a state of being connected to the source terminal side of the transistor Tr13 (contact point N12) through the transistor Tr12 set in the ON state, and the potential (reference voltage Vref) of the data line Ld read by the voltage converter 143, as described later, is a function of the time t and depends on the voltage corresponding to the gate-source voltage Vgs of the transistor Tr13.

As more fully discussed hereinafter, the behavior of the gate-source voltage Vgs of the transistor Tr13 after the precharge operation (transient response period Ttrs) differs according to the threshold value voltage Vth of the transistor Tr13 or the threshold value voltage after variation (Vth0+ΔVth), and therefore, the threshold value voltage Vth of the transistor Tr13 or the threshold value voltage after variation (Vth0+ΔVth) can be substantially uniquely determined based on the change of the gate-source voltage Vgs of the transistor Tr13. In the gate-source voltage Vgs of the transistor Tr13, as the variation of the threshold value voltage Vth progresses (namely, as the change amount Vth increases), the gradient of the change becomes smaller.

In other words, when the reference voltage Vref(t1), which corresponds to the gate-source voltage Vgs(t1) of the transistor Tr13, is read at the timing after a specified transient response period Ttrs (reference voltage reading timing t1) has passed, the potential of the reference voltage Vref(t1) read at the timing t1 after the specified transient response period Ttrs has passed is lower according to the progression of the variation of the threshold value voltage Vth of the transistor Tr13 (the change amount ΔVth is large). Thus, the threshold value voltage Vth of the transistor Tr13 or the threshold value voltage after variation (Vth0+ΔVth) can be determined or estimated based on the reference voltage Vref (t1) read at the timing t1 after the transient response period Ttrs has passed.

The reference voltage Vref read by the voltage converter 145-1 can be represented by the following equation (14):

Vccw−Vref(t)=Vgs+Vrttl (14)

In the equation (14), Vgs is the gate-source voltage of the transistor Tr13 (=the drain-source voltage of the transistor Tr13) at the reference voltage reading timing after the transient response period Ttrs has passed, and Vrttl is a sum of a voltage drop ds12 due to the source-drain resistance of the transistor Tr12 and the wiring resistance Vvd.

Namely, the modulation of the potential in the data line Ld from the start timing t0 in the transient response period Ttrs to the end timing t1 in the transient response period Ttrs (Vref(t1)=Vref(t0)) depends on the modulation of the gate-source voltage of the transistor Tr13 from the start timing t0 in the transient response period Ttrs to the end timing t1 in the transient response period Ttrs {Vgs(t1)−Vgs(t0)}. As described later, the threshold value voltage Vth of the transistor Tr13 can be uniquely defined by such variation.

In the reference voltage Vref read in the above manner, the voltage level is held in the voltage converter 145-1 through, for example, a buffer, thereafter to be converted by inversion amplification, and thus, to be output as the first compensation voltage component a·Vref to the voltage calculator 145-2.

### (Write Operation)

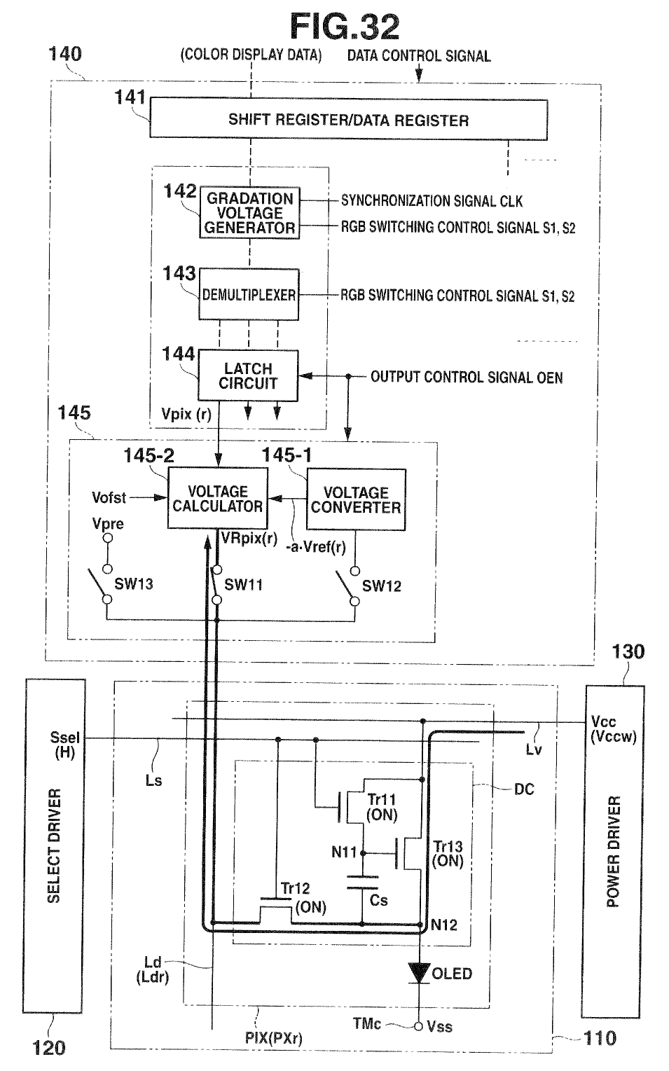

FIG. 32 is a conceptual diagram showing the write operation in the display apparatus according to the present application example.

As described above, with respect to each of the display pixels PIX set in the selected state, after reading of the reference voltage Vref corresponding to the threshold voltage value (Vth0+ΔVth) after variation of the transistor Tr13 for driving light emission provided in the pixel driving circuit DC, the write operation of the display data is executed continuously.

In the write operation period Twrt after the termination of the above-mentioned characteristic change detection operation (characteristic change detection operation period Tdet), as shown in FIGS. 29 and 32, the switching switch SW11 is turned on, and the switching switches SW12 and SW13 are turned off, whereby the data line Ld and the voltage calculator 145-2 are electrically connected, and, at the same time, the power voltage Vccw of the write operation level is continuously applied to the power voltage line Lv. In this state, the gradation voltage Vpix generated in accordance with the display data for each display pixel PIX is corrected in accordance with the compensation voltage set based on the reference voltage Vref read by the reference voltage reading operation, the correction gradation voltage VRpix corresponding to the operation characteristics after variation of the display pixel PIX (the device characteristics after variation of the transistor Tr13: the threshold value voltage Vth) is generated (correction gradation voltage generating operation) to be applied to each of the display pixels PIX in the i-th row, set in the selected state, through the data lines Ld in each column, and the voltage component corresponding to the correction gradation voltage VRpix is held (write operation).

In the correction gradation voltage generating operation, the gradation voltages Vpix of each color of R, G, and B (Vpix(r), Vpix(g), and Vpix(b)), which are generated by the gradation voltage generator 142 based on the luminance gradation value included in the display data and held in parallel in the latch circuit 144 through the demultiplexer 143 are output to the voltage calculator 145-2, and the gradation voltages Vpix are corrected so as to have a voltage value corresponding to the variation of the threshold value voltage Vth of the transistor Tr13, based on the reference voltages Vref (Vref(r), Vref(g), and Vref(b)) obtained by the voltage converter 145-1 in the characteristic change detection operation (reference voltage reading operation).

Specifically, in the voltage calculator 145-2, the gradation voltage Vpix output from the latch circuit 144, the first compensation voltage component a·Vref output from the voltage converter 145-1, and the second compensation voltage component Vofst obtained based on, for example, the variation characteristics of the threshold value voltage Vth of the transistor Tr13 (the relation between the threshold value voltage Vth and the reference voltage Vref) are added and subtracted so as to satisfy the equation (11), and thus, to generate the correction gradation voltage VRpix. The coefficient a is a positive value (a>0), and the second compensation voltage component Vofst is a positive value (Vofst>0), depending on the design of the transistor Tr13.

The gradation voltage Vpix is a positive voltage (Vpix>0) in which the potential becomes higher as the gradation of the display data becomes higher, and the correction gradation voltage VRpix is set so as to have a voltage amplitude of a negative potential relative to the low potential power voltage Vcc (=Vccw≦reference voltage Vss) of the write operation level applied from the power driver 130 to the power voltage line Lv. Namely, as the gradation becomes higher, the correction gradation voltage VRpix is lower on the negative potential side (the absolute value of the voltage amplitude is larger).

According to the above constitution, in the write operation, as shown in FIG. 32, the correction gradation voltage VRpix obtained by correcting the gradation voltage Vpix based on the compensation voltage component (a·Vref+Vofst) in accordance with the change amount ΔVth of the threshold value voltage Vth of the transistor Tr13 is applied to the source terminal of the transistor Tr13 (contact point N12) of the display pixel PIX (pixel driving circuit DC), set in the selected state, through the switching switch SW11 and the data line Ld. Therefore, the voltage Vgs corresponding to the correction gradation voltage VRpix is written and set in between the gate and source of the transistor Tr13 (both ends of the capacitor Cs). In such a write operation, the voltage component is not set by applying a current corresponding to the display data to the gate terminal and the source terminal of the transistor Tr13, but since a predetermined voltage is directly applied, the potential of each terminal and each contact point can be immediately set in the desired state.

Further, in such a write operation, the correction gradation voltages VRpix (VRpix(r), VRpix(g), and VRpix(b)) corresponding to the display data of each color of R, G, and B are simultaneously applied from the data driver 140 to the display pixels PIX of each color of R, G, and B (sub pixels PXr, PXg, and PXb), arrayed in the display area 110, through the data lines Ld (Ldr, Ldg, and Ldb) in each column, and thus, the write operation is executed in parallel.

Also in the write operation period Twrt, the voltage value of the correction gradation voltage VRpix applied to the contact point N12 on the anode terminal side of the organic EL element OLED is set to be lower than the reference voltage Vss applied to the cathode terminal TMc (namely, the organic EL element OLED is set in the reverse bias state), whereby the current is not applied to the organic EL element OLED, and thus the organic EL element OLED does not emit light.

In the correction gradation voltage generating operation, in the gradation voltage setting operation (the display data capture operation and the gradation voltage generating operation) executed in parallel with the characteristic change detection operation, when the luminance gradation value included in the display data obtained by the gradation voltage generator 142 is “0”, a gradation voltage Vzero for performing the non-emitting operation (or the black display operation) is output from the gradation voltage generator 142, and applied as it is to the data line Ld through the switching switch SW11 without being subjected to the correction processing based on the reference voltage Vref in the voltage calculator 145-2 (namely, the compensation processing for the variation of the threshold value voltage Vth of the transistor Tr13).

The gradation voltage Vzero for the non-emitting operation applied to the data line Ld is set to be a voltage value (−Vzero<Vth−Vccw) having such a relation that the voltage Vgs (≈Vccw−Vzero) applied to between the gate and source of the diode-connected transistor Tr13 is lower than the threshold value voltage Vth of the transistor Tr13 or the threshold value voltage after variation (Vth0+ΔVth) (Vgs<Vth). The gradation voltage Vzero is preferably Vccw in order to control the variation of a threshold value voltage of the transistors Tr12 and Tr13.

### (Holding Operation)

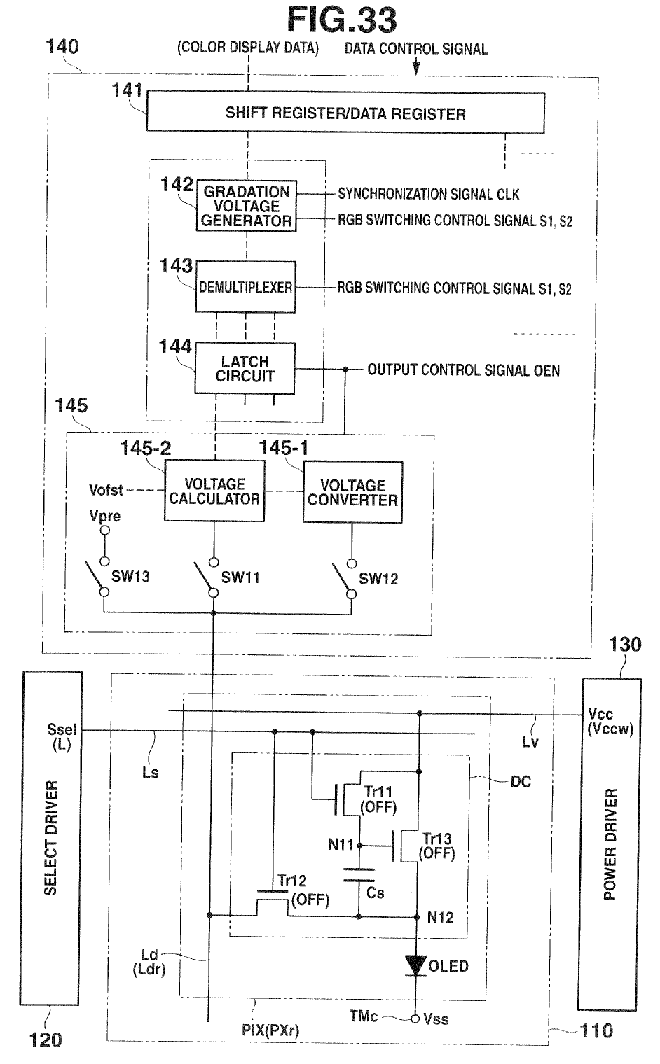

FIG. 33 is a conceptual diagram showing the holding operation in the display apparatus according to the application example.

In the holding operation (holding operation period Thld) after the termination of the characteristic change detection operation and the write operation executed in parallel with the gradation voltage setting operation, the selection signal Ssel of the non-selection level (low level) is applied to the select line Ls in the i-th row as shown in FIG. 11, whereby, as shown in FIG. 33, the transistors Tr11 and Tr12 are turned off, and the diode-connected state in the transistor Tr13 is released. At the same time, the electrical connection between the source terminal of the transistor Tr13 (contact point N12) and the data line Ld is interrupted, and the voltage component corresponding to the correction gradation voltage VRpix (VRpix(r), VRpix(g), and VRpix(b)) is changed (held) in between the gate and source of the transistor Tr13 (both ends of the capacitor Cs).

Also in the present application example, as with the above embodiments, as shown in FIG. 11, in the holding operation period Thld after the termination of the gradation voltage setting operation (characteristic change detection operation) and the write operation applied to the display pixels PIX in the i-th row, the selection signal Ssel of the selection level (high level) is applied from the select driver 120 to the select line Ls in (i+1)-th row, whereby the display pixel in (i+1)-th row is set to the selected state, and a series of processing operations, including the gradation voltage setting operation (characteristic change detection operation) and the write operation similar to the above, are executed.

In the conceptual diagram of the holding operation shown in FIG. 33, the switching switches SW11 to SW13 provided in the data driver 140 are set to the OFF state. However, as described above, in the holding operation period Thld for the display pixels PIX in the i-th row, the characteristic change detection operation (precharge operation, transient response, and reference voltage reading operation) and the write operation are parallel executed with respect to the display pixels PIX after the (i+1)-th row. Therefore, as shown in FIG. 29, the switching switches SW11 to SW13 are individually switched and controlled at a predetermined timing for each of the selection period Tsel of the display pixels in each row.

### (Light Emitting Operation)

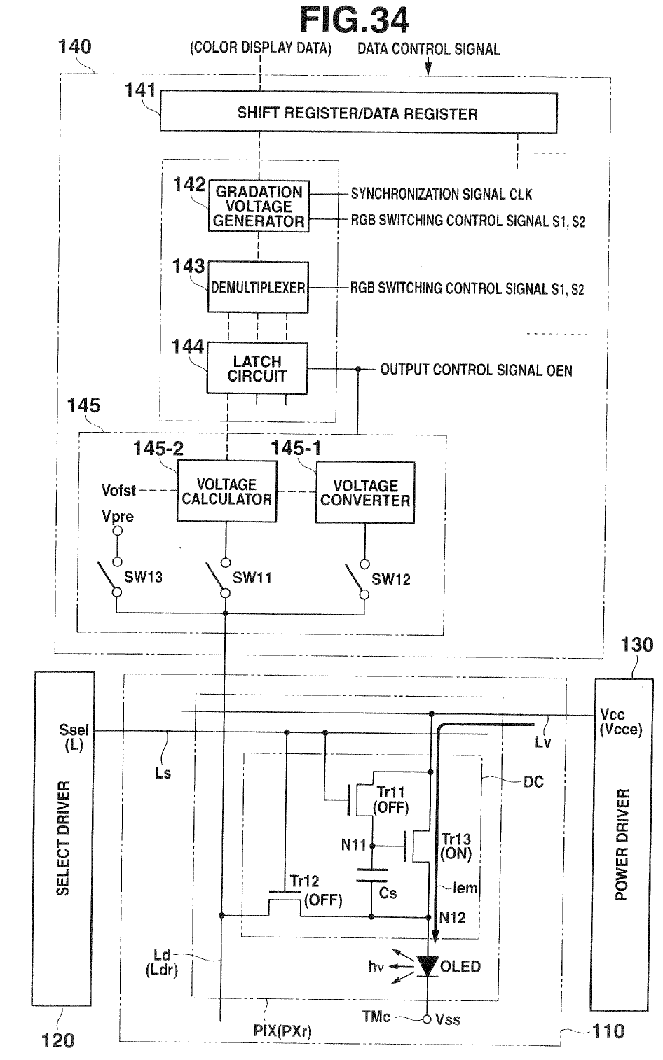

FIG. 34 is a conceptual diagram showing a light emitting operation in the display apparatus according to the present application example.

In the light emitting operation (light emitting operation period Tem) after the termination of the gradation voltage setting operation, and the characteristic change detection operation, the write operation, and the holding operation simultaneously and in parallel applied to the display pixels PIX in all rows included in an arbitrary group, as shown in FIG. 11, the power voltage Vcc of the light emitting operation level, which has a higher potential than the reference voltage Vss (for example, a ground potential) (=Vcce>Vss), is applied to the power voltage line Lv connected to the display pixels PIX in each row in such a state that the selection signal Ssel of the non-selection level (low level) is applied to the select line Ls in each row in the relevant group.

According to this constitution, the transistor Tr13 of each display pixel PIX (pixel driving circuit DC) is operated in the saturated area. In addition, while a positive voltage corresponding to the voltage component (Vccw−VRpix) written and set in between the gate and source of the transistor Tr13 is applied to the anode side of the organic EL element OLED (contact point N12) by the write operation, the reference voltage Vss is applied to the cathode terminal TMc, whereby the organic EL element OLED is set to the forward bias state. Therefore, as shown in FIG. 34, the light emission driving current Iem (the drain-source current Ids of the transistor Tr13), which has a gradation according to the display data and a current value corresponding to the correction gradation voltage VRpix corrected corresponding to the threshold value voltage Vth (=Vth0+ΔVth) after variation of the transistor Tr13, is applied from the power voltage line Lv to the organic EL element OLED through the transistor Tr13, whereby the organic EL element OLED emits light at a desired luminance gradation.

According to the display apparatus according to the present application example and the method of driving the display apparatus, in the data driver provided with the digital-analog conversion circuit (gradation voltage generator) having the single (common) gamma correction curve shown in the above embodiments, for example, in accordance with the timing of supplying the display data of R, G, and B colors, the gradation reference voltage applied to the digital-analog conversion circuit is sequentially switched and set, and the gradation voltage setting operation (display data capture operation and gradation voltage generating operation) in which the digital-analog conversion processing is performed in a time sharing manner with the use of the gamma correction curve corresponding to the electro-optic characteristics of the organic EL element of each color of R, G, and B to generate the gradation voltage corresponding to the display data of each color of R, G, and B (luminance gradation value). At the same time, the characteristic change detection operation for detecting the temporal characteristic changes (the threshold value voltage variation of the drive transistor) of each display pixel to which the relevant display data is written is executed in parallel with the gradation voltage setting operation period, and the gradation voltage is corrected to be written in each display pixel so as to compensate for the characteristic changes. Therefore, while the margin of the gradation voltage setting operation and the write operation in the selection period is sufficiently secured, the variation of the light emission characteristic for each display pixel is suppressed, and the display pixel is made to emit light at an appropriate luminance gradation according to the display data, whereby the display image quality can be improved.

In other words, as shown in the present application example, in the display apparatus having a driving method in which the operation for compensating the characteristic changes (such as the threshold value variation of the drive transistor) of the display pixel to which the display data will be written is executed prior to the operation for writing the display data in each display pixel, the gradation voltage generating operation can be executed in parallel during the detection operation period of the characteristic changes. In the gradation voltage generating operation, the display data is digital-analog converted (gamma correction processing) in a time sharing manner by the digital-analog conversion circuit, having the single gamma characteristics according to the invention, with the use of the gamma correction curve in which the characteristics are specified by switching the gradation reference voltage in accordance with the display data of each color. In the display apparatus having the characteristic change compensation function, the circuit configuration of the data driver (gradation voltage generator) can be reduced in size without changing the operation timing of the driving method.

Further, in the characteristic change compensation mechanism shown in the present application example, since the gradation signal (correction gradation voltage) output from the data driver 140 to each display pixel is a voltage signal, the gradation signal is different from the current driver which directly sets the current value of the drain-source current Ids passing through the drive transistor (transistor Tr13) in the write operation period, for example. Therefore, even if the current value of the drain-source current Ids passing through the transistor Tr13 in the write operation period is very small, the gate-source voltage Vgs corresponding to the drain-source current Ids passing through the transistor Tr13 can be immediately set. Thus, it is possible to favorably realize the write operation for writing the correction gradation voltage VRpix in between the gate-source of the transistor Tr13 and the capacitor Cx within the selection period set to be relatively short, in addition to the application of the precharge voltage Vpre, the reading of the reference voltage Vref after a predetermined transient response period Ttrs has passed, and the generation of the correction gradation voltage VRpix.

The circuit configuration according to the characteristic change compensation function and the control operation are examples applicable to the invention, and are not limited to the above. Namely, as shown in the above embodiments, as long as the characteristic changes of the display pixel (such as the threshold value voltage variation of the drive transistor) is detected independently of the gradation voltage setting operation during the gradation voltage setting operation period executed prior to the operation for writing the display data to the display pixel, another circuit configuration and control operation may be applied.

### <Specific Example of Driving Method>

Next, in the present application example, a driving method specific to the display apparatus 100 having the display area 110 shown in FIG. 1 will be specifically described.

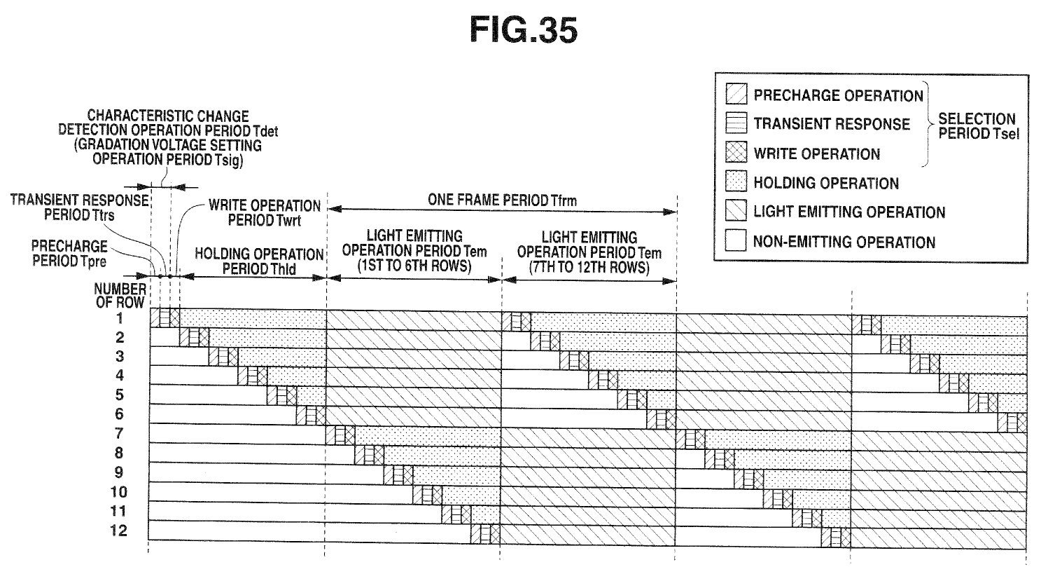

FIG. 35 is an operation timing diagram schematically showing a specific example of the method of driving the display apparatus according to the first application example.

Any description of the driving method similar to the above embodiment (see, FIG. 17) is simplified or omitted. As with the above embodiment, for convenience of explanation, 12 rows of display pixels (n=12: 1st to 12th rows) are arrayed in the display area and divided into a group including the display pixels in 1st to 6th rows (corresponding to the upper area shown in FIG. 1) and a group including the display pixels in 7th to 12th rows (corresponding to the lower area shown in FIG. 1).

In the driving control method in the display apparatus 100 according to the present application example, as shown in, for example, FIG. 35, in the driving method shown in the above embodiment (see FIG. 17), the characteristic change detection operation (the precharge operation, the transient response, and the reference voltage reading operation) is simultaneously and in parallel executed within the gradation voltage setting operation period Tsig in the display pixels PIX in each row in the display area 110, and the write operation (including the correction gradation voltage generating operation) is continuously executed with respect to the display pixels PIX in the row with which the gradation voltage setting operation and the characteristic change detection operation are terminated.

Such a series of operations is sequentially repeated for each row, and with respect to all the display pixels PIX (organic EL element OLED) in the 1st to 6th rows or the 7th to 12th rows which have been previously divided into groups, a processing for making all the display pixels PIX, included in the relevant group, simultaneously emit light with a luminance gradation based on the display data is sequentially repeated in each group at the timing at which the write operation is terminated, whereby the image information corresponding to one screen of the display area 110 is displayed.

### SECOND APPLICATION EXAMPLE

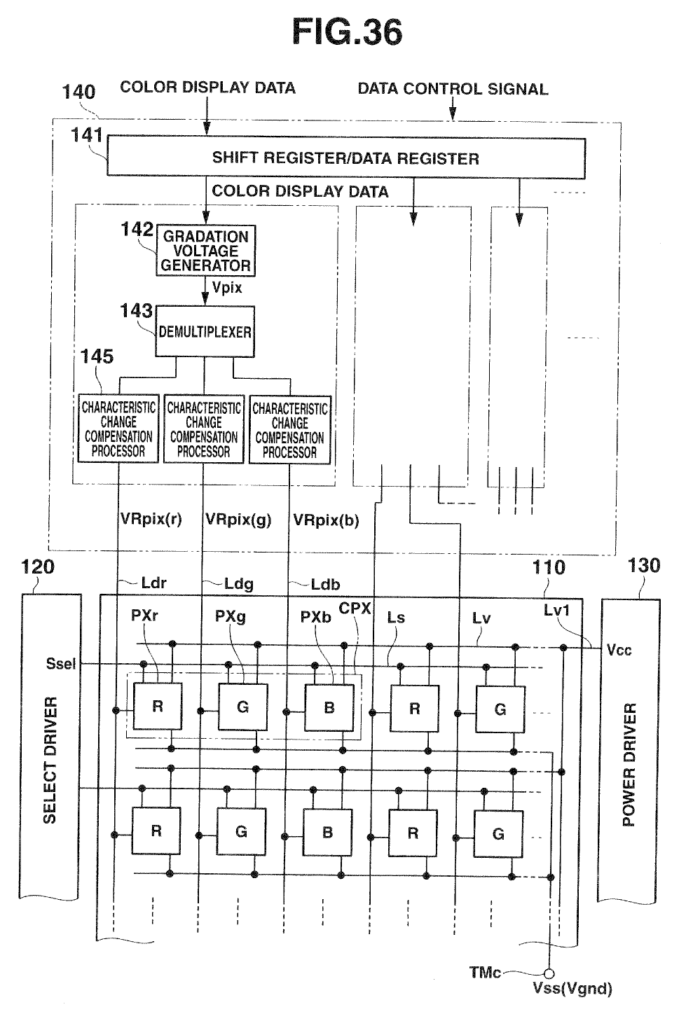

FIG. 36 is a schematic configuration diagram showing a display panel and a data driver in a second application example of the display apparatus according to the invention.

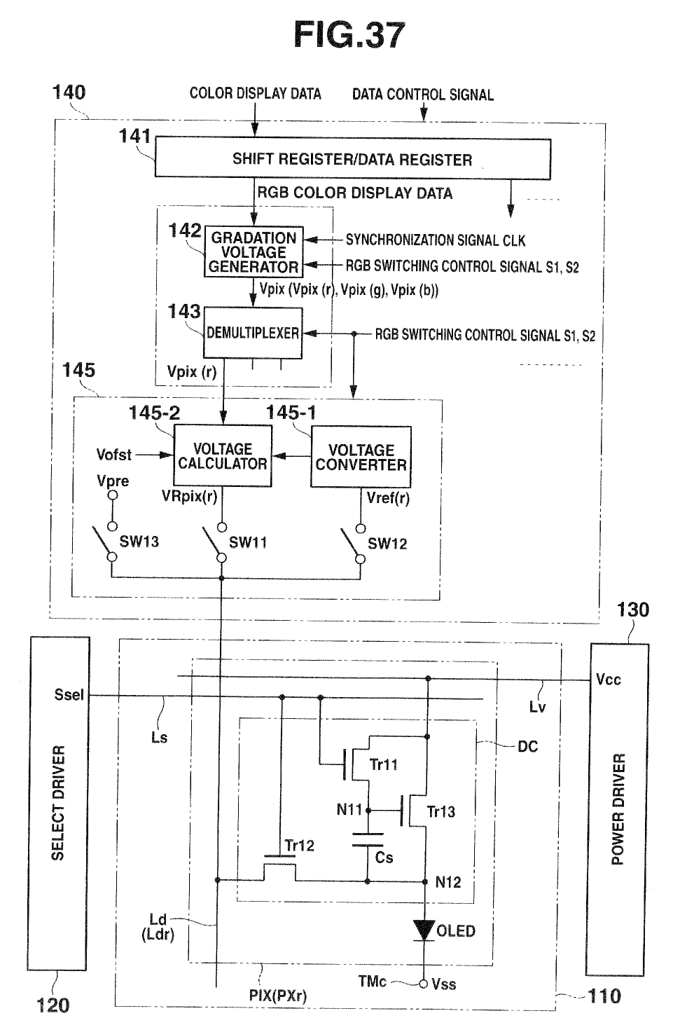

FIG. 37 is a configuration diagram of an essential part of the data driver according to the second application example.

In the second application example, any description of the device configuration similar to the first application example and the third embodiment (see FIGS. 19 and 20) is simplified or omitted.

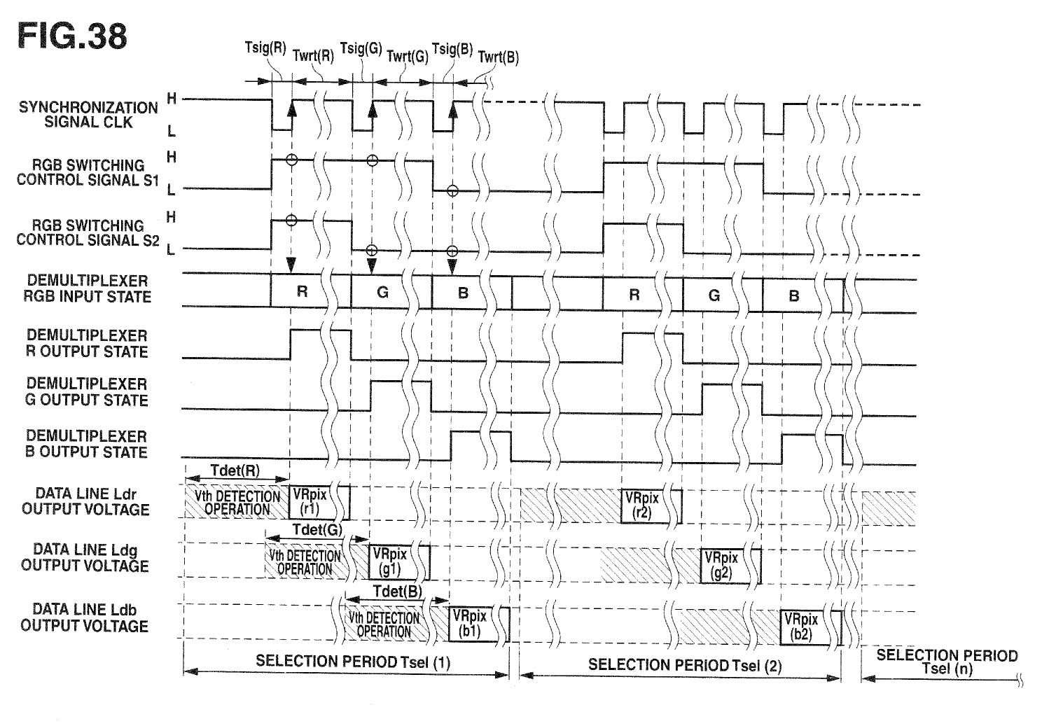

FIG. 38 is a timing chart showing an example of a method of driving the display apparatus according to the present application example.

The method of driving the display apparatus and the operation during the selection period according to the present application example will be described appropriately with reference to the driving method shown in the first embodiment (FIG. 11) and the operation during the selection period shown in the first application example (FIG. 29).

In the first application example, there has been described the device configuration in which a mechanism (characteristic change compensation processor 145), which compensates for the characteristic changes (the threshold value voltage variation of the drive transistor) of the display pixels PIX to be subjected to the write operation, is added to the data driver 140 according to the first and second embodiments. However, in the second application example, the data driver according to the third embodiment has the device configuration added with the characteristic change compensation mechanism (the characteristic change compensation processor 145) similar to that in the first application example.

Namely, in the display apparatus according to the present application example, as shown in, for example, FIG. 36, the data driver (display driving device) 140 shown in the third embodiment is provided with the characteristic change compensation processor 145 in addition to the shift register/data register 141, the gradation voltage generator 142, and the demultiplexer 143. The characteristic change compensation processor 145, as shown in FIG. 37, is provided with the voltage converter (characteristic change detector) 145-1, the voltage calculator (correction gradation signal generator) 145-2, and the connection path switching switches (switching switches) SW11 to SW13, as with the first application example. These components are respectively provided for each of the data lines Ldr, Ldg, and Ldb in each column connected with the display pixels PIX of each color of R, G, and B (sub pixels PXr, PXg, and PXb).

According to the above constitution, as shown in FIG. 38, as with the third embodiment, in the gradation voltage setting operation period Tsig (Tsig(R), Tsig(G), and Tsig(B)) of each color of R, G, and B set during the selection period Tsel, the display data of each color of R, G, and B is sequentially captured from the display signal generation circuit 160 through the shift register/data register 141, and the gradation voltages Vpix (Vpix(r), Vpix(g), and Vpix(b)) corresponding to the luminance gradation value included in the display data are generated in a time sharing manner by the gradation voltage generator 142 and the demultiplexer 143 to be distributed corresponding to each color of R, G, and B, and thus, to be sequentially output.

Meanwhile, each of the characteristic change compensation processor 145 provided corresponding to the display pixels PIX of each color of R, G, and B (sub pixels PXr, PXg, and PXb) includes the gradation voltage setting operation periods Tsig (Tsig(R), Tsig(G), and Tsig(B)) in which the gradation voltages Vpix of each color of R, G, and B (Vpix(r), Vpix(g), and Vpix(b)) are generated and distributed. In addition, in the characteristic change detection operation periods Tdet (Tdet(R), Tdet(G), and Tdet(B)) in parallel with the gradation voltage setting operation periods Tsig (Tsig(R), Tsig(G), and Tsig(B)), as with the first application example, the characteristic change detection operation including the precharge operation and the reference voltage reading operation after the transient response period has passed is executed with respect to each display pixel PIX (sub pixels PXr, PXg, and PXb) set in the selected state, and the state of the characteristic change of each display pixel PIX (the change amount of the threshold value voltage of the drive transistor) is detected.

Then, in the write operation periods Twrt (Twrt(R), Twrt(G), and Twrt(B)) in which the write operation is executed with respect to the display pixels PIX of each color, the gradation voltages Vpix (Vpix(r), Vpix(g), and Vpix(b)) of each color of R, G, and B sequentially output from the demultiplexer 143 are corrected by the individual characteristic change compensation processor 145 to generate the correction gradation voltages VRpix (VRpix(r), VRpix(g), and VRpix(b)), and thus, to be sequentially applied to the display pixels PIX of each color (sub pixels PXr, PXg, and PXb) through the data lines Ld (Ldr, Ldg, and Ldb) in each column, whereby the voltage component corresponding to the correction gradation voltage VRpix (VRpix(r), V pix(g), and VRpix(b)) is held.

As with the third embodiment, the gradation voltage setting operation (the gradation voltage setting operation periods Tsig(R), Tsig(G), an Tsig(B)) and the write operation (the write operation periods Twrt(R), Twrt(G), and Twrt(B)) are, as shown in FIG. 38, continuously executed as a series of operations for each display data of each color of R, G, and B, and sequentially executed in order of P, G, and B at such a timing that these operations do not overlap with each other in each color of R, G, and B (at different timings). Further, some of the characteristic change detection operations (characteristic change detection operation periods Tdet(R), Tdet(G), and Tdet(B)) executed in parallel with the gradation voltage setting operation (gradation voltage setting operation period Tsig) of each color of R, G, and B may be executed so as to temporally overlap with each other, as shown in FIG. 38, or may be executed at such a timing that they do not overlap with each other.

According to the display apparatus according to the present application example and the method of driving the display apparatus, as with the first application example, the gradation reference voltage applied to the digital-analog conversion circuit (gradation voltage generator) having the single (common) gamma correction curve is sequentially switched and set in accordance with the display data, whereby in parallel with the gradation voltage setting operation period in which the gamma correction processing corresponding to the electro-optic characteristics of the organic EL element of each color of R, G, and B is executed to generate the gradation voltage of each color of R, G, and B, the characteristic changes (the threshold value voltage change of the drive transistor) of each display pixel in which the relevant display data is written is detected, and each gradation voltage can be corrected so as to compensate for the characteristic changes to be written in each display pixel. Therefore, while the margin of the gradation voltage setting operation in each color and the write operation in the selection period is sufficiently secured, the variation of the light emission characteristics for each display pixel is suppressed, and the display pixel is made to emit light with an appropriate luminance gradation based on the display data, whereby the display image quality can be improved. At the same time, the latch circuit in each of the characteristic change compensation processors is omitted, whereby the circuit configuration of the data driver (gradation voltage generator) can be further reduced in size.

What is claimed is:

1. A display driving device for driving a plurality of display pixels provided with a light emitting element, which performs color display and has any one of a plurality of light emission colors, comprising:
a signal converter, which is supplied a display data, which corresponds to said each display pixel and includes a plurality of color components corresponding to said plurality of light emission colors and generates a gradation signal, which corresponds to the predetermined number of two or more display pixels having the light emtting element of different light emission colors from each other and is obtained by conversion of the display data,
wherein the signal converter comprises:
a gamma correction curve generator which, based on a single conversion characteristic, generates gamma correction curves different from each other which correspond to the color components corresponding to the light emission color of each of the light emitting elements in the predetermined number of display pixels and set a relation between a value of the display data and a value of the gradation signal; and
a gradation signal generator which converts the color component of the display data with the use of the generated gamma correction curve corresponding to said each color component and generates in a time series manner the gradation signal corresponding to the predetermined number of display pixels.

2. The display driving device according to claim 1, wherein a value of said each gamma correction curve, which is generated by the gamma correction curve generator and corresponds to each of the color components, is set to be such a value that a previously set color balance can be obtained, based on a luminance value of the light emitting element of said each light emission color in said plurality of display pixels with respect to the value of the display data.

3. The display driving device according to claim 1, wherein the display data is a digital signal having a plurality of bits, and the gamma correction curve generator comprises:
a gradation voltage generator, which is subjected to an application of a maximum gradation reference voltage and a minimum gradation reference voltage, generates a plurality of gradation voltages corresponding to the number of bits of the display data based on a value of the maximum gradation reference voltage and the minimum gradation reference voltage, wherein a value of said each gradation voltage serves as the single conversion characteristic; and
a gradation reference voltage switching part which switches at least any one of the maximum gradation reference voltage and the minimum gradation reference voltage in accordance with a timing of supplying each of the predetermined number of the color components in the display data and generates the gamma correction curve corresponding to each of the color components.

4. The display driving device according to claim 3, wherein the gradation voltage generator comprises a ladder resistor part, which includes a plurality of resistance elements connected in series, is in its both ends subjected to the application of the maximum gradation reference voltage and the minimum gradation reference voltage, divides a voltage between the maximum gradation reference voltage and the minimum gradation reference voltage by said each resistance element, and generates said plurality of gradation voltages, and
the gradation signal generator is subjected to a supply of the display data to select the gradation voltage corresponding to a value of the display data in said plurality of gradation voltages, and thus, to determine the selected gradation voltage as the gradation signal.

5. The display driving device according to claim 1, wherein the signal converter generates the gradation signal, corresponding to the predetermined number of display pixels, in a time series manner corresponding to the order of supplying said each color component in the display data.

6. The display driving device according to claim 1, further comprising a signal distribution circuit which distributes the gradation signal, which corresponds to the predetermined number of display pixels generated in a time series manner by the signal converter, corresponding to each of the predetermined number of display pixels.

7. The display driving device according to claim 6, further comprising a signal holding circuit which holds the gradation signals corresponding to the predetermined number of display pixels distributed by the signal distribution circuit and simultaneously outputs the gradation signals to the predetermined number of display pixels.

8. A display apparatus for performing color display, comprising:
a display panel having a plurality of data lines and a plurality of select lines perpendicular to each other and a plurality of display pixels, which are arranged near each intersection of said plurality of data lines and said plurality of select lines and have light emitting elements performing color display and having any of a plurality of light emission colors; and
a display driving device which is supplied a display data corresponding to each of light emission colors of the light emitting element in said each display pixel arrayed along the extending direction of the select line and comprising a digital signal including a plurality of color components, and generates a gradation signal based on the display data to supply the gradation signal to said plurality of display pixels through said plurality of data lines,
wherein the display driving device comprises a signal converter which is provided corresponding to a predetermined number of two or more data lines corresponding to the display pixel having the light emitting element of different light emission colors from each other in said plurality of data lines and generates the gradation signal obtained by conversion of the display data, and
the signal converter comprises:
a gamma correction curve generator which, based on a single conversion characteristic, generates gamma correction curves different from each other which correspond to color components corresponding to a light emission color of each light emitting element in the predetermined number of display pixels corresponding to the predetermined number of data lines and sets a relation between a value of the display data and a value of the gradation signal; and
a gradation signal generator which converts the color component of the display data with the use of the generated gamma correction curve corresponding to said each color component and generates in a time series manner the gradation signal corresponding to the predetermined number of the display pixels.

9. The display apparatus according to claim 8, wherein a value of said each gamma correction curve, which is generated by the gamma correction curve generator in the signal converter and corresponds to each of the color components, is set, in the display panel, to be such a value that a previously set color balance can be obtained, based on a luminance value of the light emitting element of said each light emission color in said plurality of display pixels with respect to the value of the display data.

10. The display apparatus according to claim 8, wherein the display data is a digital signal having a plurality of bits, and the gamma correction curve generator comprises:
a gradation voltage generator, which is subjected to an application of a maximum gradation reference voltage and a minimum gradation reference voltage, generates a plurality of gradation voltages corresponding to the number of bits of the display data based on a value of the maximum gradation reference voltage and the minimum gradation reference voltage, wherein a value of said each gradation voltage serves as the single conversion characteristic; and
a gradation reference voltage switching part which switches at least any one of the maximum gradation reference voltage and the minimum gradation reference voltage in accordance with a timing of supplying each of the predetermined number of the color components in the display data and generates the gamma correction curve corresponding to each of the color components.

11. The display apparatus according to claim 10, wherein the gradation voltage generator comprises a ladder resistor part, which includes a plurality of resistance elements connected in series, is in its both ends subjected to an application of the maximum gradation reference voltage and the minimum gradation reference voltage, divides a voltage between the maximum gradation reference voltage and the minimum gradation reference voltage by said each resistance element, and generates said plurality of gradation voltages, and
the gradation signal generator is subjected to a supply of the display data to select the gradation voltage corresponding to a value of the display data in said plurality of gradation voltages, and thus, to determine the selected gradation voltage as the gradation signal.

12. The display apparatus according to claim 8, wherein the signal converter generates the gradation signal, corresponding to the predetermined number of display pixels, in a time series manner corresponding to the order of supplying said each color component in the display data.

13. The display apparatus according to claim 8, wherein the display driving device comprises a signal distribution circuit which distributes the gradation signal, which corresponds to the predetermined number of display pixels generated in a time series manner by the signal converter, corresponding to each of the predetermined number of display pixels.

14. The display apparatus according to claim 13, wherein the display driving device comprises a signal holding circuit which holds the gradation signals corresponding to the predetermined number of display pixels distributed by the signal distribution circuit and simultaneously outputs the gradation signals to the predetermined number of display pixels.

15. The display apparatus according to claim 8, wherein the display driving device comprises a characteristic change compensation processor which corrects the gradation signal, generated by said each signal converter, in accordance with characteristic change of said each display pixel.

16. A method of driving a display driving device for driving a plurality of display pixels provided with a light emitting element, which performs color display and has any one of a plurality of light emission colors, comprising:
a step of converting display data, which is supplied, corresponds to said each display pixel, and includes a plurality of color components corresponding to said plurality of light emission colors, and generating a gradation signal corresponding to a predetermined number of two or more display pixels having the light emitting element of different light emission colors from each other; and
a step of supplying the generated gradation signal, corresponding to said each color component, to each of the predetermined number of display pixels,
wherein the step of generating the gradation signal comprises:
a step of, based on a single conversion characteristic, generating gamma correction curves different from each other which correspond to each of a predetermined number of color components included in the display data and setting a relation between a value of the display data and a value of the gradation signal; and
a step of converting said each color component in the display data with the use of the generated gamma correction curves corresponding to each of the color components and generating in a time series manner the gradation signal corresponding to the predetermined number of display pixels.

17. The method of driving a display driving device according to claim 16, wherein the display data is a digital signal having a plurality of bits, and
the step of generating each of the gamma correction curves comprises a step of generating a plurality of gradation voltages, which correspond to the number of bits of the display data based on a value of a maximum gradation reference voltage and a value of a minimum gradation reference voltage to be applied and have a value serving as the single conversion characteristic, switching at least any one of the maximum gradation reference voltage and the minimum gradation reference voltage in accordance with a timing of supplying each of the predetermined number of the color components in the display data, and generating the gamma correction curve corresponding to each of the color components.

18. A method of driving a display apparatus for performing color display, wherein the display apparatus has a display panel having a plurality of display pixels, which are arranged near each intersection of a plurality of data lines and a plurality of select lines perpendicular to each other and provided with a light emitting element performing color display and having any of a plurality of light emission colors, the method comprising:
a step of converting display data, which is supplied, corresponds to each of light emission colors of the light emitting element in said each display pixel arrayed in the extending direction of the select line, and comprises a digital signal including a plurality of color components, and generating a gradation signal corresponding to the predetermined number of display pixels having the light emitting element which is connected to a predetermined number of two or more data lines and has the light emitting elements of different light emission colors from each other; and
a step of supplying the generated gradation signal corresponding to said each color component to each of the predetermined number of display pixels,
wherein the step of generating the gradation signal comprises:
a step of, based on a single conversion characteristic, generating gamma correction curves different from each other which correspond to each of a predetermined number of color components included in the display data and setting a relation between a value of the display data and a value of the gradation signal; and
a step of converting said each color component in the display data with the use of the generated gamma correction curves corresponding to each of the color components and generating in a time series manner the gradation signal corresponding to the predetermined number of display pixels.

19. The method of driving a display apparatus according to claim 18, wherein the display data is a digital signal having a plurality of bits, and
the step of generating each of the gamma correction curves comprises a step of generating a plurality of gradation voltages, which correspond to the number of bits of the display data based on a value of a maximum gradation reference voltage and a value of a minimum gradation reference voltage to be applied and have a value serving as the single conversion characteristic, switching at least any one of the maximum gradation reference voltage and the minimum gradation reference voltage in accordance with a timing of supplying each of the predetermined number of the color components in the display data, and generating the gamma correction curve corresponding to each of the color components.
